(19) United States
(12) Patent Application Publication
(10) Pub. No.: US 2015/0120717 A1
(43) Pub. Date: Apr. 30, 2015

(54) SYSTEMS AND METHODS FOR DETERMINING INFLUENCERS IN A SOCIAL DATA NETWORK AND RANKING DATA OBJECTS BASED ON INFLUENCERS

(71) Applicant: Marketwire L.P., Toronto (CA)

(72) Inventors: Edward Dong-Jin KIM, Toronto (CA); Brian Jia-Lee KENG, Thornhill (CA); Kanchana PADMANABHAN, Toronto (CA)

(73) Assignee: MARKETWIRE L.P., Toronto (CA)

(21) Appl. No.: 14/581,215

(22) Filed: Dec. 23, 2014

Related U.S. Application Data
(63) Continuation-in-part of application No. 14/522,471, filed on Oct. 23, 2014.
Application No. 14/522,471 is a continuation-in-part of application No. 14/522,390, filed on Oct. 23, 2014.
Application No. 14/522,390 is a continuation-in-part of application No. 14/522,357, filed on Oct. 23, 2014.
(60) Provisional application No. 61/895,539, filed on Oct. 25, 2013.
(60) Provisional application No. 61/907,878, filed on Nov. 22, 2013.
(60) Provisional application No. 62/020,833, filed on Jul. 3, 2014.
(60) Provisional application No. 61/895,539, filed on Oct. 25, 2013.
(60) Provisional application No. 61/907,878, filed on Nov. 22, 2013.
(60) Provisional application No. 62/020,833, filed on Jul. 3, 2014.
(60) Provisional application No. 61/895,539, filed on Oct. 25, 2013.
(60) Provisional application No. 61/907,878, filed on Nov. 22, 2013.
(60) Provisional application No. 62/020,833, filed on Jul. 3, 2014.
(60) Provisional application No. 62/020,833, filed on Jul. 3, 2014.

(51) Int. Cl. G06F 17/30

(52) U.S. Cl. CPC G06F 17/3053; G06F 17/30867
USPC 707/727

(57) ABSTRACT

A method performed by a computing system is provided for searching for text sources including temporally-ordered data objects based on at least influence of an author. Users associated with a topic are identified, including authors. The users are modeled as a node and the method includes computing a topic network graph using the users as nodes and their relationships as edges. Users are ranked within the topic network graph. A search query based on a term and a time interval, including the topic, is obtained. Data objects based on the search query are identified. The method further includes: generating a popularity curve based on the frequency of data objects; identifying popular data objects based on the popularity curve; identifying an author of each of the popular data objects; and ranking the popular data objects according to a respective ranking of a respective author of each of the popular data objects.

### CROSS-REFERENCE TO RELATED APPLICATIONS

This application is a Continuation-In-Part of U.S. patent application Ser. No. 14/522,471 filed on Oct. 23, 2014, titled “Systems and Methods for Determining Influencers in a Social Data Network”, which claims priority to: U.S. Provisional Patent Application No. 61/895,539, filed on Oct. 25, 2013, titled “Systems and Methods for Determining Influencers in a Social Data Network”; U.S. Provisional Patent Application No. 61/907,878 filed on Nov. 22, 2013, titled “Systems and Methods for Identifying Influencers and Their Communities in a Social Data Network”; and U.S. Provisional Patent Application No. 62/020,833 filed on Jul. 3, 2014, titled “Systems and Methods for Dynamically Determining Influencers in a Social Data Network Using Weighted Analysis”. The entire contents of the above patent applications are incorporated herein by reference.

This application is also a Continuation-In-Part of U.S. patent application Ser. No. 14/522,390 filed on Oct. 23, 2014, titled “Systems and Methods for Identifying Influencers and Their Communities in a Social Data Network”, which claims priority to: U.S. Provisional Patent Application No. 61/895,539, filed on Oct. 25, 2013, titled “Systems and Methods for Determining Influencers in a Social Data Network”; U.S. Provisional Patent Application No. 61/907,878 filed on Nov. 22, 2013, titled “Systems and Methods for Identifying Influencers and Their Communities in a Social Data Network”; and U.S. Provisional Patent Application No. 62/020,833 filed on Jul. 3, 2014, titled “Systems and Methods for Dynamically Determining Influencers in a Social Data Network Using Weighted Analysis”. The entire contents of the above patent applications are incorporated herein by reference.

This application is also a Continuation-In-Part of U.S. patent application Ser. No. 14/522,357 filed on Oct. 23, 2014, titled “Systems and Methods for Dynamically Determining Influencers in a Social Data Network Using Weighted Analysis”, which claims priority to: U.S. Provisional Patent Application No. 61/895,539, filed on Oct. 25, 2013, titled “Systems and Methods for Determining Influencers in a Social Data Network”; U.S. Provisional Patent Application No. 61/907,878 filed on Nov. 22, 2013, titled “Systems and Methods for Identifying Influencers and Their Communities in a Social Data Network”; and U.S. Provisional Patent Application No. 62/020,833 filed on Jul. 3, 2014, titled “Systems and Methods for Dynamically Determining Influencers in a Social Data Network Using Weighted Analysis”. The entire contents of the above patent applications are incorporated herein by reference.

This application also claims priority to U.S. Provisional Patent Application No. 62/020,833 filed on Jul. 3, 2014, titled “Systems and Methods for Dynamically Determining Influencers in a Social Data Network Using Weighted Analysis”. The entire contents of the above patent application are incorporated herein by reference.

### TECHNICAL FIELD

The following generally relates to analysing social network data.

### BACKGROUND

In recent years social media has become a popular way for individuals and consumers to interact online (e.g. on the Internet). Social media also affects the way businesses aim to interact with their customers, fans, and potential customers online.

Some bloggers on particular topics with a wide following are identified and are used to endorse or sponsor specific products. For example, advertisement space on a popular blogger's website is used to advertise related products and services.

Social network platforms are also used to influence groups of people. Examples of social network platforms include those known by the trade names Facebook, Twitter, LinkedIn, Tumblr, and Pinterest. Popular or expert individuals within a social network platform can be used to market to other people. Quickly identifying popular or influential individuals becomes more difficult when the number of users within a social network grows. Furthermore, accurately identifying influential individuals within a particular topic is difficult. The experts or those users who are popular in a social network are herein interchangeably referred to as “influencers”.

### BRIEF DESCRIPTION OF THE DRAWINGS

Embodiments will now be described by way of example only with reference to the appended drawings wherein:

FIG. 1 is a diagram illustrating users in connection with each other in a social data network.

FIG. 2 is a schematic diagram of a server in communication with a computing device.

FIG. 3 is a flow diagram of an example embodiment of computer executable instructions for determining influencers associated with a topic.

FIG. 4 is a flow diagram of another example embodiment of computer executable instructions for determining influencers associated with a topic.

FIG. 5 is a flow diagram of an example embodiment of computer executable instructions for obtaining and storing social networking data.

FIG. 6 is a block diagram of example data components in an index store.

FIG. 7 is a block diagram of example data components in a profile store.

FIG. 8 is a schematic diagram of example user lists and a tally of the number of times a user is listed within different user lists.

FIG. 9 is a flow diagram of an example embodiment of computer executable instructions for determining topics in which a given user is considered an expert.

FIG. 10 is a flow diagram of an example embodiment of computer executable instructions for determining topics in which a given user is interested.

FIG. 11 is a flow diagram of an example embodiment of computer executable instructions for searching for users in the index store that are considered experts in a topic.

FIG. 12 is a flow diagram of an example embodiment of computer executable instructions for identifying users that have interest in a topic.

FIG. 13 is an illustration of an example topic network graph for the topic “McCafe”.

FIG. 14 is the illustration of the topic network graph in FIG. 13, showing decomposition of a main cluster and an outlier cluster.

FIG. 15 is a flow diagram of an example embodiment of computer executable instructions for identifying and filtering outliers in a topic network based on decomposition of communities.

FIG. 16 is a flow diagram of example embodiment of computer executable instructions for identifying and providing community clusters from each topic network.

FIGS. 17A-17D illustrate exemplary screen shots for interacting with a GUI displaying the influencer communities within a topic network.

FIG. 18 illustrates an exemplary community network graph.

FIGS. 19A-19C show exemplary communities and characteristics for a particular topic.

FIGS. 20A-20B show exemplary communities and characteristics for a second selected topic.

FIG. 21 is another example diagram illustrating users in connection with each other in a social data network.

FIG. 22 is a flow diagram of an example embodiment of computer executable instructions for determining weighted relationships between users for a given topic, and communities of influencers based on the weighted relationships.

FIG. 23 is a flow diagram of another example embodiment of computer executable instructions for determining communities of influencers based on the weighted relationships.

FIG. 24 is a flow diagram of another example embodiment of computer executable instructions for determining communities of influencers based on the weighted relationships.

FIGS. 25A and 25B illustrate exemplary screen shots for interacting with a GUI displaying the influencer communities within a topic network, where FIG. 25A shows results that does not use weighted analysis and FIG. 25B shows results using weighted analysis.

FIG. 26 illustrates an exemplary screen shots for interacting with a GUI displaying the influencer communities within a topic network using weight analysis.

FIGS. 27A and 27B illustrate exemplary screen shots for interacting with a GUI displaying the influencer communities within a topic network, where FIG. 15A shows results that does not use weighted analysis and FIG. 15B shows results using weighted analysis.

FIG. 28A and FIG. 28B illustrate popularity curves for keywords “Pixar” and “Abu Musab al-Zarqawi”, respectively.

FIG. 29 illustrates popularity comparison curves for keywords “soccer” and “Zidane”.

FIG. 30A and FIG. 30B illustrate correlations for keywords “Philip Seymour Hoffman” for periods Mar. 1 to Mar. 20, 2006, and May 1 to May 20, 2006, respectively.

FIG. 31 illustrates an example of “hot keywords” cloud tag for 30 Jul. 2006.

FIG. 32 illustrates high level system architecture for the present invention.

FIG. 33 illustrates various components of the query execution engine and their interaction.

FIG. 34 illustrates a summary datastructure for a sequence with 8 nodes.

FIG. 35 illustrates answering a query of size 5 b using the stored summary.

FIG. 36 illustrates merging s ranked lists to produce a top-k list.

FIG. 37A illustrates and example graph extracted from Wikipedia.

FIG. 37B illustrates obtained transition matrix for the graph in FIG. 10A.

FIG. 37C illustrates resulting probabilities after running algorithm RelevanceRank on the graph of FIG. 37A after 1-5 iterations and at convergence.

FIG. 38 illustrates geographic search for query “iphone” on Jan. 29, 2007.

FIG. 39A illustrates a demographic curve for age distribution of individuals writing about Cadbury.

FIG. 39B illustrates a demographic curve for gender distribution of individuals writing about Cadbury segmented based on sentiment information.

FIG. 40 illustrates the interface for showing cached copy of search results in a tooltip. The figure shows one such tooltip which is displaying content of the first search result along with an automatically generated summary. The tooltips are multimedia enable and are capable of displaying images and videos.

FIG. 41 illustrates the interface for query by document.

FIG. 42 illustrates a BuzzGraph for query “cephalon” showing all other keywords related to Cephalon.

FIG. 43 illustrates the display of the results of an indexing scheme for “global warming” wherein time and gender information are analyzed by the search query.

### DETAILED DESCRIPTION OF THE DRAWINGS

It will be appreciated that for simplicity and clarity of illustration, where considered appropriate, reference numerals may be repeated among the figures to indicate corresponding or analogous elements. In addition, numerous specific details are set forth in order to provide a thorough understanding of the example embodiments described herein. However, it will be understood by those of ordinary skill in the art that the example embodiments described herein may be practiced without these specific details. In other instances, well-known methods, procedures and components have not been described in detail so as not to obscure the example embodiments described herein. Also, the description is not to be considered as limiting the scope of the example embodiments described herein.

Social networking platforms include users who generate and post content for others to see, hear, etc (e.g. via a network of computing devices communicating through websites associated with the social networking platform). Non-limiting examples of social networking platforms are Facebook, Twitter, LinkedIn, Pinterest, Tumblr, blogospheres, websites, collaborative wikis, online newsgroups, online forums, emails, and instant messaging services. Currently known and future known social networking platforms may be used with principles described herein. Social networking platforms can be used to market to, and advertise to, users of the platforms. It is recognized that it is difficult to identify users relevant to a given topic. This includes identifying influential users on a given topic.

As used herein, the term “influencer” refers to a user account that primarily produces and shares content related to a topic and is considered to be influential to other users in the social data network. More particularly, an influencer is an individual or entity represented in the social data network that: is considered to be interested in the topic or generate content about the topic; has a large number of followers (e.g. or readers, friends or subscribers), a significant percent of which are interested in the topic; and has a significant percentage of the topic-interested followers that value the influencer's opinion about the topic. Non-limiting examples of a topic include a brand, a company, a product, an event, a location, and a person.

The term “follower”, as used herein, refers to a first user account (e.g. the first user account associated with one or more social networking platforms accessed via a computing device) that follows a second user account (e.g. the second user account associated with at least one of the social networking platforms of the first user account and accessed via a computing device), such that content posted by the second user account is published for the first user account to read, consume, etc. For example, when a first user follows a second user, the first user (i.e. the follower) will receive content posted by the second user. A user with an “interest” on a particular topic herein refers to a user account that follows a number of experts (e.g. associated with the social networking platform) in the particular topic. In some cases, a follower engages with the content posted by the other user (e.g. by sharing or reposting the content).

Identifying the key influencers is desirable for companies in order, for example, to target individuals who can potentially broadcast and endorse a brand's message. Engaging these individuals allows control over a brand's online message and may reduce the potential negative sentiment that may occur. Careful management of this process may lead to exponential growth in online mindshare, for example, in the case of viral marketing campaigns.

Most past approaches to determining influencers have focused on easily calculable metrics such as the number of followers or friends, or the number of posts. While the aggregated followers or friends count may approximate the overall social network, it provides little data in the way of computing metrics that indicate the influence of a user or individual with respect to a company or brand. This leads to noisy influencer results and wasted time sifting through the massive volume of potential users.

Several social media analytics companies claim to provide influencer scores for social networks. However, it is herein recognized that many companies use a metric that is not a true influencer metric, but an algebraic formula of the number of followers and the number of mentions (e.g. “tweets” for Twitter, posts, messages, etc.). For instance, some of the known approaches use a logarithmic normalization of these numbers that allocates approximately 80% of the weight to the follower counts and the remainder to the number of mentions.

The reason for using an algebraic formula is that the counting or tallying of followers and mentions are instantly updated in the user profile for a social network. Hence, the computation is very fast and easy to report. This is often called an Authority metric or Authority score to distinguish it from true influencer analysis.

In an example embodiment, the Authority score, for example, is computed using a linear combination of several parameters, including the number of posts from a user and the number followers that follow the same user. In an example embodiment, the linear combination may also be based on the number of ancillary users that the same user follows.

However, there are several significant drawbacks to the Authority score approach. It is herein recognized that this Authority score is context insensitive. This is a static metric irrespective of the topic or query. For example, regardless of the topic, mass media outlets like the New York Times or CNN would get the highest ranking since they have millions of followers. Therefore, it is not context-sensitive.

It is also herein recognized that this Authority metric has a high follower count bias. If there is a well-defined specialist in a certain field with a limited number of followers, but all of them are also experts, they will never show up in the top 20 to 100 results due to their low follower count. Effectively, all the followers are treated as having equal weight, which has been shown to be an incorrect assumption in network analytics research.

The proposed systems and methods, as described herein, may dynamically calculate influencers with respect to the query topic, and may account for the influence of their followers.

It is also recognized that the recursive nature of the influencer relation is a challenge in implementing influencer identification on a massive scale. By way of example, consider a situation where there are individuals A, B and C with: A following B and C; B following C and A; and C following only A. Then the influence of A is dependent on C, which in turn is dependent on A and B, and so on. In this way, the influencer relationships have a recursive nature.

More generally, the proposed systems and methods provide a way to determine the influencers in a social data network.

In an example embodiment, the proposed systems and methods include a computing system configured for searching for text sources including temporally-ordered data objects based on at least influence of an author. An example method includes: identifying users associated with a topic, the users including authors of the data objects; modeling each of the users as a node and determining relationships between each of the users; computing a topic network graph using the users as nodes and the relationships as edges; ranking the users within the topic network graph; identifying and filtering outlier nodes within the topic network graph; outputting users remaining within the topic network graph according to their associated ranking of influence; obtaining or generating a search query based on one or more terms and one or more time intervals, the one or more terms including the topic; obtaining or generating time data associated with the data objects; identifying one or more data objects based on the search query; generating one or more popularity curves based on the frequency of data objects corresponding to one or more of the search terms in the one or more time intervals; identifying data objects as popular based on the one or more popularity curves; identifying an author of each of the popular data objects, each author identified as part of the outputted users within the topic network graph; and ranking each of the popular data objects according to a respective influence ranking of a respective author of each of the popular data objects.

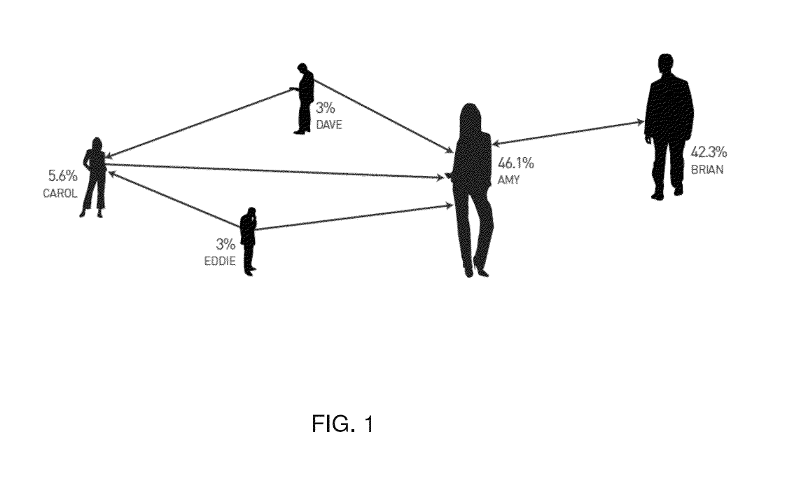

In an example aspect of determining influencers, consider the simplified follower network for a particular topic in FIG. 1. Each user, actually a user account or a user name associated with a user account or user data address, is shown in relationship to the other users. The lines between the users, also called edges, represent relationships between the users. For example, an arrow pointing from the user account “Dave” to the user account “Carol” means Dave reads messages published by Carol. In other words, Dave follows Carol. A bi-directional arrow between Amy and Brian means, for example, Amy follows Dave and Dave follows Amy. Beside each user account in FIG. 1, a PageRank score is provided. The PageRank algorithm is a known algorithm used by Google to measure the importance of website pages in a network and can be also applied to measuring the importance of users in a social data network.

Continuing with FIG. 1, Amy has the greatest number of followers (i.e. Dave, Carol, and Eddie) and is the most influential user in this network (i.e. PageRank score of 46.1%). However, Brian, with only one follower (i.e. Amy), is more influential than Carol with two followers (i.e. Eddie and Dave), primarily because Brian has a significant portion of Amy's mindshare. In other words, using the proposed systems and methods herein, although Carol has more followers than Brian, she does not necessarily have a greater influence than Brian. Hence, using the proposed systems and methods described herein, the number of followers of a user is not the sole determination for influence. In an example embodiment, identifying who are the followers of a user may also be factored into the computation of influence.

The example network in FIG. 1 is represented in Table 1, and it illustrates how PageRank can significantly differ from the number of followers.

TABLE 1
Twitter follower counts and PageRank scores
for sample network represented in FIG. 1.

| User Handle | Follower Count | PageRank |
|---|---|---|
| Amy | 4 | 46.1% |
| Brian | 1 | 42.3% |
| Carol | 2 | 5.6% |
| Dave | 0 | 3.0% |
| Eddie | 0 | 3.0% |

Amy is clearly the top influencer with the greatest number of followers and highest PageRank score. Although Carol has two followers, she has a lower PageRank metric than Brian who has one follower. However, Brian's one follower is the most-influential Amy (with four followers), while Carol's two followers are low influencers with (0 followers each). The intuition is that, if a few experts consider someone an expert, then s/he is also an expert. However, the PageRank algorithm gives a better measure of influence than only counting the number of followers. As will be described below, the PageRank algorithm and other similar ranking algorithms can be used with the proposed systems and methods described herein.

The proposed systems and methods may be used to determine the key influencers for a given topic in a social data network.

In an example embodiment, the proposed system and methods can be used to determine that influencers in Topic A are also influencers in one or more other topics (e.g. Topic B, Topic C, etc.).

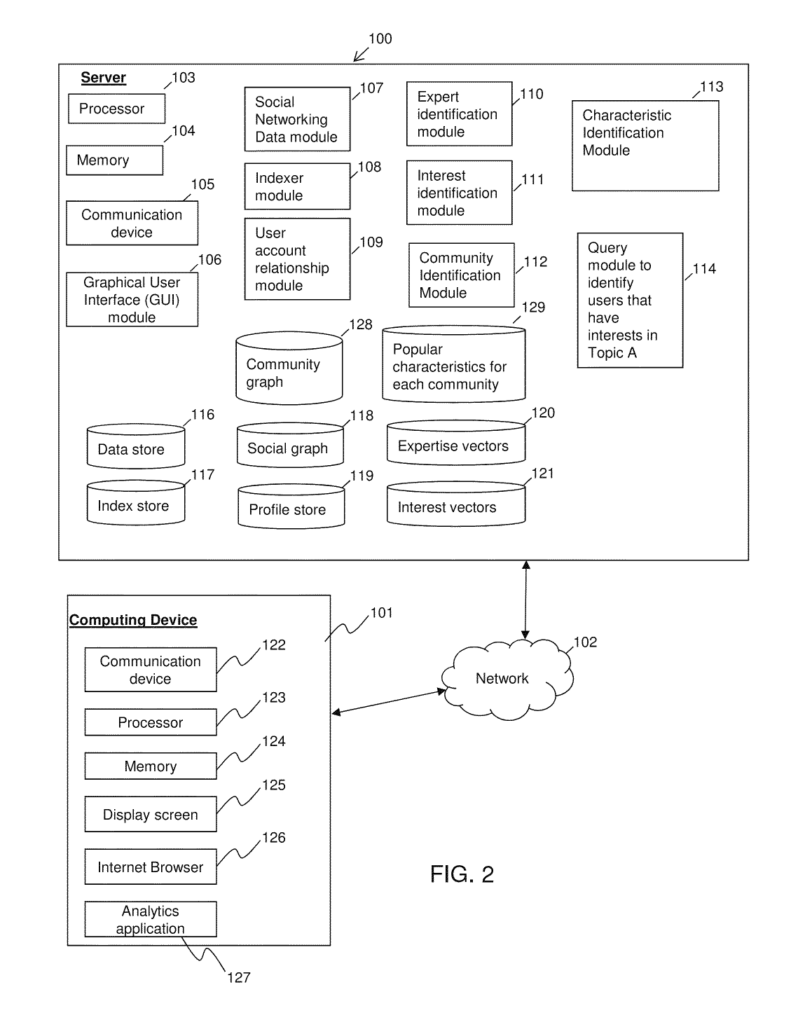

Turning to FIG. 2, a schematic diagram of a proposed system is shown. A server 100 is in communication with a computing device 101 over a network 102. The server 100 obtains and analyzes social network data and provides results to the computing device 101 over the network. The computing device 101 can receive user inputs through a GUI to control parameters for the analysis.

It can be appreciated that social network data includes data about the users of the social network platform, as well as the content generated or organized, or both, by the users. Non-limiting examples of social network data includes the user account ID or user name, a description of the user or user account, the messages or other data posted by the user, connections between the user and other users, location information, etc. An example of connections is a “user list”, also herein called “list”, which includes a name of the list, a description of the list, and one or more other users which the given user follows. The user list is, for example, created by the given user.

Continuing with FIG. 2, the server 100 includes a processor 103 and a memory device 104. In an example embodiment, the server includes one or more processors and a large amount of memory capacity. In another example embodiment, the memory device 104 or memory devices are solid state drives for increased read/write performance. In another example embodiment, multiple servers are used to implement the methods described herein. In other words, in an example embodiment, the server 100 refers to a server system. In another example embodiment, other currently known computing hardware or future known computing hardware is used, or both.

The server 100 also includes a communication device 105 to communicate via the network 102. The network 102 may be a wired or wireless network, or both. The server 100 also includes a GUI module 106 for displaying and receiving data via the computing device 101. The server also includes: a social networking data module 107; an indexer module 108; a user account relationship module 109; an expert identification module 110; an interest identification module 111; a query module to identify user that have interests in Topic A (e.g. a given topic) 114, a community identification module 112 and a characteristic identification module 113. As will be described, the community identification module 112 is configured to define communities or cluster of data based on a network graph of relationships identified by the expert identification module

The server 100 also includes a number of databases, including a data store 116; an index store 117; a database for a social graph 118; a profile store 119; a database for expertise vectors 120; a database for interest vectors 121, a database for storing community graph information 128, and a database for storing popular characteristics for each community 129 and storing pre-defined characteristics to be searched within each community, the communities as defined by community identification module 112.

The social networking data module 107 is used to receive a stream of social networking data. In an example embodiment, millions of new messages are delivered to social networking data module 107 each day, and in real-time. The social networking data received by the social networking data module 107 is stored in the data store 116.

The indexer module 108 performs an indexer process on the data in the data store 116 and stores the indexed data in the index store 117. In an example embodiment, the indexed data in the index store 117 can be more easily searched, and the identifiers in the index store can be used to retrieve the actual data (e.g. full messages).

A social graph is also obtained from the social networking platform server, not shown, and is stored in the social graph database 118. The social graph, when given a user as an input to a query, can be used to return all users following the queried user.

The profile store 119 stores meta data related to user profiles. Examples of profile related meta data include the aggregate number of followers of a given user, self-disclosed personal information of the given user, location information of the given user, etc. The data in the profile store 119 can be queried.

In an example embodiment, the user account relationship module 109 can use the social graph 118 and the profile store 119 to determine which users are following a particular user.

The expert identification module 110 is configured to identify the set of all user lists in which a user account is listed, called the expertise vector. The expertise vector for a user is stored in the expertise vector database 120. The interest identification module 111 is configured to identify topics of interest to a given user, called the interest vector. The interest vector for a user is stored in the interest vector database 121.

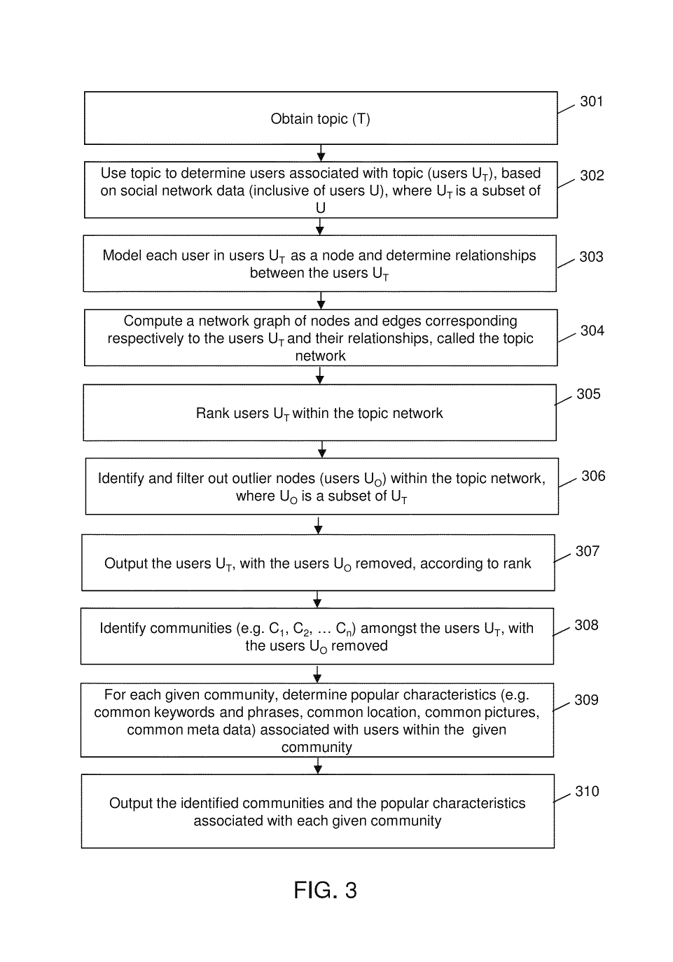

Referring again to FIG. 2, the server 100 further comprises a community identification module 112 that is configured to identify communities (e.g. a cluster of information within a queried topic such as Topic A) within a topic network and associated influencer as identified by the expert identification module 110. As will be described with reference to FIG. 3, the topic network illustrates the graph of influential users and their relationships (e.g. as defined by the expert identification module 110 and/or social graph 118). The output from a community identification module 112 comprises a visual identification of clusters (e.g. color coded) defined as communities of the topic network that contain common characteristics and/or are affected (e.g. influenced such as follower-followed relationships), to a higher degree by other entities (e.g. influencers) in the same community than those in another community. The server 100 further comprises a characteristic identification module 113.

The characteristic identification module 113 is configured to receive the identified communities from the community identification module 112 and provide an identification of popular characteristics (e.g. topic of conversation) among the community members. The results of the characteristic identification module 113, can be visually linked to the corresponding visualization of the community as provided in the community identification module 112. As will be described, in one aspect, the results of the community identification module 112 (e.g. a plurality of communities) and/or characteristic identification module 113 (e.g. a plurality of popular characteristics within each community) are displayed on the display screen 125 as output to the computing device 101. In yet a further aspect, the GUI module 106 is configured to receive input from the computing device 101 for selection of a particular community as identified by the community identification module 112. The GUI module 106 is then configured to communicate with the characteristic identification module 113, to provide an output of results for a particular characteristic (e.g. defining popular conversations) as associated with the selected community (e.g. for all influential users within the selected community). The results of the characteristic identification module 112 (e.g. a word cloud to visually define popular conversations among users of the selected community) can be displayed on the display screen 125 alongside the particular selected community and/or a listing of users within the particular selected community.

Continuing with FIG. 2, the computing device 101 includes a communication device 122 to communicate with the server 100 via the network 102, a processor 123, a memory device 124, a display screen 125, and an Internet browser 126. In an example embodiment, the GUI provided by the server 100 is displayed by the computing device 101 through the Internet browser. In another example embodiment, where an analytics application 127 is available on the computing device 101, the GUI is displayed by the computing device through the analytics application 127. It can be appreciated that the display device 125 may be part of the computing device (e.g. as with a mobile device, a tablet, a laptop, etc.) or may be separate from the computing device (e.g. as with a desktop computer, or the like).

Although not shown, various user input devices (e.g. touch screen, roller ball, optical mouse, buttons, keyboard, microphone, etc.) can be used to facilitate interaction between the user and the computing device 101.

It will be appreciated that any module or component exemplified herein that executes instructions may include or otherwise have access to computer readable media such as storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by an application, module, or both. Any such computer storage media may be part of the server 100 or computing device 101 or accessible or connectable thereto. Any application or module herein described may be implemented using computer readable/executable instructions that may be stored or otherwise held by such computer readable media.

Turning to FIG. 3, an example embodiment of computer executable instructions are shown for determining one or more influencers of a given topic. The process shown in FIG. 3 assumes that social network data is available to the server 100, and the social network data includes multiple users that are represented as a set U. At block 301, the server 100 obtains a topic represented as T. For example, a user may enter in a topic via a GUI displayed at the computing device 101, and the computing device 101 sends the topic to the server 100. At block 302, the server uses the topic to determine users from the social network data which are associated with the topic. This determination can be implemented in various ways and will be discussed in further detail below. The set of users associated with the topic is represented as U_{T}, where U_{T} is a subset of U.

Continuing with FIG. 3, the server models each user in the set of users U_{T} as a node and determines the relationships between the users U_{T} (block 303). The server computes a network of nodes and edges corresponding respectively to the users U_{T} and the relationships between the users U_{T} (block 304). In other words, the server creates a network graph of nodes and edges corresponding respectively to the users U_{T} and their relationships. The network graph is called the “topic network”. It can be appreciated that the principles of graph theory are applied here. The relationships that define the edges or connectedness between two entities or users U_{T} can include for example: friend connection and/or follower-followee connection between the two entities within a particular social networking platform. In an additional aspect, the relationships could include other types of relationships defining social media connectedness between two entities such as: friend of a friend connection. In yet another aspect, the relationship could include connectedness of a friend or follower connection across different social network platforms (e.g. Instagram and Facebook). In yet a further aspect, the relationship between the users U_{T} as defined by the edges can include for example: users connected via re-posts of messages by one user as originally posted by another user (e.g. re-tweets on Twitter), and/or users connected through replies to messages posted by one user and commented by another user via the social networking platform. Referring again to FIG. 3, the presence of an edge between two entities indicates the presence of at least one type of relationship or connectedness (e.g. friend or follower connectivity between two users) in one or more social networking platforms.

The server then ranks users within the topic network (block 305). For example, the server uses PageRank to measure importance of a user within the topic network and to rank the user based on the measure. Other non-limiting examples of ranking algorithms that can be used include: Eigenvector Centrality, Weighted Degree, Betweenness, Hub and Authority metrics.

The server identifies and filters out outlier nodes within the topic network (block 306). The outlier nodes are outlier users that are considered to be separate from a larger population or clusters of users in the topic network. The set of outlier users or nodes within the topic network is represented by U_{O}, where U_{O} is a subset of U_{T}. Further details about identifying and filtering the outlier nodes are described below.

At block 307, server outputs the users U_{T}, with the users U_{O} removed, according to rank.

In an alternate example embodiment, block 306 is performed before block 305.

At block 308, the server identifies communities (e.g. C₁, C₂, . . . , Cₙ) amongst the users U_{T} with the users U_{O} removed. The identification of the communities can depend on the degree of connectedness between nodes within one community as compared to nodes within another community. That is, a community is defined by entities or nodes having a higher degree of connectedness internally (e.g. with respect to other nodes in the same community) than with respect to entities external to the defined community. As will be defined, the value or threshold for the degree of connectedness used to separate one community from another can be pre-defined (e.g. as provided by the community graph database 128 and/or user-defined from computing device 101). The resolution thus defines the density of the interconnectedness of the nodes within a community. Each identified community graph is thus a subset of the network graph of nodes and edges (the topic network) defined in block 304 for each community. In one aspect, the community graph further displays both a visual representation of the users in the community (e.g. as nodes) with the community graph and a textual listing of the users in the community (e.g. as provided to display screen 125 of FIG. 1). In yet a further aspect, the display of the listing of users in the community is ranked according to degree of influence within the community and/or within all communities for topic T (e.g. as provided to display screen 125 of FIG. 1). In accordance with block 308, users U_{T} are then split up into their community graph classifications such as U_{C1}, U_{C2}, . . . U_{Cn}.

At block 309, for each given community (e.g. C₁), the server determines popular characteristic values for pre-defined characteristics (e.g. one or more of: common words and phrases, topics of conversations, common locations, common pictures, common meta data) associated with users (e.g. U_{C1}) within the given community based on their social network data. The selected characteristic (e.g. topic or location) can be user-defined (e.g. via input from the computing device 101) and/or automatically generated (e.g. based on characteristics for other communities within the same topic network, or based on previously used characteristics for the same topic T). At block 310, the server outputs the identified communities (e.g. C₁, C₂, . . . , Cₙ) and the popular characteristics associated with each given community. The identified communities can be output (e.g. via the server for display on the display screen 125) as a community graph in visual association with the characteristic values for a pre-defined characteristic for each community.

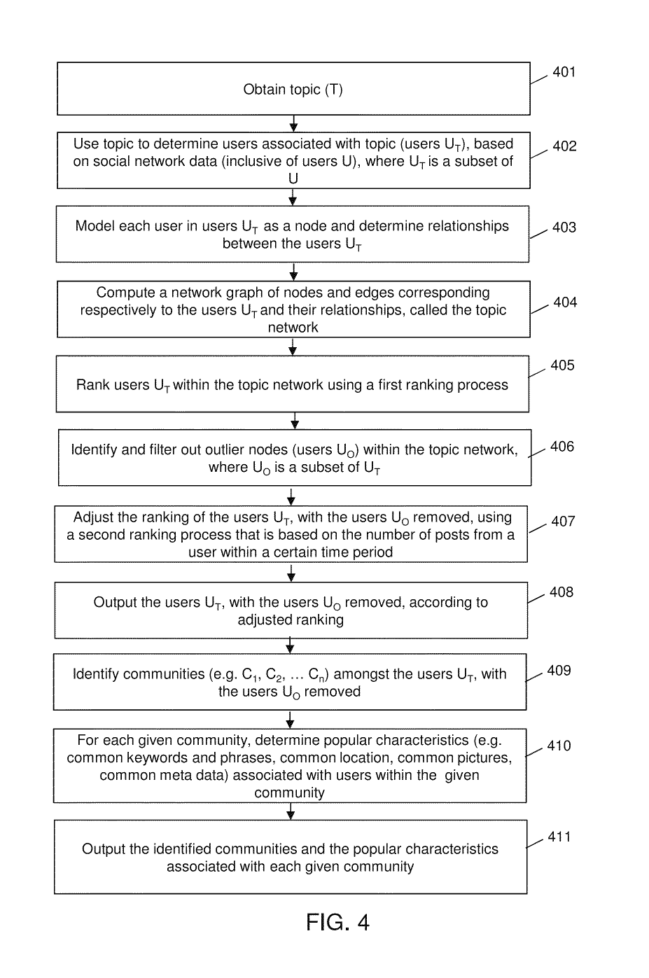

Turning to FIG. 4, another example embodiment of computer executable instructions are shown for determining one or more influencers of a given topic. Blocks 401 to 404 correspond to blocks 301 to 304. Following block 404, the server 100 ranks users within the topic network using a first ranking process (block 405). The first ranking process may or may not be the same ranking process used in block 305. The ranking is done to identify which users are the most influential in the given topic network for the given topic.

At block 406, the server identifies and filters out outlier nodes (users U_{O}) within the topic network, where U_{O} is a subset of U_{T}. At block 407, the server adjusts the ranking of the users U_{T}, with the users U_{O} removed, using a second ranking process that is based on the number of posts from a user within a certain time period. For example, the server determines that if a first user has a higher number of posts within the last two months compared to the number of posts of a second user within the same time period, then the first user's original ranking (from block 405) may be increased, while the second user's ranking remains the same or is decreased.

It is recognized that a network graph based on all the users U may be very large. For example, there may be hundreds of millions of users in the set U. Analysing the entire data set related to U may be computationally expensive and time consuming. Therefore, using the above process to find a smaller set of users U_{T} that relate to the topic T reduces the amount of data to be analysed. This decreases the processing time as well. In an example embodiment, near real time results of influencers have been produced when analysing the entire social network platform of Twitter. Using the smaller set of users U_{T} and the data associated with the user U_{T}, a new topic network is computed. The topic network is smaller (i.e. less nodes and less edges) than the social network graph that is inclusive of all users U. Ranking users based on the topic network is much faster than ranking users based on the social network graph inclusive of all users U.

Furthermore, identifying and filtering outlier nodes in the topic network helps to further improve the quality of the results.

At block 409, the server is configured to identify communities (e.g. C₁, C₂, . . . , Cₙ) amongst the users U_{T} with the users U_{O} removed (e.g. utilizing the community identification module 112 of FIG. 2) in a similar manner as previously described in relation to block 308. At block 410, the server is configured to determine, for each given community (e.g. C₁), popular characteristic values for pre-defined characteristics (e.g. common keywords and phrases, topics of conversations, common locations, common pictures, common meta data) associated with users (e.g. U_{C1}) within the given community (e.g. C₁), based on their social network data in a similar manner as previously described in relation to block 309. At block 411, the server is configured to output the identified communities and the characteristic values for the popular characteristics associated with each given community (e.g. C₁-Cₙ) in a similar manner as block 310 (e.g. via a display screen associated with the server 100 and/or the computing device 101 as shown in FIG. 2).

Further details of the methods described in FIG. 3 and FIG. 4 are described below.

Obtaining Social Network Data:

With respect to obtaining social network data, although not shown in FIG. 3 or FIG. 4, it will be appreciated that the server 100 obtains social network data. The social network data may be obtained in various ways. Below is a non-limiting example embodiment of obtaining social network data.

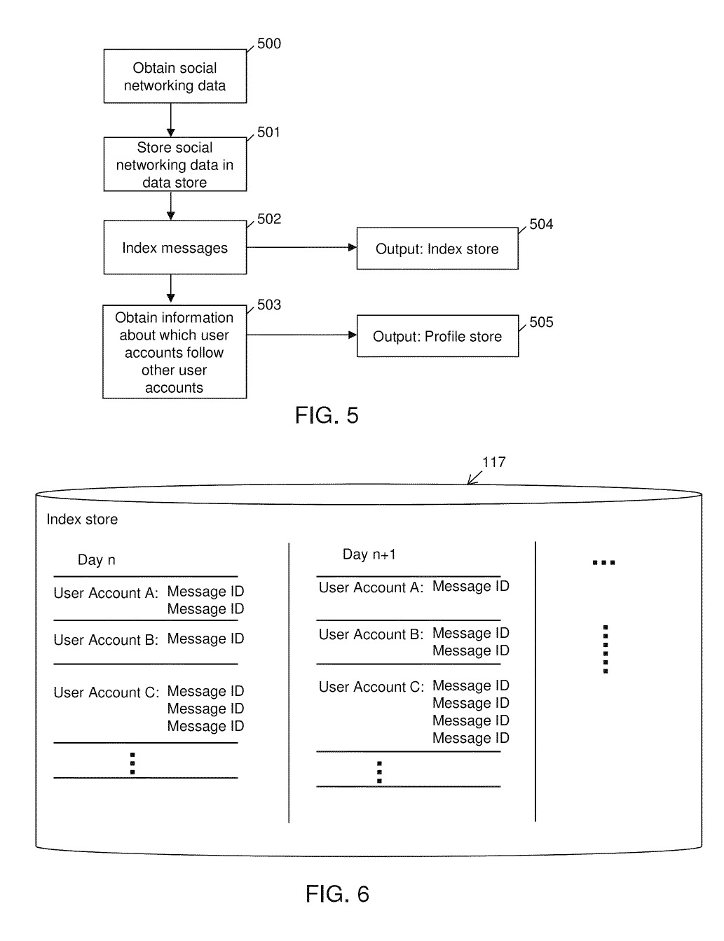

Turning to FIG. 5, an example embodiment of computer executable instructions are shown for obtaining social network data. The data may be received as a stream of data, including messages and meta data, in real time. This data is stored in the data store 116, for example, using a compressed row format (block 501). In a non-limiting example embodiment, a MySQL database is used. Blocks 500 and 501, for example, are implemented by the social networking data module 107.

In an example embodiment, the social network data received by social networking module 107 is copied, and the copies of the social network data are stored across multiple servers. This facilitates parallel processing when analysing the social network data. In other words, it is possible for one server to analyse one aspect of the social network data, while another server analyses another aspect of the social network data.

The server 100 indexes the messages using an indexer process (block 502). For example, the indexer process is a separate process from the storage process that includes scanning the messages as they materialize in the data store 116. In an example embodiment, the indexer process runs on a separate server by itself. This facilitates parallel processing. The indexer process is, for example, a multi-threaded process that materializes a table of indexed data for each day, or for some other given time period. The indexed data is outputted and stored in the index store 117 (block 504).

Turning briefly to FIG. 6, which shows an example index store 117, each row in the table is a unique user account identifier and a corresponding list of all message identifiers that are produced that day, or that given time period. In an example embodiment, millions of rows of data can be read and written in the index store 117 each day, and this process can occur as new data is materialized or added to the data store 116. In an example embodiment, a compressed row format is used in the index store 117. In another example embodiment, deadlocks are avoided by running relaxed transactional semantics, since this increases throughput across multiple threads when reading and writing the table. By way of background, a deadlock occurs when two or more tasks permanently block each other by each task having a lock on a resource which the other tasks are trying to lock.

Turning back to FIG. 5, the server 100 further obtains information about which user accounts follow other user accounts (block 503). This process includes identifying profile related meta data and storing the same in the profile store (block 505).

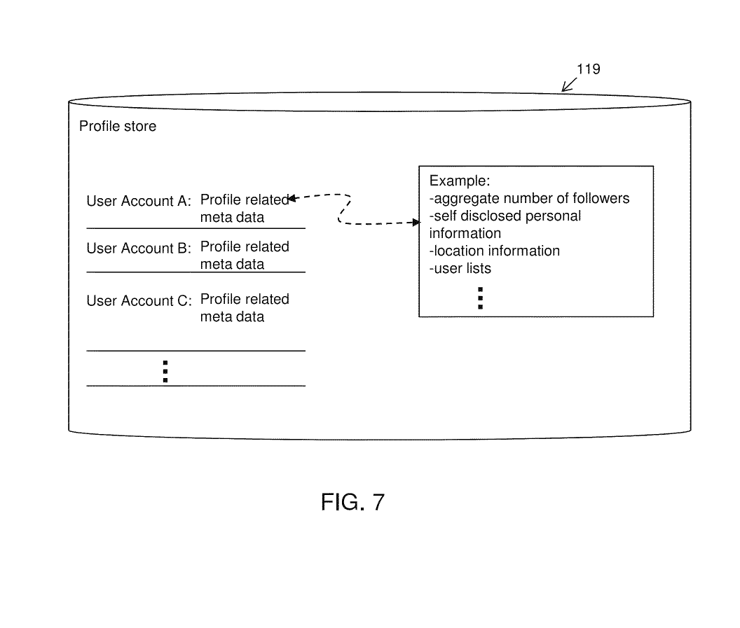

In FIG. 7, an example of the profile store 119 shows that for each user account, there is associated profile related meta data. The profile related meta data includes, for example, the aggregate number of followers of the user, self-disclosed personal information, location information, and user lists.

After the data is obtained and stored, it can be analyzed, for example, to identify experts and interests.

Determining Users Related to a Topic:

With respect to determining users related to a topic, as per blocks 302 and 402, it will be appreciated that such an operation can occur in various ways. Below are non-limiting example embodiments that can be used to determine users related to a topic.

In an example embodiment, the operation of determining users related to a topic (e.g. block 302 and block 402) includes using a topic to identify popular documents within a certain time interval, which is described below. It is herein recognized that this process can also be used to identify users related to a topic. In particular, when a topic (e.g. a keyword) is provided to the system of for text analysis, the system returns documents (e.g. posts, blogs, tweets, messages, articles, etc.) that are related and popular to the topic. Using the proposed systems and methods described herein, the executable instructions include the server 100 determining the author or authors of the popular documents. In this way, the author or authors are identified as the top users who are related to the given topic. An upper limit n may be provided to identify the top n users who are related to the given topic, where n is an integer. In an example embodiment, n is 5000, although other numbers can be used. The top n users may be determined according to a known or future known ranking algorithm, or using known or future known authority scoring algorithm for social media analytics. For each of the top n users, the server determines the users who follow each of the top n users. Those users that are not considered as part of the top n users, or do not follow the top n users are not part of the users U_{T} in the topic network. In an example embodiment, the set of users U_{T} includes the top n users and their followers.

In another example embodiment of performing the operation of determining users related to a topic (e.g. block 302 and block 402), the computer executable instructions include: determining documents (e.g. posts, articles, tweets, messages, etc.) that are correlated with the given topic; determining the author or authors of the documents; and establishing the author or authors as the users U_{T} associated with the given topic.

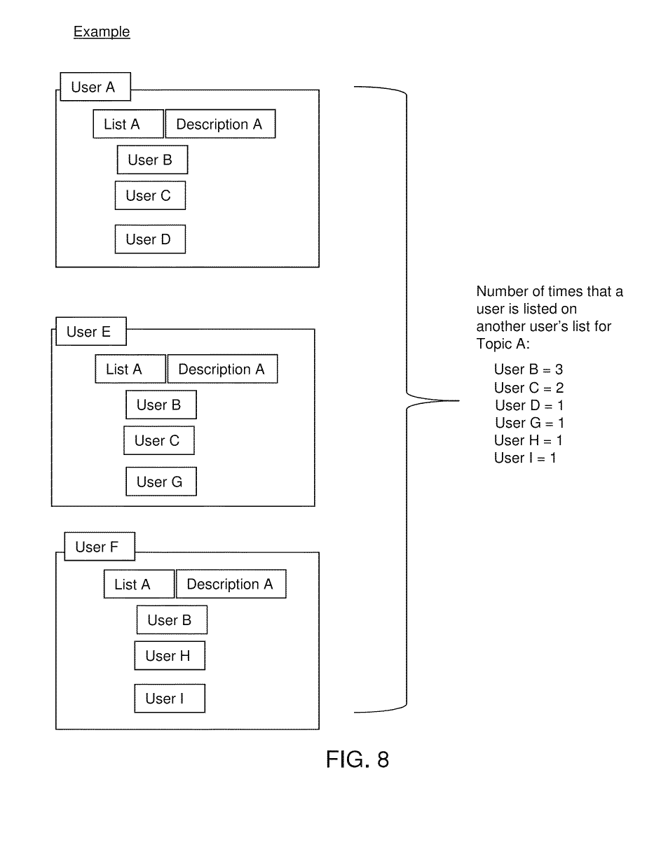

In another example embodiment of performing the operation of determining users related to a topic (e.g. block 302 and block 402), the operation includes identifying an expertise vector of a user. This example embodiment is explained using FIGS. 8 to 11.

By way of example, and turning to FIG. 8, a user may have a list of other users which he or she may follow. For example, User A has a list of User B, User C and User D, which User A follows. The users (e.g. User B, User C and User D) are grouped under a list named List A, and the list has an associated list description (e.g. Description A). In other words, User A believes that User B, User C and User D are experts or knowledgeable in Topic A.

Another user, User E, may have the same or similar list name and description (e.g. same or similar to List A, Description A), but may have different users listed than those by User A. For example, User E follows User B, User C and User G. In other words, User E believes that User B, User C and User G are experts or knowledgeable in Topic A.

Another user, User F, may have the same or similar list name and description (e.g. same or similar to List A, Description A), but may have different users listed than those by User A. For example, User F follows User B, User H and User I, since User F believes these users are experts or knowledgeable in Topic A.

Based on the above example scenario, it can be appreciated that different users may have the same or similarly named or similarly described lists, but the users in each list can be different. In other words, different users may think that other different users are experts in a given topic.

Continuing with the example in FIG. 8, based on the number of times that a user is listed on another user's list for a given topic, the server 100 can determine whether the user is considered an expert by other users. For example, User B is listed on three different lists related to Topic A; User C is listed on two different lists; and each of User D, User G, User H and User I are only listed on one list. Therefore, in this example, User B is considered the foremost expert in Topic A, followed by User C.

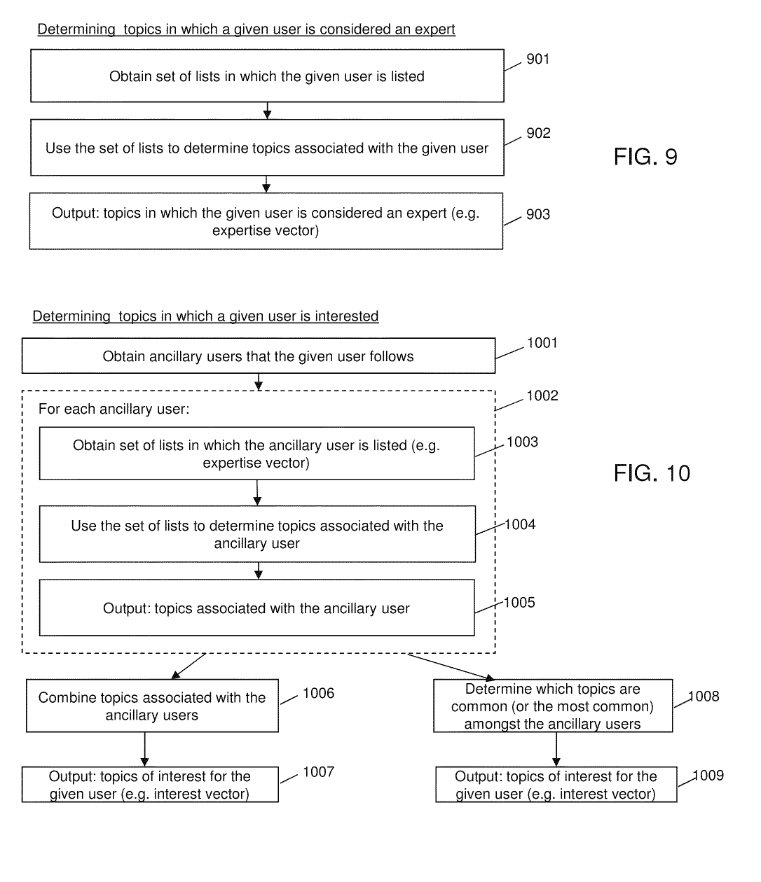

Turning to FIG. 9, an example embodiment of computer executable instructions is provided for determining topics for which a given user is considered an expert. At block 901, the server 100 obtains a set of lists in which the given user listed. At block 902, the server 100 uses the set of lists to determine topics associated with the given user. At block 903, the server outputs the topics in which the given user is considered an expert. These topics form an expertise vector of the given user. For example, if the user Alice is listed in Bob's fishing list, Celine's art list, and David's photography list, then Alice's expertise vector includes: fishing, art and photography.

In an example embodiment, the user lists are obtained by constantly crawling them, since the user lists are dynamically updated by users, and new lists are created often. In an example embodiment, the user lists are processed using an Apache Lucene index. The expertise vector of a given user is processed using the Lucene algorithm to populate the index of topics associated with the given user. This index supports, for example, full Lucene query syntax, including phrase queries and Boolean logic. By way of background, Apache Lucene is an information retrieval software library that is suitable for full text indexing and searching. Lucene is also widely known for its use in the implementation of Internet search engines and local single-site searching. It can be appreciated, that other currently known or future known searching and indexing algorithms can be used.

In an example embodiment, the computer executable instructions of FIG. 9 are implemented by module 110.

Turning to FIG. 10, an example embodiment of computer executable instructions is provided for determining topics in which a given user is interested. At block 1001, the server 100 obtains ancillary users that the given user follows.

At block 1002, a number of instructions are performed, but specific to each ancillary user. In particular, at block 1003, the server obtains a set of lists in which the ancillary user is listed (e.g. the expertise vector of the ancillary user). At block 1004, the server uses the set of lists to determine topics associated with the ancillary user. The outputs of block 1004 are topics associated with the ancillary user (block 1005). In an example embodiment, block 1002 can simply call on the algorithm presented in FIG. 9, but being applied to each ancillary user.

In an example embodiment, at block 1006, the server combines the topics from all the ancillary users. The combined topics form the output 1007 of the topics of interest for the given user (e.g. the interest vector of the given user).

In another example embodiment, an alternative to the blocks 1006 and 1007 is to determine which topics are common, or most common amongst the ancillary users (block 1008). For example, a given user Alice, follows ancillary users Bob, Celine and David. Bob is considered an expert in fishing and photography (e.g. the expertise vector of Bob). Celine is considered an expert in fishing, photography and art (e.g. the expertise vector of Celeine). David is considered an expert in fishing and music (e.g. the expertise vector of David). Therefore, since the topic of fishing is common amongst all the ancillary users, it is identified that Alice has an interest in the topic of fishing. Or, since photography is more common amongst the ancillary users (e.g. the second most common topic after fishing), then the topic of photography is also identified as a topic of interest for Alice. Since art and music are not common amongst the ancillary users, these topics are not considered to be topics interest to Alice.

In an example embodiment, module 111 implements the computer executable instructions presented in FIG. 10.

In an example embodiment, the data from the expertise vector and the data from interest vector are supplied to the Lucene algorithm for indexing.

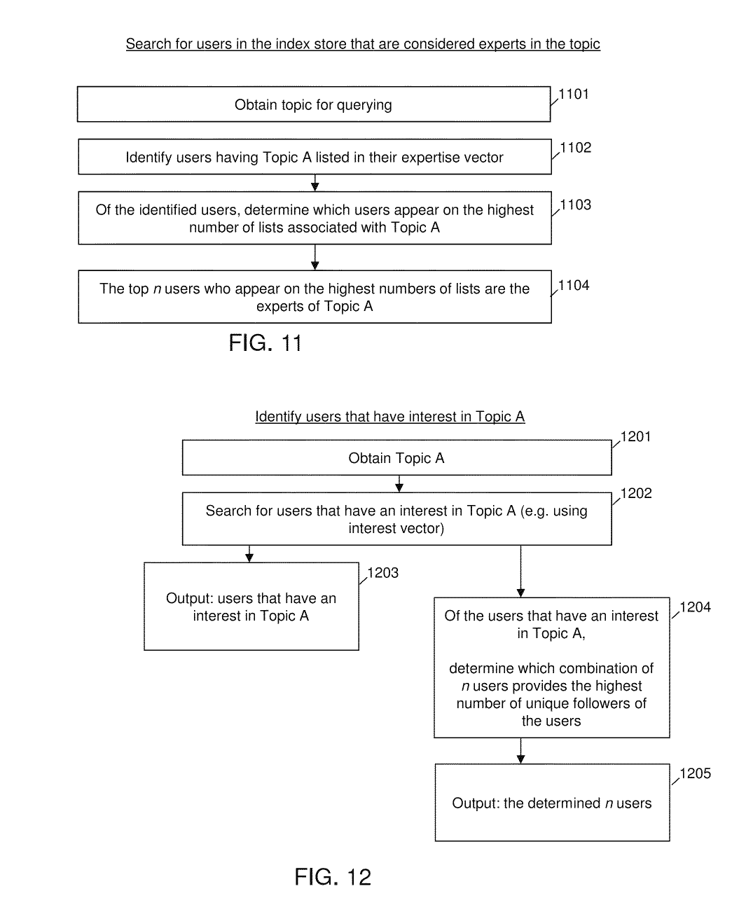

Turning to FIG. 11, example computer executable instructions are provided for searching for users in the index store 117 that are considered experts in a topic. At block 1101, the server obtains the topic for querying. At block 1102, the server 100 identifies users having Topic A (e.g. the topic being queried) listed in their expertise vector. At block 1103, of the identified users, the server determines which users appear on the highest number of lists associated with Topic A. At block 1104, the top n users who appear on the highest number of lists are the experts of Topic A. In other words, the server creates the set of users U_{T} to include the top n users and their followers.

In another example embodiment for determining users, which includes the principles described in FIGS. 8 to 11, there maximum reach of followers can be used to identify the top n users. The maximum reach computation determines how many unique followers associated with a set of users (e.g. experts, influencers). For example, if a first expert and a second experts have, combined, a total of two hundred unique followers, and the second expert and a third expert have, combined, a total of three hundred unique followers, then the second expert and the third expert have a larger “reach” of followers compared to the first expert and the second expert. Turning to FIG. 12, the example computer executable instructions are for identifying users that have an interest in Topic A, which can implemented by module 114. At block 1201, the server 100 obtains Topic A, for example, through a user input in the GUI. At block 1202, the server searches for users that have an interest in Topic A (e.g. by analysing the interest vector of each user). At block 1203, the identified users from block 1202 are outputted.

To determine the maximum reach for the users that have an interest in Topic A, the server determines which combination of n users provides the highest number of unique followers of the users (block 1204). The determined top n users are outputted (block 1205) along with their followers. In other words, the users U_{T} in the topic network include the top n users and their followers.

It will be appreciated that other known and future known ways to identify users related to a topic may be used in other example embodiments.

Identifying and filtering outlier users in the topic network:

With respect to identifying and filtering outlier nodes (e.g. users) within the topic network, as per blocks 306 and 406, it will be appreciated that different computations can be used. Below is a non-limiting example embodiment of implementing block 306 and 406.

It is recognized that the data from the topic network can be improved by removing problematic outliers. For instance, a query using the topic “McCafe” referring to the McDonalds coffee brand also happened to bring back some users from the Philippines who are fans of a karaoke bar/cafe of the same name. Because they happen to be a tight-knit community, their influencer score is often high enough to rank in the critical top-ten list.

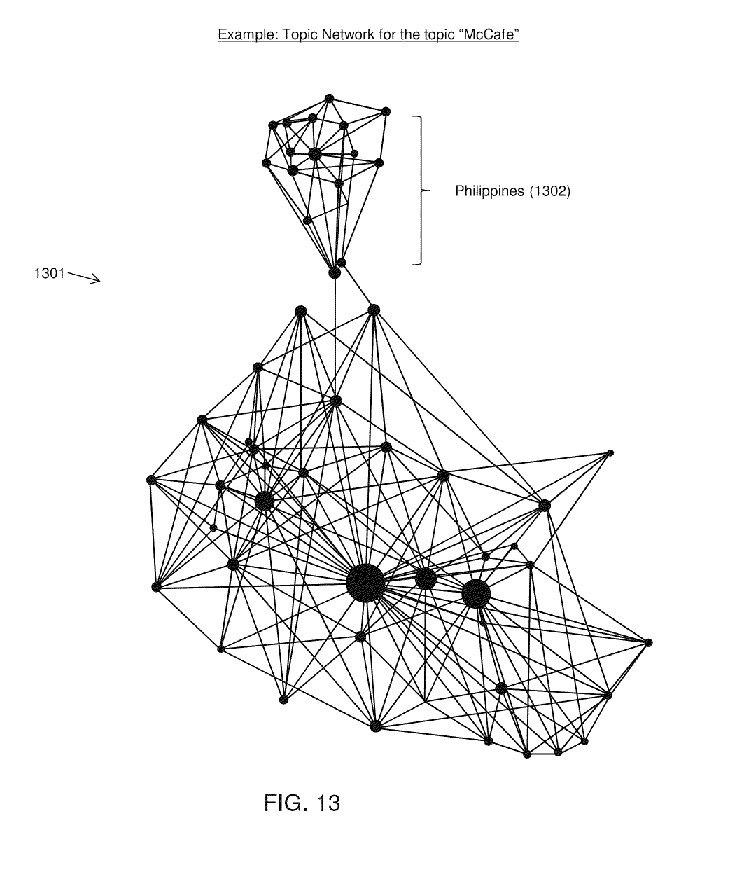

Turning to FIG. 13, an illustration of an example embodiment of a topic network 1301 showing unfiltered results is shown. The nodes represent the set of users U_{T} related to the topic McCafe. Some of the nodes 1302 or users are from the Philippines who are fans of a karaoke bar/cafe of the same name McCafe.

This phenomenon sometimes occurs in test cases, not limited to the test case of the topic McCafe. It is herein recognized that a user who looks for McCafe is not looking for both the McDonalds coffee and the Filipino karaoke bar, and thus this sub-network 1302 is considered noise.

To accomplish noise reduction, in an example embodiment, the server uses a network community detection algorithm called Modularity to identify and filter these types of outlier clusters in the topic queries. The Modularity algorithm is described in the article cited as Newman, M. E. J. (2006) “Modularity and community structure in networks,” PROCEEDINGS-NATIONAL ACADEMY OF SCIENCES USA 103 (23): 8577-8696, the entire contents of which are herein incorporated by reference.

It will be appreciated that other types of clustering and community detection algorithms can be used to determine outliers in the topic network. The filtering helps to remove results that are unintended or sought after by a user looking for influencers associated with a topic.

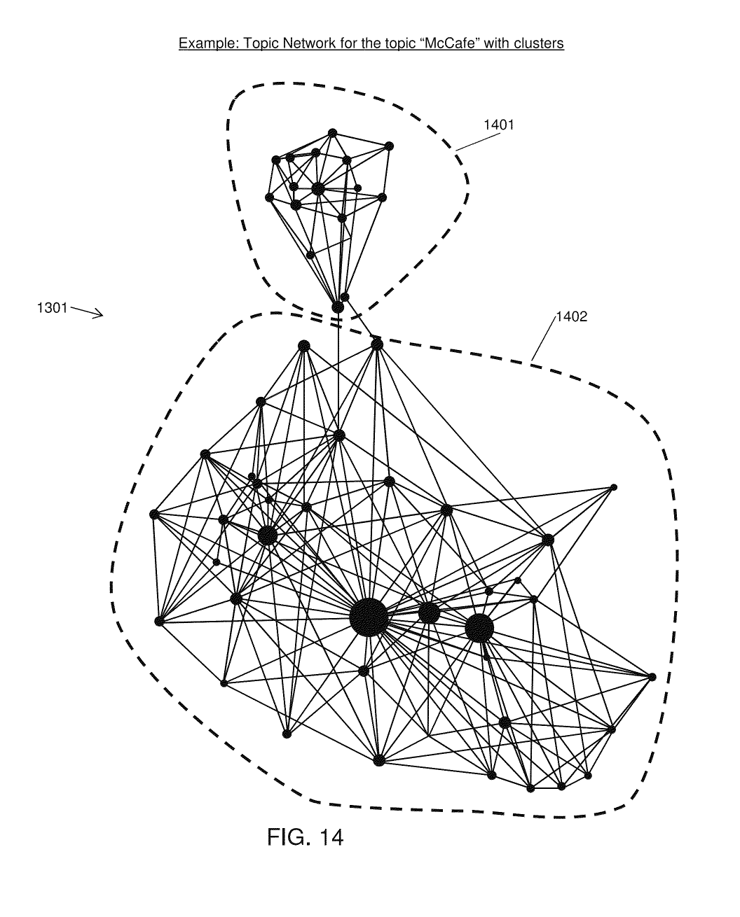

As shown in FIG. 14, an outlier cluster 1401 is identified relative to a main cluster 1402 in the topic network 1301. The outlier cluster of users U_{O} 1401 is removed from the topic network, and the remaining users in the main cluster 1402 are used to form the ranked list of outputted influencers.

In an example embodiment, the server 100 computes the following instructions to filter out the outliers:

1. Execute the Modularity algorithm on the topic network.

2. The Modularity function decomposes the topic network into modular communities or sub-networks, and labels each node into one of X clusters/communities. In an example embodiment, X<N/2, as a community has more than one member, and N is the number of users in the set U_{T}.

3. Sort the communities by the number of users within a community, and accept the communities with the largest populations.

4. When the cumulative sum of the node population exceeds 80% of the total, remove the remaining smallest communities from the topic network.

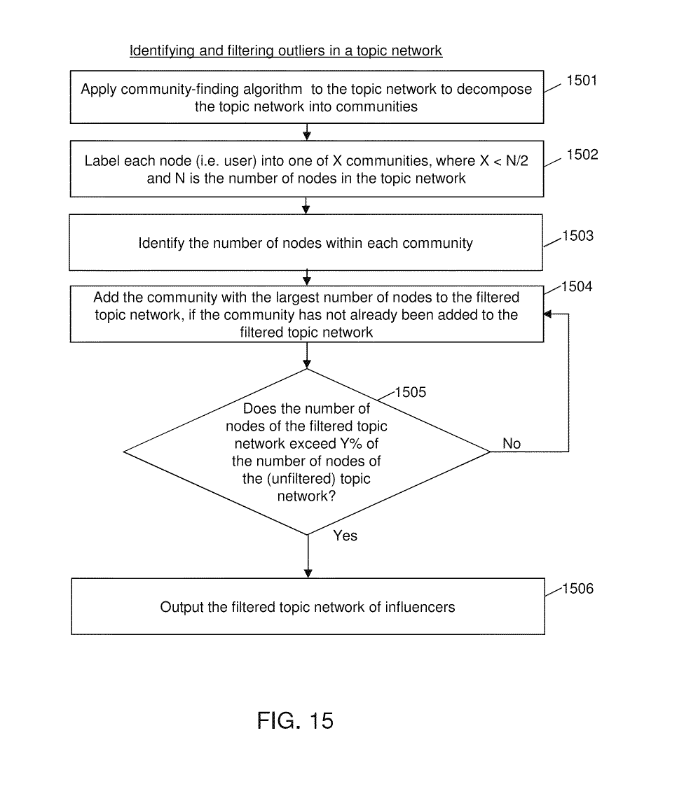

A general example embodiment of the computer executable instructions for identifying and filtering the topic network is described with respect to FIG. 15. It can be appreciated that these instructions can be used to execute blocks 306 and 406.

At block 1501, the server 100 applies a community-finding algorithm to the topic network to decompose the network into communities. Non-limiting examples of algorithms for finding communities include the Minimum-cut method, Hierarchical clustering, the Girvan-Newman algorithm, the Modularity algorithm referenced above, and Clique-based methods.

At block 1502, the server labels each node (i.e. user) into one of X communities, where X<N/2 and N is the number of nodes in the topic network.

At block 1503, the server identifies the number of nodes within each community.

The server then adds the community with the largest number of nodes to the filtered topic network, if that community has not already been added to the filtered topic network (block 1504). It can be appreciated that initially, the filtered topic network includes zero communities, and the first community added to the filtered topic network is the largest community. The same community from the unfiltered topic network cannot be added more than once to filtered topic network.

At block 1505, the server determines if the number of nodes of the filtered topic network exceeds, or is greater than, Y % of the number of nodes of the original or unfiltered topic network. In an example embodiment, Y % is 80%. Other percentage values for Y are also applicable. If not, then the process loops back to block 1504. When the condition of block 1505 is true, the process proceeds to block 1506.

Generally, when the number of nodes in the filtered topic network reaches or exceeds a majority percentage of the total number of nodes in the unfiltered topic network, then the main cluster has been identified and the remaining nodes, which are the outlier nodes (e.g. U_{O}), are also identified.

At block 1506, the filtered topic network is outputted, which does not include the outlier user U_{O}.

### Example

### McCafe Case Study

McCafe is a coffee-house style food and drink brand that McDonald's created. It contains a wide variety of menu items such as coffee, lattes, espressos, and smoothies. The influencer results using the systems and methods described herein for “McCafe” are shown in Table 2. The social network data comes from Twitter.

TABLE 2
The top-ranked Twitter handles ordered by influence score and Authority score for the
topic query “McCafe.”

| Twitter Users | | | | | |
|---|---|---|---|---|---|
| order by | Authority | | Twitter Users | Authority | |
| Influence | Score | PageRank | order by Authority | Score | PageRank |
| McCafe © | 8 | 2.255% | McDonald's Corp. | 10 | 1.682% |
| McDonald's | 10 | 1.682% | McDonald's | 10 | 0.959% |
| Corp. | | | | | |
| McDonald's | 6 | 1.478% | Divine Lee | 10 | 0.558% |
| Philly | | | | | |
| Marti | 7 | 1.236% | Victor Basa | 10 | 0.558% |
| McDonald's | 7 | 1.174% | Tyler Fox-Banks | 10 | 0.279% |
| SoCal | | | | | |
| The Mommy- | 8 | 1.164% | McDonald's | 10 | 0.234% |
| Files | | | Venezuela | | |
| McDonalds | 6 | 1.091% | hashtags | 10 | 0.203% |
| Eastern NE | | | | | |
| McDonaldsDMV | 6 | 1.017% | GUYEL | 10 | 0.136% |
| Rick Wion | 7 | 1.012% | The Product Poet | 10 | 0.107% |
| McDonald's | 9 | 0.960% | Mia Farrow | 10 | 0.074% |
| Canada | | | | | |
| McDonald's | 10 | 0.959% | Maxene Magalona | 10 | 0.065% |
| McDonalds | 8 | 0.916% | XIAN LIM | 10 | 0.065% |
| NYTriState | | | | | |
| Utah | 6 | 0.913% | Xeni Jardin | 10 | 0.000% |
| McDonald's | | | | | |
| Me Encanta | 6 | 0.910% | Manado Kota | 10 | 0.000% |

There are several observations for these results.

The influence score accurately lists the handle McCafe as the top influencer for the query, while the Authority score is 8. This does not appear on the first page of the Authority score.

Many local/regional McDonald's handles are rated highly with based on influence but had an Authority score lower than 10.

Rick Wion, with a low Authority score of 7, is the ninth highest-rated user based on influence. Rick Wion is the McDonald's VP of Social Media Engagement, who is clearly an influencer of McCafe on Twitter.

There are many inappropriate names in the Authority score list who may have mentioned McCafe and have a lot of followers, but they are clearly not influencers.

The above observations demonstrate the better quality of the influencer results when using the systems and methods described herein.

### Example

### Fanexpo Case Study

Fanexpo is an annual convention of comics, sci-fi and fantasy entertainment held in the city of Toronto, Canada. The top-ranked influencers for the topic query “Fanexpo” are shown on the left in Table 3, with comparison results based on Authority score shown on the right. The influencers are determined using the systems and methods described herein.

TABLE 3
The top-ranked Twitter handles ordered by influence score and Authority score for the
topic query “Fanexpo.”

| Twitter Users | | | | | |
|---|---|---|---|---|---|
| order by | Authority | | Twitter Users order | Authority | |
| influence | Score | PageRank | by Authority | Score | PageRank |
| Fan Expo | 8 | 1.241% | Dark Horse Comics | 10 | 0.749% |
| Canada | | | | | |
| C.B. Cebulski | 9 | 0.966% | Torontoist | 10 | 0.778% |
| Silver Snail | 7 | 0.822% | Michael Rooker | 10 | 0.580% |
| SpaceChannel | 8 | 0.790% | Amanda Tapping | 10 | 0.563% |
| Torontoist | 10 | 0.778% | National Post | 10 | 0.432% |
| Dark Horse | 10 | 0.749% | CTV Toronto | 10 | 0.322% |
| Comics | | | | | |
| Mark Brooks | 8 | 0.671% | CBC Top Stories | 10 | 0.310% |
| Michael | 9 | 0.661% | Nathan Fillion | 10 | 0.358% |
| Shanks | | | | | |
| Katie Cook | 8 | 0.659% | Brent Spiner | 10 | 0.350% |
| Kelly Sue | 8 | 0.637% | Jessica Nigri | 10 | 0.338% |
| DeConnick | | | | | |
| Ramon Perez | 7 | 0.632% | Meg Turney | 10 | 0.132% |
| Shaun Hatton | 7 | 0.627% | The Walking Dead | 10 | 0.215% |
| Fearless Fred | 9 | 0.614% | Eduardo Benvenuti | 10 | 0.119% |
| Alice Quinn | 7 | 0.583% | Randy Pitchford | 10 | 0.118% |

Several interesting observations can be seen when analyzing these results.

The influencer approach described herein accurately lists the handle Fan Expo Canada as the top influencer for the query, while the Authority approach gave it a score of 8.

The second-ranked influencer, C. B. Cebulski, is a famous writer for Marvel comics, who is considered very influential in this domain.

Notice in the top Authority rank, the above two influencers (i.e. Fan Expo Canada and C. B. Cebulski) do not appear in the critical first page.

The next four influencers, Silver Snail, SpaceChannel, Torontoist, and Dark Horse Comics, are a comics store in Toronto, a sci-fi TV channel, a Toronto entertainment blog and a comic publisher.

The top Authority ranks general news outlets National Post, CTV Toronto, CBC Top Stories, which are user accounts that are not appropriate for this topic.

The next series of influencers (e.g. Twitter account names) are either writers for Marvel or DC comics, or actors in sci-fi or fantasy film or a TV series. Notice that many of them have an Authority score of less than 10.

Again, the above observations demonstrate the better quality of the influencer results when using the systems and methods described herein.

### Example

### Nike Livestrong Case Study

Livestrong is an organization founded by now-disgraced cyclist Lance Armstrong to benefit cancer research. Nike recently cut relations with Livestrong after Armstrong was indicted on a doping scandal. The influencer results for the query “Nike Livestrong” are shown on the right in Table 4, using social network data from Twitter. The results using an Authority approach are shown on the right.

TABLE 4
The top-ranked Twitter handles ordered by influence score and Authority score for the
topic query “Nike Livestrong.”

| Twitter Users | | | | | |
|---|---|---|---|---|---|
| order by | Authority | | Twitter Users order | Authority | |
| influence | Score | PageRank | by Authority | Score | PageRank |
| Darren Rovell | 10 | 0.63% | Darren Rovell | 10 | 0.63% |
| The Associated | 10 | 0.45% | The Associated Press | 10 | 0.45% |
| Press | | | | | |
| Juliet Macur | 8 | 0.40% | Nice Kicks | 10 | 0.37% |
| Deadspin | 10 | 0.37% | Deadspin | 10 | 0.37% |
| Nice Kicks | 10 | 0.37% | NBC Nightly News | 10 | 0.32% |
| Joseph | 9 | 0.34% | Jim Roberts | 10 | 0.34% |
| Weisenthal | | | | | |
| Jim Roberts | 10 | 0.34% | Bloomberg News | 10 | 0.34% |
| Bloomberg | 10 | 0.34% | Sports Illustrated | 10 | 0.32% |
| News | | | | | |
| NBC Nightly | 10 | 0.32% | Business Insider | 10 | 0.29% |
| News | | | | | |
| Sports | 10 | 0.32% | CBSSports.com | 10 | 0.28% |
| Illustrated | | | | | |
| NYT Sports | 9 | 0.29% | Complex | 10 | 0.26% |
| Business | 10 | 0.29% | Cyclingnews.com | 10 | 0.25% |
| Insider | | | | | |
| CBSSports.com | 10 | 0.28% | Fast Company | 10 | 0.20% |

There are several interesting points from Table 4.

Many of the top influencers with Authority score 10 are sports news handles or sports journalists who wrote extensively on the Armstrong doping scandal.

In particular, Juliet Macur is third-ranked based on influence, while her Authority score is 8. She is a New York Times sports journalist who wrote the book “Cycle of Lies: the Fall of Lance Armstrong.”

Joseph Weisenthal is a sports business insider who tweeted about the doping scandal on the Nike Livestrong partnership.

While it may be difficult to distinguish between all the Twitter user accounts with an Authority score of 10, the influence ranking gives more specificity to the relative rank of the influencers.

Further details of the method steps described in FIG. 3 and FIG. 4 as particular related to identification of communities, identification of popular characteristics and their values within each community, and display of the results is described below.

Identifying Communities

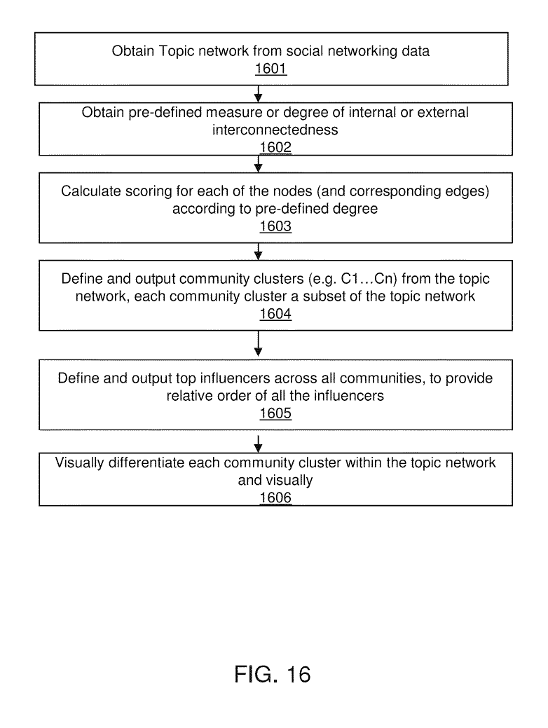

Turning to FIG. 16, an example embodiment of computer executable instructions are shown for identifying communities from social network data.

A feature of social network platforms is that users are following (or defining as a friend) another user. As described earlier, other types of relationships or interconnectedness can exist between users as illustrated by a plurality of nodes and edges within a topic network. Within the topic network, influencers can affect different clusters of users to varying degrees. That is, based on the process for identifying communities as described in relation to FIG. 16, the server is configured to identify a plurality of clusters within a single topic network, referred to as communities. Since influence is not uniform across a social network platform, the community identification process defined in relation to FIG. 16 is advantageous as it identifies the degree or depth of influence of each influencer (e.g. by associating with one community over another) across the topic network.

As will be defined in FIG. 16, the server is configured to provide a set of distinct communities (e.g. C1, . . . , Cn), and the top influencer(s) in each of the communities. In yet a preferred aspect, the server is configured to provide an aggregated list of the top influencers across all communities to provide the relative order of all the influencers.

At step 1601, the server is configured to obtain topic network graph information from social networking data as described earlier (e.g. FIG. 3-FIG. 4). The topic network visually illustrates relationships among the nodes a set of users (U_{T}) each represented as a node in the topic network graph and connected by edges to indicate a relationship (e.g. friend or follower-followee, or other social media interconnectivity) between two users within the topic network graph. At block 1602, the server obtains a pre-defined degree or measure of internal and/or external interconnectedness (e.g. resolution) for use in defining the boundary between communities.

At block 1603, the server is configured to calculate scoring for each of the nodes (e.g. influencers) and edges according to the pre-defined degree of interconnectedness (e.g. resolution). That is, in one example, each user handle is assigned a Modularity class identifier (Mod ID) and a PageRank score (defining a degree of influence). In one aspect, the resolution parameter is configured to control the density and the number of communities identified. In a preferred aspect, a default resolution value of 2 which provides 2 to 10 communities is utilized by the server. In yet another aspect, the resolution value is user defined (e.g. via computing device 101 in FIG. 2) to generate higher or lower granularity of communities as desired for visualization of the community information.

At block 1604, the server is configured to define and output distinct community clusters (e.g. C₁, C₂, . . . , Cₙ) thereby partitioning the users U_{T} into U_{C1} . . . U_{Cn} such that each user defined by a node in the network is mapped to a respective community. In one aspect, modularity analysis is used to define the communities such that each community has dense connections (high connectivity) between the cluster of nodes within the community but sparse connections with nodes in different communities (low connectivity). In one aspect, the community detection process steps 1603-1606 can be implemented utilizing a modularity algorithm and/or a density algorithm (which measures internal connectivity). Furthermore, visualization of the results is implemented utilizing Gephi, an open source graph analysis package, and/or a javascript library in one aspect.

At block 1605, the server is configured to define and output top influencer across all communities and/or top influencers within each community and provide relative ordering of all influencers. In one aspect, the top influencers are visually displayed alongside their community when a particular community is selected. In yet a further aspect, at block 1605, the server is configured to provide an aggregated list of all the top influencers across all communities to provide the relative order of all the influencers.

At block 1606, the server is configured to visually depict and differentiate each community cluster (e.g. by colour coding or other visual identification to differentiate one community from another). In a further aspect, at block 1606, the server is configured to provide a set of top influencers in each of the communities visually linked to the respective community. In yet a further aspect, the server at block 1606, the server is configured to vary the size of each node of the community graph to correspond to the score of the respective influencer (e.g. score of influence). As output from block 1606, the edges from the nodes show connections between each of the users, within their community and across other communities.

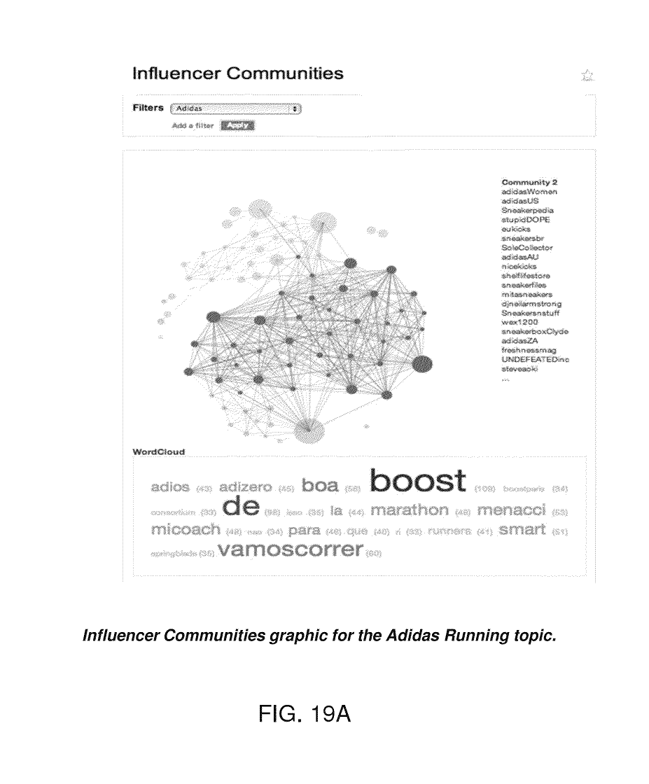

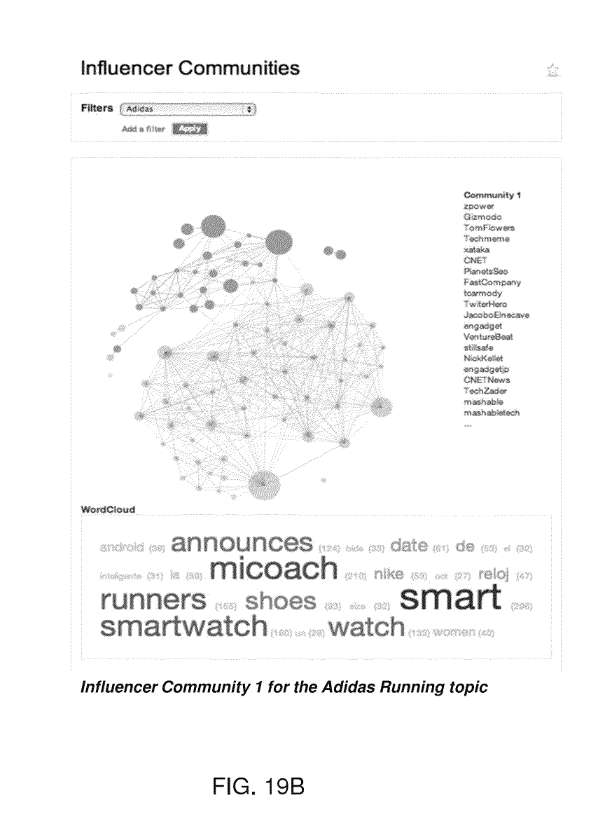

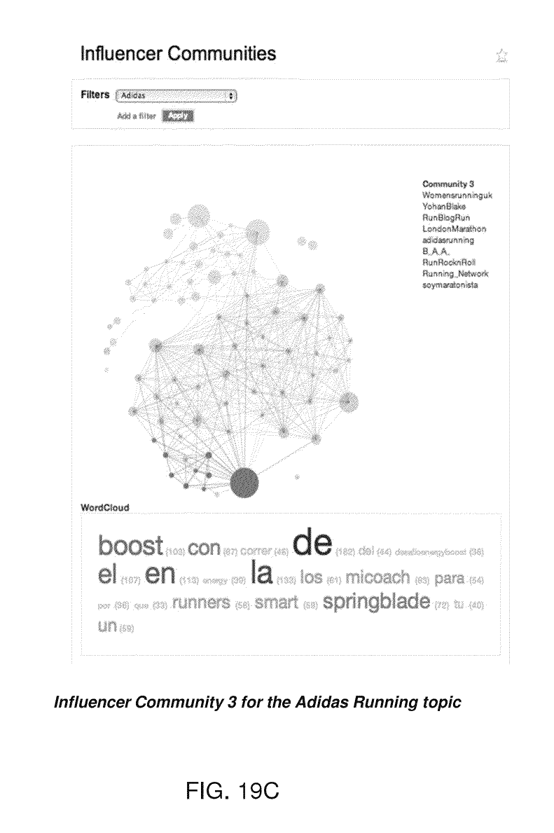

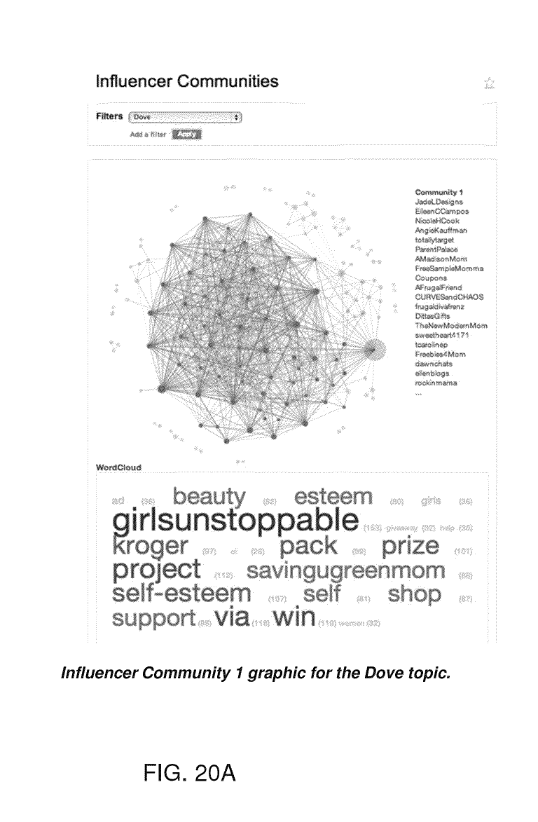

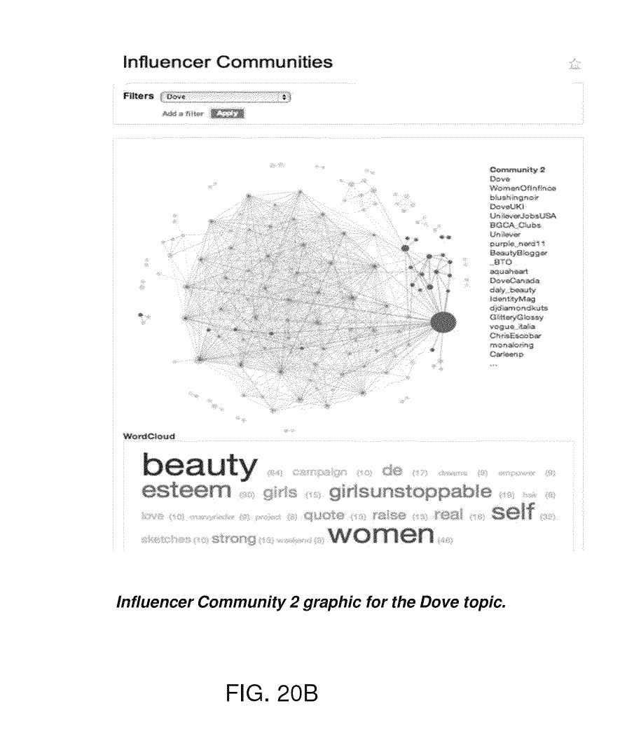

Accordingly, as will be shown in FIGS. 19A-19C and 20A-20B the visualization of the communities and the influencers (e.g. the top influencers ranked within each communities and/or a listing of top influencers across all communities) allow an end user (e.g. a user of computing device 101 in FIG. 2) to visualize the scale and relative significance of each of the influencers in their associated communities.

Identifying Popular Characteristics within a Given Community

As described in relation to FIGS. 3 and 4, in yet a further aspect, the server is configured to determine, for each given community (e.g. C₁) provided by block 1603, popular characteristic values for pre-defined characteristics (e.g. common keywords and phrases, topics of conversations, common locations, common images, common meta data) associated with users (e.g. U_{C1}) within the given community (e.g. C₁), based on their social network data. Accordingly, trends or commonalities by examining the pre-defined set of characteristics (e.g. topics of conversation) for users U_{C1} within each community C₁ can be defined. In one aspect, the top listing of characteristic values (e.g. top topics of conversation among all users within each community) is depicted at block 1605 and output to the computing device 101 (shown in FIG. 2) for display in association with each community.

### Displaying Communities and Popular Characteristics

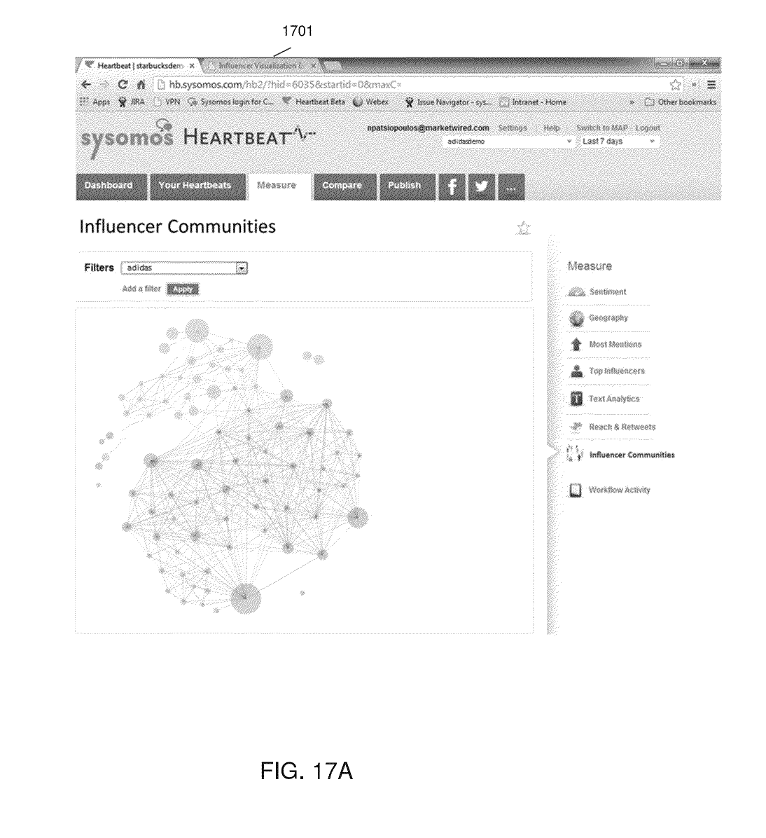

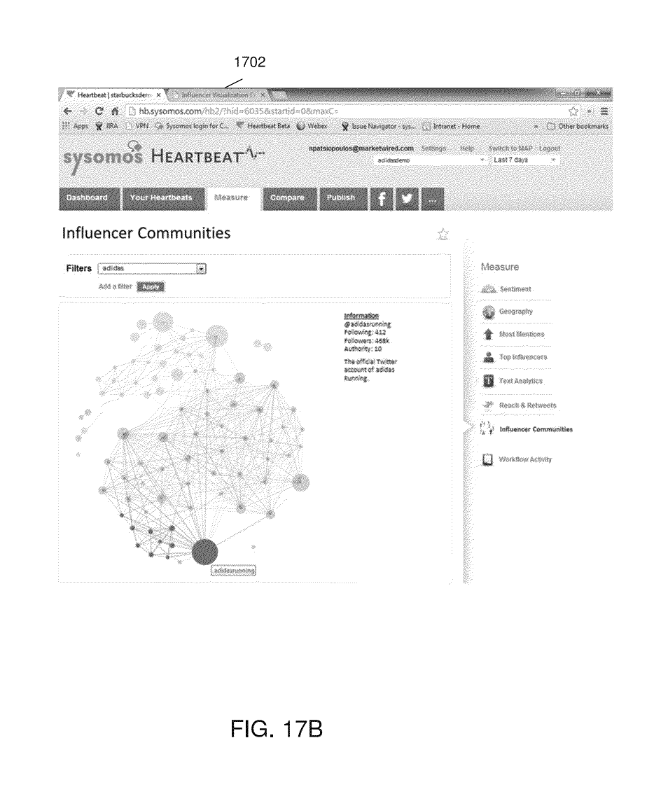

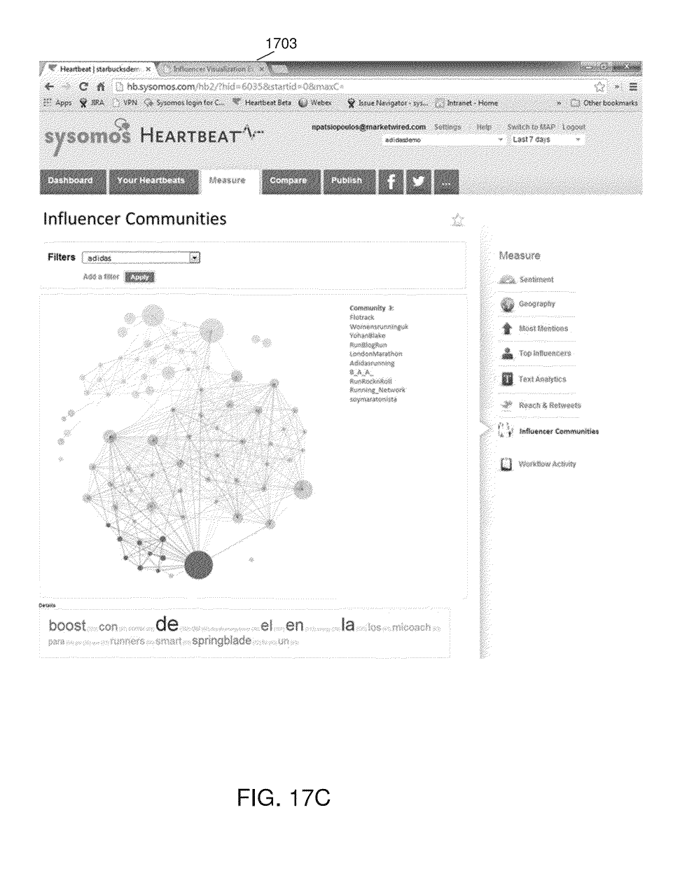

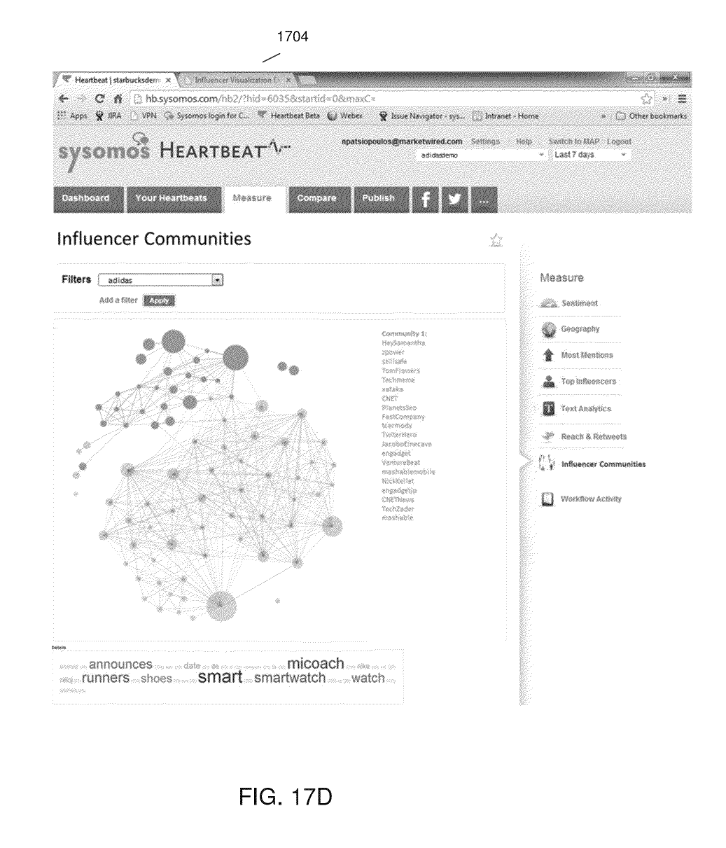

Referring to FIGS. 17A-17D shown are screen shots as provided from GUI module 106 of the server and output to display screen 125 of computing device (FIG. 2) for visualization of the community clusters from a topic network and visualization of the popular characteristics in each community. As shown in FIGS. 17A-17D, the server provides an interactive interface for selecting communities and/or nodes within the topic network/particular community for visually revealing details about each node (e.g. user, community information and degree of influence). Accordingly, FIGS. 17A-17D illustrate the interactive visualization of the Influencer Communities and their characteristic (e.g. conversations for each community in a WordCloud visualization technique). As also shown in FIGS. 17A-17D, each community (e.g. consisting of edges and nodes) is visually differentiated from another community (e.g. by colour coding) and each node is sized according to degree of influence within the entire topic network. The degree of influence of a user, for example, corresponds to the ranking of a user account within a community or the entire topic network. Furthermore, by selecting a particular community (e.g. visual selection using a mouse or pointer of the community from the topic network), the community values are then depicted (e.g. highlighting the community within the topic network graph, revealing the top influencers within the community, and revealing popular characteristic values for top topics of conversation for the selected community). In FIGS. 17A-17D, the visualization of the popular characteristic values on the display screen (e.g. screen of computing device 101 in FIG. 2) is shown as a word cloud which depicts top conversation topics within the selected community as well as an indication of the frequency of use of each topic within all users of the particular community.

Referring to FIG. 17A, shown is a screen 1701 (e.g. of computing device 101 in FIG. 2), illustrating that within a topic search (e.g. search for term “adidas”, there are multiple conversations occurring in several communities (clusters, segments) of a social network.

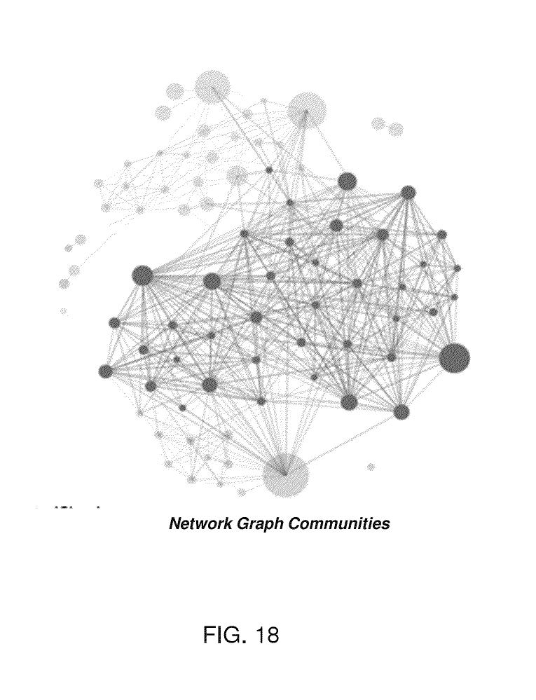

Referring to FIG. 18, shown is a screen illustrating that within another topic search, the topic network has a plurality of community clusters each visually differentiated from one another and the nodes sized to reflect the degree of influence, preferably within the entire topic network.

Referring to FIG. 17B, shown is a screen 1702 which depicts that the nodes are color coded to visually associate them with their respective community and the size of each node is proportional to the Influencer score in their community (color coded) relative to the overall topic network. FIG. 17B further illustrates that by selecting anode (e.g. hovering the mouse pointer over a node), the Twitter handle (e.g. adidasrunning) pops up and the information for that handle is displayed is displayed on screen 1702 (e.g. in the right hand list under Information).

Referring to FIG. 17C, shown is a screen 1703, and choosing a sub-graph visually highlights the top Influencers in that selected community, and gives a visual representation on the screen 1703 (e.g. wordcloud of the conversations in that community). As illustrated in FIG. 17, insight into community behavior; positive/negative sentiment is shown.

Referring to FIG. 17D shown is a screen 1704, where a community (e.g. community 1) is selected (e.g. by user input selection via computing device 101 of FIG. 2) and the top influencers within the community are visually depicted alongside the topic network that is highlighted to show the selected community. FIG. 17D shows exemplary use of advanced network analysis for community detection (e.g. Modularity), and influence (using PageRank). The approach in FIG. 17A-17D is advantageous as it allows large scale processing of social networking data (e.g. full Twitter. Firehose) rather than sampling the social network data as that would miss small but potentially significant communities of influencers.

Defining Popular Characteristics (e.g. Conversation Topics) within a Community

Referring to FIGS. 19A-19C and 20A-20B, shown are exemplary screen shots of various influencer communities within two different topic networks (e.g. Adidas and Dove respectively). As illustrated in these figures, while the identities of user handles in each community can give some insight into the demographics of the community, it is desirable to show a more concrete description of the community. Accordingly, in one aspect (e.g. example implementation of FIGS. 3 & 4), the sample of tweets returned from the topic search query is identified and a frequency count is generated on the relevant terms to generate a word cloud of the popular terms in the conversations of each community. With this visualization, one can thus easily visually identify the behavioural characteristics of each community and use this information to make a more targeted message to the influencers in each community.

FIGS. 19A-19C and 20A-20B illustrate an example implementation for determining and visualizing the community clusters within atopic network and the associated popular characteristic values for each community (e.g. example implementation of FIG. 3 or 4). In accordance with one implementation, FIGS. 19A-19C and 20A-20B utilize the underlying Twitter data obtained from the Sysomos search engine, which is formed by a user defined list of Boolean keyword search terms over a specified period of time in one example implementation.

### Example

### Adidas Running Case Study—FIGS. 19A-19C

The darker shaded groups in FIGS. 19A-19C respectively, correspond to the three largest Communities in the “Adidas Running” topic. The highlighted community (blue) in FIG. 19A corresponds to the largest set of influencers.

As can be seen from FIG. 19A, the word cloud and the user handles illustrate that the conversation in this community appears to be around Adidas sneakers and shoes.

In FIG. 19B, the second largest community (orange), has conversations around the Adidas Micoach smartwatch for training. There are also many gadget review handles in this community such as Engadget, CNET, Mashable, FastCompany, and Gizmodo.

In FIG. 19C, the main AdidasRunning handle is part of this smaller community (green), with serious running handles such as YohanBlake, RunBlogRun, LondonMarathon, B_A_A (Boston Athletic Association), RunningNetwork, etc.

Upon a review of the visualization screens for the communities and their characteristics in FIGS. 19A-19C, it can be seen that AdidasRunning may be well connected to the serious running community (green), but is not well connected to the larger influencer communities of sneaker aficionados (blue) and the gadget review (orange) communities. Accordingly, it can be determined that for effective influencer marketing, AdidasRunning should connect with the key influencers in the other communities and that their messages could be tailored to the other communities such as to have better overlap and connection with the other communities.

### Example

### Dove Case Study

FIGS. 20A and 20B show the two largest communities in the Dove (soap) product topic in darker shading. FIG. 20A has the largest community (blue) of relatively low influencers. As can be visually revealed from the user handles and the word cloud of FIGS. 20A and 20B, the user handles and word could reflect that the users of influence/topics of influence seem to be the “mommy bloggers” interested in saving, shopping, win, prize, Kroger (supermarket).

As well, Dove's “girlsunstoppable” campaign has influence within this community.

FIG. 20B depicts a smaller community which has the official Dove corporate handles (DoveCanada, DoveUK, Unilever, etc.) as well as some semi-influential beauty bloggers.

Therefore upon a review of FIGS. 20A and 20B, it can be visually revealed that that while Dove (as a Topic query) is well connected among influential beauty bloggers, there can be a stronger connection with the mommy bloggers as they are the larger community as compared to the beauty bloggers. Again, one can tailor the message differently to the influencers in this community without alienating the others.

Thus as discussed in reference to the figures (e.g. FIGS. 2, 3-4, 16-20b), there is presented a system and method for identifying influencers within their social communities (based on obtained social networking data) for a given query topic. It can also be seen that influencers do not have uniform characteristics, and there are in fact communities of influencers even within a given topic network. The systems and methods presented herein are utilized to output visualization on the computing device (e.g. computing device 101) visualized in a network graph to display the relative influencer of entities or individuals and their respective communities. Additionally popular characteristic values (e.g. based on pre-defined characteristic such as topics of conversation) are visually depicted on the display screen of the computing device for each community showing the top or relevant topics. The topics can be depicted as word clouds of each community's conversation to visually reveal the behavioural characteristics of the individual communities.

General examples of the methods and systems are provided below.

In an example embodiment, a method is performed by a server for determining at least one user account that is influential for a topic. The method includes: obtaining the topic; determining a plurality of user accounts within a social data network that are related to the topic; representing each of the user accounts as a node in a connected graph and determining an existence of a relationship between each of the user accounts; computing a topic network graph using each of the user accounts as nodes and the corresponding relationships as edges between each of the nodes; ranking the user accounts within the topic network graph to filter outlier nodes within the topic network graph; identifying at least two distinct communities amongst the user accounts within the filtered topic network graph, each community associated with a subset of the user accounts; identifying attributes associated with each community; and outputting each community associated with the corresponding attributes.

In an example aspect, the method further includes: ranking the user accounts within each community and providing, for each community, a ranked listing of the user accounts mapped to the corresponding community.

In an example aspect, wherein ranking the user accounts further comprises: mapping each ranked user account to the respective community and outputting a ranked listing of the user accounts for the at least two communities.

In an example aspect, wherein the attributes are associated with each user account's interaction with the social data network.

In an example aspect, wherein the attributes are displayed in association with a combined frequency of the attribute for the user accounts.

In an example aspect, wherein the attributes are frequency of topics of conversation for the users within a particular community.

In an example aspect, the method further includes displaying in a graphical user interface the at least two distinct communities comprising color coded nodes and edges, wherein at least a first portion of the color coded nodes and edges is a first color associated with a first community and a least a second portion of the color coded nodes and edges is a second color associated with a second community.

In an example aspect, wherein a size of a given color coded node is associated with a degree of influence of a given user account represented by the given color coded node.

In an example aspect, the method further includes displaying words associated with a given community, the words corresponding to the attributes of the given community.

In an example aspect, the method further includes detecting a user-controlled pointer interacting with a given community in the graphical user interface, and at least one of: displaying one or more top ranked user accounts in the given community; visually highlighting the given community; and displaying words associated with a given community, the words corresponding to the attributes of the given community.

In another example embodiment, a computing system is provided for determining at least one user account that is influential for a topic. The computing system includes: a communication device; a memory; and a processor configured to at least: obtain the topic; determine a plurality of user accounts within a social data network that are related to the topic; represent each of the user accounts as a node in a connected graph and determining an existence of a relationship between each of the user accounts; compute a topic network graph using each of the user accounts as nodes and the corresponding relationships as edges between each of the nodes; rank the user accounts within the topic network graph to filter outlier nodes within the topic network graph; identify at least two distinct communities amongst the user accounts within the filtered topic network graph, each community associated with a subset of the user accounts; identify attributes associated with each community; and output each community associated with the corresponding attributes.

In another example embodiment, a method is provided that is performed by a server for determining one or more users who are influential for a topic. The method includes: obtaining a topic; determining users within a social data network that are related to the topic; modeling each of the users as a node and determining relationships between each of the users; computing atopic network graph using the users as nodes and the relationships as edges; ranking the users within the topic network graph; identifying and filtering outlier nodes within the topic network graph; and outputting users remaining within the topic network graph according to their associated rank.

In an example aspect, the users that at least one of consume and generate content comprising the topic are considered the users related to the topic.

In another example aspect, in the topic network graph, an edge defined between at least two users represents a friend connection between the at least two users.

In another example aspect, in the topic network graph, an edge defined between at least two users represents a follower-followee connection between the at least two users, and wherein one of the at least two users is a follower and the other of the least two users is a followee.

In another example aspect, in the topic network graph, an edge defined between at least two users represents a reply connection between the at least two users, and wherein one of the at least two users replies to a posting made by the other of the at least two users.

In another example aspect, in the topic network graph, an edge defined between at least two users represents a re-post connection between the at least two users, and wherein one of the at least two users re-posts a posting made by the other of the at least two users.

In another example aspect, the ranking includes using a PageRank algorithm to measure importance of a given user within the topic network graph.

In another example aspect, the ranking includes using at least one of: Eigenvector Centrality, Weighted Degree, Betweenness, and Hub and Authority metrics.

In another example aspect, identifying and filtering the outlier nodes within the topic network graph includes: applying at least one of a clustering algorithm, a modularity algorithm and a community detection algorithm on the topic network graph to output multiple communities; sorting the multiple communities by a number of users within each of the multiple communities; selecting a number n of the communities with the largest number of users, wherein a cumulative sum of the users in the n number of the communities at least meets a percentage threshold of a total number of users in the topic network graph; and establishing users in unselected communities as the outlier nodes.

In another example embodiment, a computing system is provided for determining one or more users who are influential for a topic. The computing system includes: a communication device; memory; and a processor. The processor is configured to at least: obtain a topic; determine users within a social data network that are related to the topic; model each of the users as a node and determining relationships between each of the users; compute a topic network graph using the users as nodes and the relationships as edges; rank the users within the topic network graph; identify and filter outlier nodes within the topic network graph; and output users remaining within the topic network graph according to their associated rank.

In another aspect of social data networks, it is herein recognized that social networks allow influencers to easily pass on information to all their followers (e.g., re-tweet or @reply using Twitter) or friends (e.g., share using Facebook). However, the obvious caveat lies in identifying the right influencers. Some graph analytic methodologies use a keyword query to identify influencers who generate content (e.g., tweets or posts) referring to a brand, in a given time frame. The method considers the follower-following (or friend) relationship among the individuals and also identifies groupings among these individuals. The groupings allow a brand to send customize messages to different audiences. However, not all followers (or friends) will value and spread an individual's opinion on a brand. Understanding the significance or characterization of a follower and followee relationship is difficult for computers based on typical data measurements.

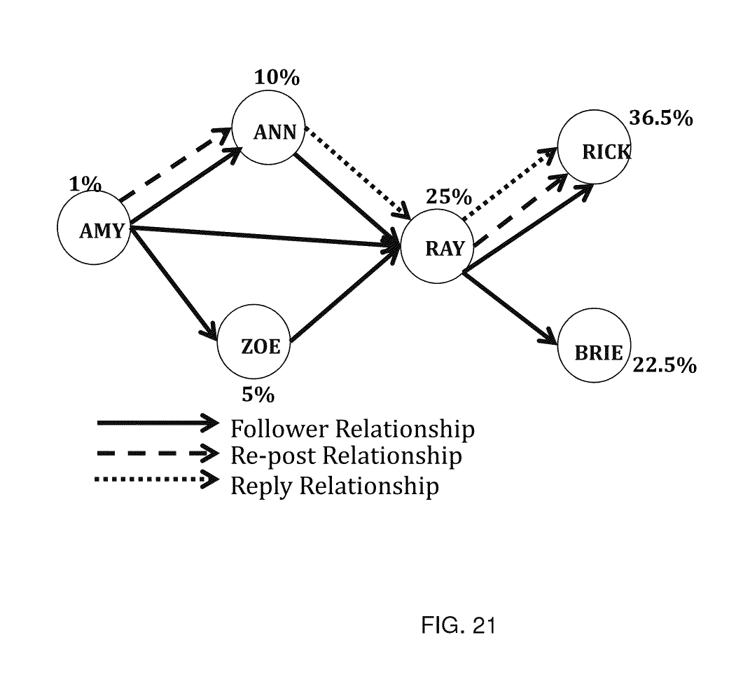

It further herein recognized that when all the links in the network are treated equal, such an approach fails to capture an important aspect of human psyche. People's “trust” tends to change over time. For example, while Amy follows Ann and Zoe (see FIG. 21), Amy chooses to re-post posts from Ann in the given timeframe and could re-post posts from Zoe sometime in the future. Thus, all links in the network are not equally important in spite of representing the same relationship.

The term “post” or “posting” refers to content that is shared with others via social data networking. A post or posting may be transmitted by submitting content on to a server or website or network for other to access. A post or posting may also be transmitted as a message between two devices. A post or posting includes sending a message, an email, placing a comment on a website, placing content on a blog, posting content on a video sharing network, and placing content on a networking application. Forms of posts include text, images, video, audio and combinations thereof.

More generally, the proposed systems and methods provide a way to determine the influencers in a social data network. In the proposed example systems and methods, weighted edges or connections, are used to develop a network graph and several different types of edges or connections are considered between different user nodes (e.g. user accounts) in a social data network. These types of edges or connections include: (a) a follower relationship in which a user follows another user; (b) a re-post relationship in which a user re-sends or re-posts the same content from another user; (c) a reply relationship in which a user replies to content posted or sent by another user; and (d) a mention relationship in which a user mentions another user in a posting.

In a non-limiting example of a social network under the trade name Twitter, the relationships are as follows:

Re-tweet (RT): Occurs when one user shares the tweet of another user. Denoted by “RT” followed by a space, followed by the symbol @, and followed by the Twitter user handle, e.g., “RT @ABC followed by a tweet from ABC).

@Reply: Occurs when a user explicitly replies to a tweet by another user. Denoted by ‘@’ sign followed by the Twitter user handle, e.g., @username and then follow with any message.

@Mention: Occurs when one user includes another user's handle in a tweet without meaning to explicitly reply. A user includes an @ followed by some Twitter user handle somewhere in his/her tweet, e.g., Hi @XYZ let's party @DEF @TUV

These relationships denote an explicit interest from the source user handle towards the target user handle. The source is the user handle who re-tweets or @replies or @mentions and the target is the user handle included in the message.

In the example of using weighted edges to identify top influencers and their communities, the network links are weighted to create a notion of link importance and further, external sources are identified and incorporated into the social data network. Examples of external sources include users and their activities of re-posting an old message or content posting, or users and their activities of referencing or mention an old message or content posting. Another example of an external source is a user and their activity of mentioning a topic in a social data network, but the topic originates from another or ancillary social data network.

As an example, consider the simplified follower network for a particular topic in FIG. 21. FIG. 21 depicts a social network with several kinds of links: a follower-following relationship; a re-post relationship, and another is a reply relationship. The mention relationship is applicable, although it is not shown in the particular example of FIG. 21. It is shown that Ray is fairly influential since he has the largest number of followers in the network. However, Rick and Brie also have significant influence as Ray follows them both. Between Rick and Brie, Rick is likely a stronger influencer since Ray has also re-posted and replied to Rick's posts (e.g. tweets or messages). In the given network, the influencers are likely Rick and Ray.

As seen in FIG. 21, taking into consideration the re-post and the reply relationships (or share) along with the follower (or friend) information provides a more accurate picture of the true influencers and also improves the groups identified.

It can be appreciated that the nodes in the graph represent different user accounts, such a user account for Ray and another user account for Rick. The direction of the arrows is also used to indicate who is the prime user (e.g. author, originator, person or account being mentioned by another, followee, etc.) and who is the secondary user (e.g. re-poster, follower, replier, person who does the mentioning, etc.). For example, the arrow head represents the prime user and the tail of the arrow represents the secondary user.

Beside each user account in FIG. 21, a PageRank score is provided. The PageRank algorithm is a known algorithm used by Google to measure the importance of website pages in a network and can be also applied to measuring the importance of users in a social data network.

The intuition is that, if a few experts consider someone an expert, then s/he is also an expert. However, the PageRank algorithm gives a better measure of influence than only counting the number of followers. As will be described below, the PageRank algorithm and other similar ranking algorithms can be used with the proposed systems and methods described herein.

The proposed systems and method also recognize that influencers may come from external sources. The notion of “external” sources may take two forms. First, even though an influencer may not have tweeted recently on a given topic, Twitter-sphere may continue to mention her or retweet one of her old posts, given her influence on this topic. For example, a sports expert may share his/her opinion on the Super Bowl and that opinion gets talked about for months after the actual game.

Second, individuals often converse about topics that originate from sources entirely outside of the network. For example, videos hosted on YouTube may be tweeted. In both cases the proposed systems and methods aim to capture the video/opinion sources as influencers.

In a general example embodiment, a weighted network analysis methodology is provided to identify communities and their top influencers by (1) weighting the network links to create a notion of “link importance” and (2) identifying and incorporating some key “external” sources into the network. Additionally, an aggregated list of the top influencers across all communities is provided, which is used to help determine a relative order of all the influencers. The visualization of the communities and the influencers allow end-users to understand the scale and relative significance of each of the influencers and their interconnections in their communities.

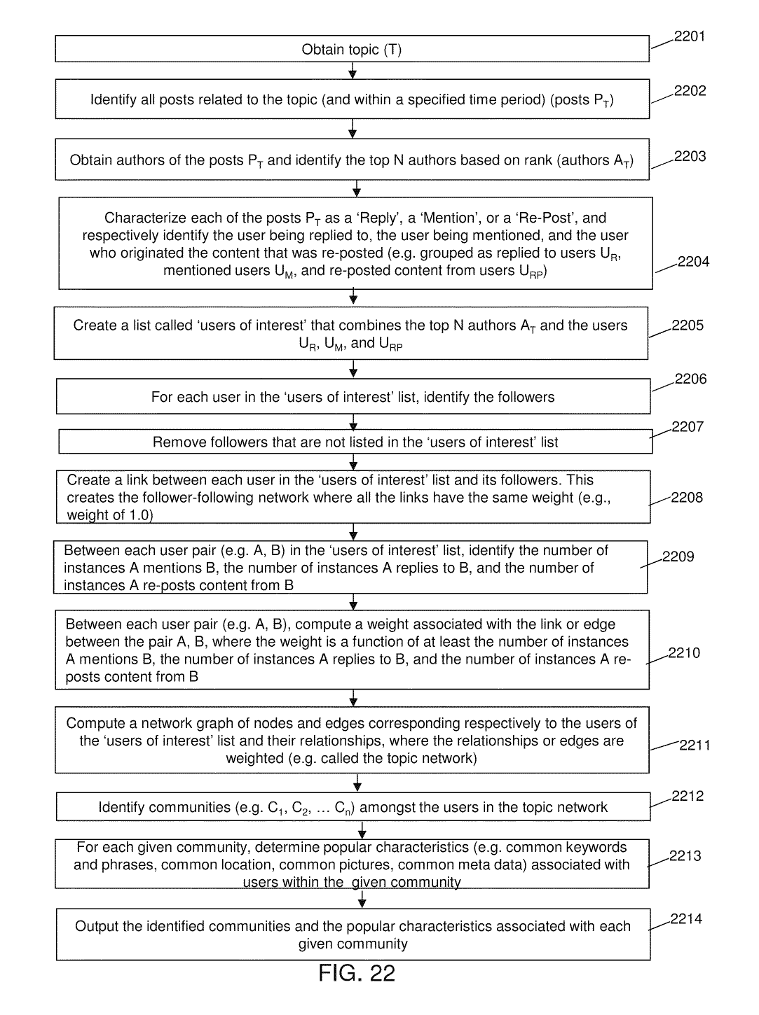

Turning to FIG. 22, an example embodiment of computer executable instructions are shown for determining one or more influencers of a given topic. The process shown in FIG. 22 assumes that social network data is available to the server 100, and the social network data includes multiple users. At block 2201, the server 100 obtains a topic represented as T. For example, a user may enter in a topic via a GUI displayed at the computing device 101, and the computing device 101 sends the topic to the server 100. At block 202, the server uses the topic to identify all posts related to the topic. These set of posts are collectively denoted as P_{T}. In an example embodiment, one or more additional search criteria are used, such as a specified time period. In other words, the server may only be examining posts related to the topic within a given period of time. Finding posts related to a certain topic can be implemented in various ways and will be discussed in further detail below.

Continuing with FIG. 2, the server obtains authors of the posts P_{T} and identifies the top N authors based on rank (block 2203). The set of top ranked authors is represented by A_{T}. In an example embodiment, the top N authors are identified using the Authority Score. Other methods and processes may be used to rank the authors. For example, the server uses PageRank to measure importance of a user within the topic network and to rank the user based on the measure. Other non-limiting examples of ranking algorithms that can be used include: Eigenvector Centrality, Weighted Degree, Betweenness, Hub and Authority metrics.

It is appreciated that the authors are uses in the social network that authored the posts. It is also appreciated that N is a counting number. Non-limiting example values of N include those values in the range of 3,000 to 5,000. Other values of N can be used.

At block 2204, the server characterizes each of the posts P_{T} as a ‘Reply’, a ‘Mention’, or a ‘Re-Post’, and respectively identifies the user being replied to, the user being mentioned, and the user who originated the content that was re-posted (e.g. grouped as replied to users U_{R}, mentioned users U_{M}, and re-posted content from users U_{RP}). The time stamp of each reply, mention, re-post, etc. may also be recorded in order to determine whether an interaction between users is recent, or to determine a ‘recent’ grading.

At block 2205, the server generates a list called ‘users of interest’ that combines the top N authors A_{T} and the users U_{R}, U_{M}, and U_{RP}. Non-limiting examples of the numbers of users in the ‘users of interest’ list or group include those numbers in range of 3,000 to 10,000. It will be appreciated that the number of users in the ‘users of interest’ group or list may be other values.

For each user in the ‘users of interest’ list, the server identifies the followers of each user (block 2206). At block 2207, the server removes the followers that are not listed in the ‘users of interest’ list, while still having identified the follower relationships between those users that are part of the ‘users of interest’.

In a non-limiting example implementation of block 2206, it was found that there were several million follower connections or edges when considering all the followers associated with the ‘users of interest’. Considering all of these follower edges may be computationally consuming and may not reveal influential interactions. To reduce the number of follower edges, those followers that are not part of the ‘users of interest’ are discarded as per block 2207.

In an alternative embodiment of blocks 2206 and 2207, the server identifies the follower relationships limited to only users listed in the ‘users of interest’ group.

At block 2208, the server creates a link between each user in the ‘users of interest’ list and its followers. This creates the follower-following network where all the links have the same weight (e.g., weight of 1.0).

At block 2209, between each user pair (e.g. A, B) in the ‘users of interest’ list, the server identifies the number of instances A mentions B, the number of instances A replies to B, and the number of instances A re-posts content from B. It can be appreciated that a user pair does not have to have a follower-followee relationship. For example, a user A may not follow a user B, but a user A may mention user B, or may re-post content from user B, or may reply to a posting from user B. Thus, there may be an edge or link between a user pair (A,B), even if one is not a follower of the other.

Furthermore, at block 2210, between each user pair (e.g. A, B), the server computes a weight associated with the link or edge between the pair A, B, where the weight is a function of at least the number of instances A mentions B, the number of instances A replies to B, and the number of instances A re-posts content from B. For example, the higher the number of instances, the higher the weighting.

In an example embodiment, at block 2208, the weighting of an edge is initialized at a first value (e.g. value of 1.0) when there is a follower-followee link and otherwise the edge is initialized at a second value (e.g. value of 0) where there is no follower-followee link, where the second value is less than the first value. Each additional activity (e.g. reply, repost, mention) between two users will increase the edge weight to a maximum weighting value of 4.0. Other numbers or ranges can be used to represent the weighting.

In an example embodiment, the relationship between the increasing number of activity or instances and the increasing weighting is characterized by an exponentially declining scale. For example, consider a user pair A,B, where A follows B. If there are 2 re-posts, the weighting is 2.0. If there are 20 re-posts, the weighting is 3.9. If there are 400 re-posts, the weighting is 4.0. It is appreciated that these numbers are just for example and that different numbers and ranges can be used.

In an example embodiment, the weighting is also based on how recent did the interaction (e.g. the re-post, the mention, the reply, etc.) take place. The ‘recent’ grading may be computed by determining the difference in time between the date the query is run and the date that an interaction occurred. If the interactions took place more recently, the weighting is higher, for example.

Continuing with FIG. 22, at block 2211, the server computes a network graph of nodes and edges corresponding respectively to the users of the ‘users of interest’ list and their relationships, where the relationships or edges are weighted (e.g. also called the topic network). It can be appreciated that the principles of graph theory are applied here.

At block 2212, the server identifies communities (e.g. C₁, C₂, . . . , Cₙ) amongst the users in the topic network. The identification of the communities can depend on the degree of connectedness between nodes within one community as compared to nodes within another community. That is, a community is defined by entities or nodes having a higher degree of connectedness internally (e.g. with respect to other nodes in the same community) than with respect to entities external to the defined community. As will be defined, the value or threshold for the degree of connectedness used to separate one community from another can be pre-defined (e.g. as provided by the community graph database 128 and/or user-defined from computing device 101). The resolution thus defines the density of the interconnectedness of the nodes within a community. Each identified community graph is thus a subset of the network graph of nodes and edges (the topic network) for each community. In one aspect, the community graph further displays both a visual representation of the users in the community (e.g. as nodes) with the community graph and a textual listing of the users in the community (e.g. as provided to display screen 125 of FIG. 1). In yet a further aspect, the display of the listing of users in the community is ranked according to degree of influence within the community and/or within all communities for topic T (e.g. as provided to display screen 125 of FIG. 1). In accordance with block 2212, users U_{T} are then split up into their community graph classifications such as U_{C1}, U_{C2}, . . . U_{Cn}.

At block 2213, for each given community (e.g. C₁), the server determines popular characteristic values for pre-defined characteristics (e.g. one or more of: common words and phrases, topics of conversations, common locations, common pictures, common meta data) associated with users (e.g. U_{C1}) within the given community based on their social network data. The selected characteristic (e.g. topic or location) can be user-defined (e.g. via input from the computing device 101) and/or automatically generated (e.g. based on characteristics for other communities within the same topic network, or based on previously used characteristics for the same topic T). At block 2214, the server outputs the identified communities (e.g. C₁, C₂, . . . , Cₙ) and the popular characteristics associated with each given community. The identified communities can be output (e.g. via the server for display on the display screen 125) as a community graph in visual association with the characteristic values for a pre-defined characteristic for each community.

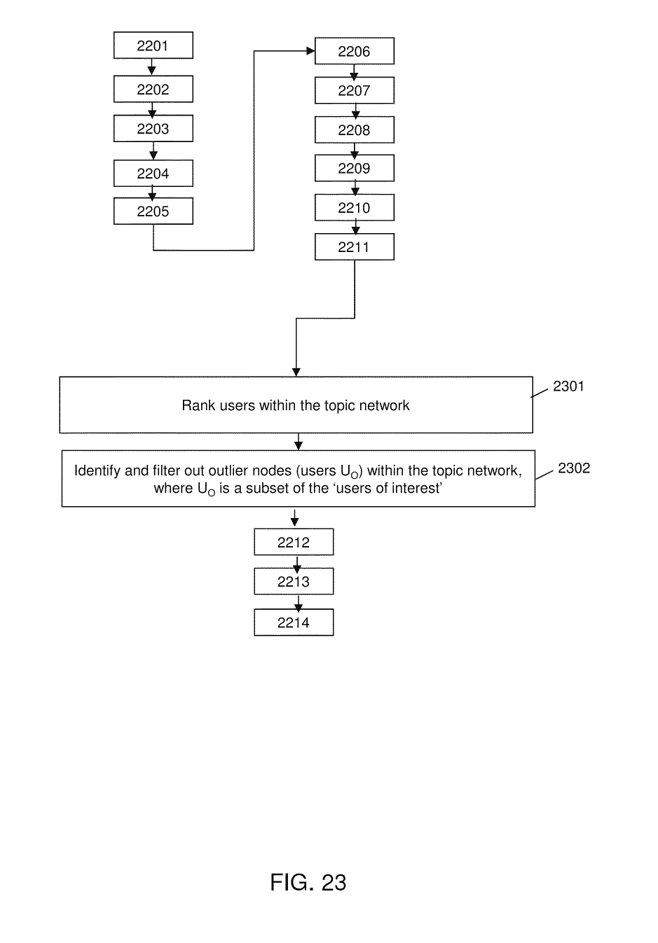

Turning to FIG. 23, another example embodiment of computer executable or processor implemented instructions are provided. Blocks 2201 to 2211 are performed. Following block 2211, at block 2301, the server then ranks users within the topic network. For example, the server uses PageRank to measure importance of a user within the topic network and to rank the user based on the measure. Other non-limiting examples of ranking algorithms that can be used include: Eigenvector Centrality, Weighted Degree, Betweenness, Hub and Authority metrics.

The server identifies and filters out outlier nodes within the topic network (block 2302). The outlier nodes are outlier users that are considered to be separate from a larger population or clusters of users in the topic network. The set of outlier users or nodes within the topic network is represented by U_{O}, where U_{O} is a subset of the ‘users of interest’. Further details about identifying and filtering the outlier nodes are described below.

The process continues with blocks 2212 to 2214, whereby the communities are formed after removing the outlier users U_{O}.

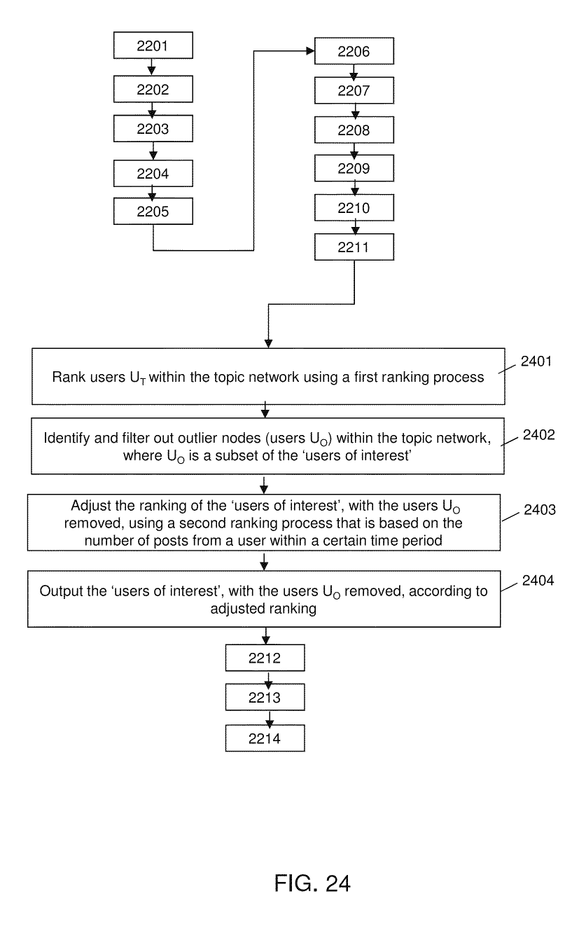

Turning to FIG. 24, another example embodiment of computer executable or processor implemented instructions are provided. Blocks 2201 to 2211 are performed. Following block 2211, the server ranks users within the topic network using a first ranking process (block 2401). The first ranking process may or may not be the same ranking process used in block 2301. The ranking is done to identify which users are the most influential in the given topic network for the given topic.

At block 2402, the server identifies and filters out outlier nodes (users U_{O}) within the topic network, where U_{O} is a subset of the ‘users of interest’. At block 2403, the server adjusts the ranking of the users, with the users U_{O} removed, using a second ranking process that is based on the number of posts from a user within a certain time period. For example, the server determines that if a first user has a higher number of posts within the last two months compared to the number of posts of a second user within the same time period, then the first user's original ranking (from block 2401) may be increased, while the second user's ranking remains the same or is decreased. In an example embodiment, the certain time period is part of a search query that is obtained or generated by the server.

It is recognized that a network graph based on all the users may be very large. For example, there may be hundreds of millions of users. Analysing the entire data set of users may be computationally expensive and time consuming. Therefore, using the above process to find a smaller set of users that relate to the topic T reduces the amount of data to be analysed. This decreases the processing time as well. In an example embodiment, near real time results of influencers have been produced when analysing the entire social network platform of Twitter. Using the smaller set of users and the associated data, a new topic network is computed. The topic network is smaller (i.e. less nodes and less edges) than the social network graph that is inclusive of all users. Ranking users based on the topic network is much faster than ranking users based on the social network graph inclusive of all users.

Furthermore, identifying and filtering outlier nodes in the topic network helps to further improve the quality of the results.

Following block 2404, blocks 2212 to 2214 are implemented.

Further details of the methods described in FIGS. 2 to 5 are described below.

In particular, in relation to obtaining social network data, the data may be obtained using the approaches described above with respect to FIGS. 5-7. After the data is obtained and stored, it can be analyzed, for example, to identify experts and interests.

In relation to determining posts related to a topic, example embodiments are described below. For example, a topic is used to identify popular documents within a certain time interval. In particular, when a topic (e.g. a keyword) is provided to the system, the system returns documents (e.g. posts, blogs, tweets, messages, articles, etc.) that are related and popular to the topic. Using the proposed systems and methods described herein, the executable instructions include the server 100 determining the author or authors of the popular documents. In this way, the author or authors are identified as the top users who are related to the given topic.

Identifying and filtering outlier users in the topic network may include approaches described in relation to FIGS. 13-15.

Identifying communities may include approaches described in relation to FIG. 16.

It will be appreciated that, in relation to a community identified using weighted analysis, popular characteristics of such a community may be subsequently identified. Further, the identified communities and the identified popular characteristics of such communities may be identified.

### Example Scenario

### Personal Care Products Brand

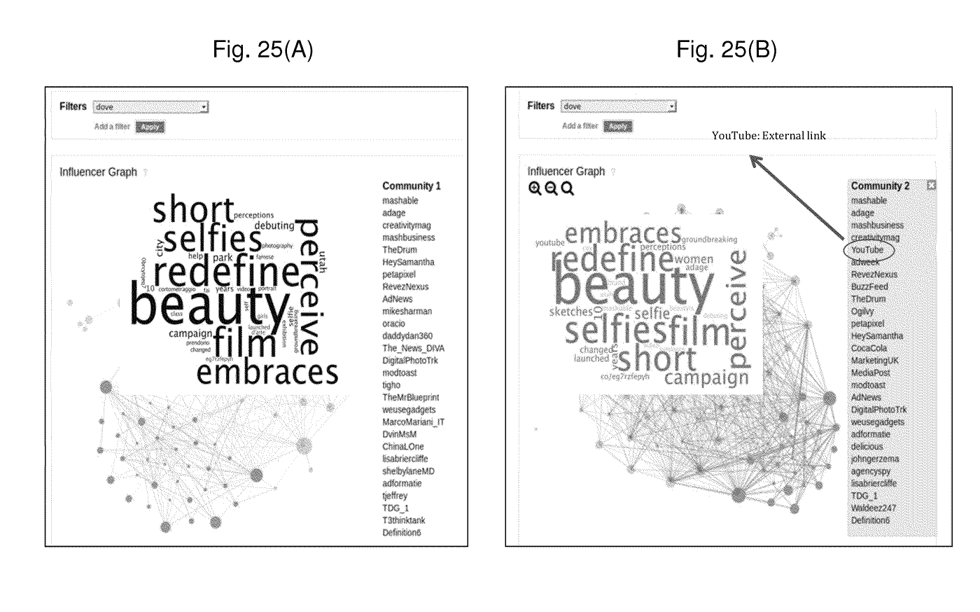

In an example embodiment, the name of a personal care product brand was inputted into the process shown in FIG. 22. The graphical output of the community network showing influencers, using weighted analysis, are shown in FIG. 25b. A personal care products company released a YouTube video as part of one of their campaigns. The campaign's success was that hundreds of people shared the YouTube video through Twitter. FIG. 25a shows a comparative analysis of the results obtained for an influencer graph that is not weighted, while FIG. 25b shows an influencer graph that uses weighted analysis. The weighted analysis is able to identify “YouTube” as an important influencer while the un-weighted analysis does not recognize YouTibe. For the personal care products company seeing YouTube as an influencer immediately shows that the video campaign was a hit.

### Example Scenario

### Pharmaceutical Company

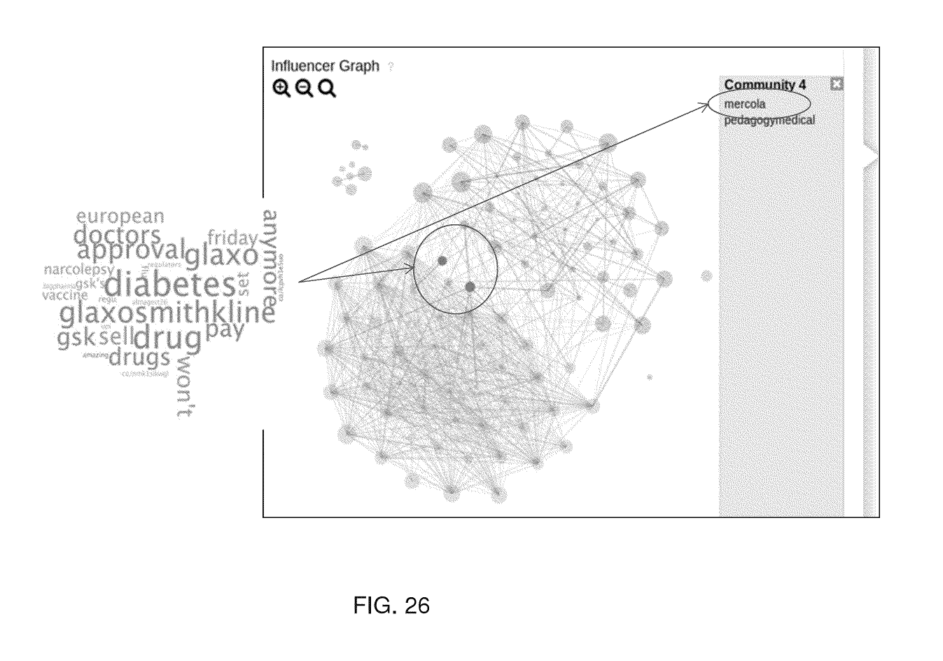

In an example embodiment, the name of a pharmaceutical company was inputted into the process shown in FIG. 22. The graphical output of the community network showing influencers, using weighted analysis, is shown in FIG. 26. For a pharmaceutical company when a critical public relations blunder occurs (e.g., incorrect information about one of their drugs is doing the rounds), the company needs to identify influencers who can help deal with the situation as soon as possible. For example, a pharmaceutical company had announced that the company would no longer pay doctors or other health care professionals to promote the company's products. An article about the company's decision appeared on multiple websites: a website by Dr. Mercola, a New York Times Best Selling Author, also featured in TIME magazine, LA Times, CNN, Fox News, ABC News, and the Today Show.

In FIG. 26, the weighted influencer process pulled out @mercola (the website's twitter handle) as one of the top influencers in the community that talks about this topic. Therefore, when the need arises the pharmaceutical company can consider the website or web platform of ‘mercola’ as an important influencer to spread any important information.

### Example Scenario

### Super Bowl

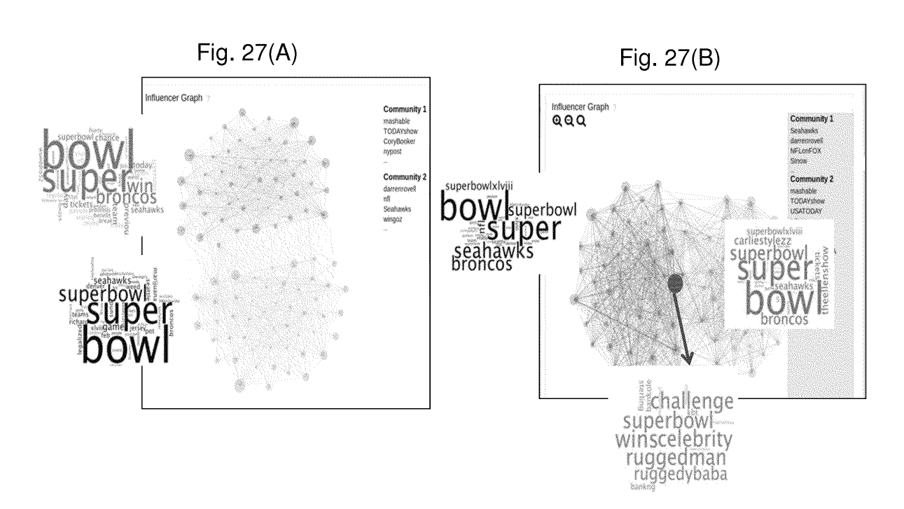

In an example embodiment, the topic “Super Bowl” was inputted into the process shown in FIG. 22. The graphical output of the community network showing influencers, using weighted analysis, is shown in FIG. 27b. By way of background, the Super Bowl is a popular sporting event in the United States. Many big brands and television channels want to take advantage of the Super Bowl by organizing a public relations event associated to it. For example, before the previous Super Bowl, “The Ellen show” or “The Ellen DeGeneres Show”, which is a talk show, gave out free tickets to the Super Bowl event for winners of some contest. The success of the contest can be seen when “@theellenshow.” the show's official twitter handle appears as a top influencer and there is an entire community talking about the public relations initiative. FIGS. 27a and 27b show a comparative analysis of the results obtained for the unweighted analysis (FIG. 27a) and the weighted analysis (FIG. 27b). Both the weighted and the unweighted versions identify communities that talk about winning free tickets for the super bowl, but the weighted analysis is able to identify the source or influencer “@theellenshow”, as shown in FIG. 27b.

The Super Bowl case study. (A) Depicts the old methodology, which pulls up influencers who are primarily talking about the Super Bowl, Broncos, or Seahawks or free tickets. (B) Depicts the results of the new methodology that in addition pulls out “theellenshow.”

Thus, there is presented a system and method for identifying influencers within their social communities (based on obtained social networking data) for a given query topic. It can also be seen that influencers do not have uniform characteristics, and there are in fact communities of influencers even within a given topic network. The systems and methods presented herein are utilized to output visualization on the computing device (e.g. computing device 101) visualized in a network graph to display the relative influencer of entities or individuals and their respective communities. Additionally popular characteristic values (e.g. based on pre-defined characteristic such as topics of conversation) are visually depicted on the display screen of the computing device for each community showing the top or relevant topics. The topics can be depicted as word clouds of each community's conversation to visually reveal the behavioural characteristics of the individual communities.

General example embodiments of the proposed computing system and method are provided below.

In an example embodiment there is a provided a method performed by a server for determining weighted influence of at least one user account for a topic. In another example embodiment, a server system or server is provided to determine weighted influence of at least one user account for a topic, the server system including a processor, memory and executable instructions stored on the memory. The method or the instructions, or both, comprising: the server obtaining the topic; determining posts related to the topic within one or more social data networks, the server having access to data from the one or more social data networks; characterizing each post as one or more of: a reply post to another posting, a mention post of another user account, and a re-posting of an original posting; generating a group of user accounts comprising any user account that authored the posting, being being mentioned in the mention post, that posted the original posting, that authored one or more posts that are related to the topic, or any combination thereof; representing each of the user accounts in the group as a node in a connected graph and establishing an edge between one or more pairs of nodes; for each edge between a given pair of nodes, determining a weighting that is a function of one or more of: whether a follower-followee relationship exists, a number of mention posts, a number of reply posts, and a number of re-posts involving the given pair of nodes; and computing a topic network graph using each of the nodes and the edges, each edge associated with a weighting.

In an example aspect, when there the follower-followee relationship exists between the given pair of nodes, initializing the weighting of the edge to a default value and further adjusting the weighting based on any one or more of the number of mention posts, the number of reply posts, and the number of re-posts involving the given pair of nodes.

In an example aspect, the method or the instructions, or both, further comprising: ranking the user accounts within the topic network graph to filter outlier nodes within the topic network graph; identifying at least two distinct communities amongst the user accounts within the filtered topic network graph, each community associated with a subset of the user accounts; identifying attributes associated with each community; and outputting each community associated with the corresponding attributes.

In an example aspect, the method or instructions or both, further comprising: ranking the user accounts within each community and providing, for each community, a ranked listing of the user accounts mapped to the corresponding community.

In an example aspect, ranking the user accounts further comprises: mapping each ranked user account to the respective community and outputting a ranked listing of the user accounts for the at least two communities.

In an example aspect, the attributes are associated with each user account's interaction with the social data networks.

In an example aspect, the attributes are displayed in association with a combined frequency of the attribute for the user accounts.

In an example aspect, the attributes are frequency of topics of conversation for the users within a particular community.

In another aspect of the systems and methods described herein, text sources can be analyzed and searched. It should be expressly understood that text sources, as used herein, includes any text content and specifically to streaming text collection with a temporal dimension. Such text sources include weblogs, blogs, newsgroup articles, email, forums, news sources, social networking sites or social media networks, collaborative wikis, micro blogging services, instant messaging services, SMS messages, and the like. Individually, each of such items may be referred to as a data object.

In particular, the systems and methods described herein include capabilities for searching for text sources including temporally-ordered data objects based on at least influence of an author

Many of the examples below are described with respect to blogs, but are equally applicable to text sources in general. It will also be appreciated that the term “blogosphere” is used to refer to all blogs and their interconnections, and more generally the networked community of blog accounts. Thus, a blogosphere and a social media data network share many similarities and the principles described herein are applicable to both data computing environments.

It is recognized that is desirable to have methods and systems for information discovery and text analysis of the Blogosphere, or other forms of social media and various temporally ordered information sources, that are not necessarily query driven, and that overcome the drawbacks and limitations of the prior art. For example, a user should be able to monitor posts and keywords of interest that merit further exploration should be automatically suggested.

Further, what is desired is a system and method that does more than solely monitor queries posed by users or blog post tags and rank them based on relative popularity. There is a wealth of related information one can extract from blogs in order to aid information discovery. For example, blog analysis can be a useful tool for marketers and public relations executives as well as others. They can be used, for example, to measure product penetration by comparing popularity of a product along with those of a competitor in the Blogosphere. Moreover, popularity can also be used to assess decisions, like marketing strategy changes, by monitoring fluctuations in popularity.

Additional functionalities, such as one-click zoomable interfaces, tooltips and intelligent alerts through the use of bursts can further enhance Blogosphere analysis. The list includes adding a spatial component to queries as well as correlations identifying temporal dynamics in the list of keywords correlated to a specific keyword, and mapping correlated keywords to topics. These functionalities and features have the potential to improve information discovery and text analysis of the Blogosphere or any other online temporally-ordered text sources.

In one aspect, a method is provided for searching one or more text sources including temporally-ordered data objects is provided. The method includes: providing access to one or more text sources, each text source including one or more temporally-ordered data objects; obtaining or generating a search query based on one or more terms and one or more time intervals; obtaining or generating time data associated with the data objects; identifying one or more data objects based on the search query; and generating one or more popularity curves based on the frequency of data objects corresponding to one or more of the search terms in the one or more time intervals. The data objects are ranked based on the influence ranking of the authors or users associated with the data objects.

In another aspect, a system is provided for searching a text source including temporally-ordered data objects. The system includes: a computer; a search term definition utility linked to the computer or loaded on the computer; wherein the computer is connected via an inter-connected network of computers to one or more text sources including temporally-ordered data objects; wherein the system, by means of cooperation of the search term definition utility and the computer, is operable to: provide access to one or more text sources, each text source including one or more temporally-ordered data objects; obtain or generate a search query based on one or more terms and one or more time intervals; obtain or generate time data associated with the data objects; identify one or more data objects based on the search query; and generate one or more popularity curves based on the frequency of data objects corresponding to one or more of the search terms in the one or more time intervals. The data objects are ranked based on the influence ranking of the authors or users associated with the data objects.

In yet another aspect, a computer program product is provided, characterized in that it comprises: computer instructions made available to a computer that are operable to define a search term definition utility, wherein the computer is linked to one or more text sources including temporally-ordered data objects, wherein the computer program product, by means of cooperation of the search term definition utility and the computer is characterized in that the search term definition utility is operable: to provide access to one or more text sources, each text source including one or more temporally-ordered data objects, obtain or generate one or more time intervals; obtain or generate a search query based on one or more terms and one or more time intervals; identify one or more data objects based on the search query; and generate one or more popularity curves based on the frequency of data objects corresponding to one or more of the search terms in the one or more time intervals. The data objects are ranked based on the influence ranking of the authors or users associated with the data objects.

A method and system are provided that allows a user to query blog posts through the use of a keyword and that returns information including additional keywords that have a time-relation to the original query and that ranks the information ranked according to the influence ranking of the authors or users associated with the information. In one aspect thereof, the system employs identifying user information to tailor the query search, and can be further limited by a specified temporal window or geographical location, or both a temporal window and geographical location.

Blogosphere query results are produced wherein the results produced are the result of an analysis of a popularity curve derived by way of temporally-ordered events that may be displayed as a ranked order of keywords indicating further sources of information on the topic of the query.

A method and system are provided for Blogosphere query activity, whereby query results can be limited by blog information, geographical location, a temporal window, or any combination of these elements, and results include time-specific keywords that can be utilized to further analyze a topic and to gather additional information related to the original query. It involves the application of software and hardware, some of which is already known. For example, the display of the query results may be achieved on a computer screen, a handheld device, or any other display means.

In particular, a method and system are provided for information discovery and text analysis of the Blogosphere or any other text sources with temporally-ordered data objects, such as messages, posts, replies, news, mailing lists, email, forums, newsgroups, and the like. Popularity curves and correlated keywords are provided via an online analytical processing-style web interface having navigational capabilities and undertaking intelligent analysis of bursts and correlations.

In one aspect, the system is operable to detect and identify bursts (meaning time-specific events of interest) by way of a popularity curve. The data in the popularity curve corresponds to the relative popularity of the query keyword in blog posts or other temporally-ordered text sources. These curves are advantageous for the process of information discovery, as the user can navigate to relevant information in an effortless manner by following the suggestions presented in the form of bursts.

For example, a user could observe a graph displaying the relative popularity of the query keywords “Philip Seymour Hoffman” in the Blogosphere as a function of time and automatically tag regions of time that the search string shows as experiencing unusual or unexpected popularity. These can be temporal regions that one may wish to focus upon and to utilize to refine a search. For this particular query, the keywords “Philip Seymour Hoffman” could display unexpected popularity over the last year in the Blogosphere when the actor was nominated for OSCAR™, when he received the OSCAR™ award and when a subsequent movie that he appeared in was released (MI3™).

From an information discovery perspective, details explaining the ‘unusual’ popularity of the keywords “Philip Seymour Hoffman” in the corresponding temporal intervals should be automatically provided. Keywords that are highly correlated with the search string in a temporal interval of choice are good candidates for explaining such ‘unusual’ popularity. For the case of the first temporal interval in which “Philip Seymour Hoffman” shows ‘unusual’ popularity, the query is closely correlated with the keywords “Capote” (the film he acted and was nominated for an OSCAR™) and “Oscar”. For the second temporal interval with the keywords, “Oscar”, “Actor”, “Capote” and “Crash” (another movie winning an OSCAR™), and for the third the correlated keywords were “Tom Cruise” and “MI3”. It is evident that such keywords provide information as to why the query might show relatively ‘unusual’ popularity in the corresponding time interval thereby indicating an event of interest.

It should be noticed that such correlations between keywords can be repeatedly discovered, possibly triggering additional information discovery. For example, one might choose to identify the keywords correlated with both “Philip Seymour Hoffman” and “Capote” in the first temporal window. Such functionality would enable a finer exploration of the posts in the temporal dimension. Essentially, it would enable a more focused drill down in the temporal dimension.

In another aspect, an alert means is provided for indicating when a potential event of interest occurs, as indicated by a burst in the popularity curve.

In yet another aspect, given a search query with a time interval and optionally a geographic region, the system may be operable to generate an automatic burst synopsis. Such a synopsis includes a set of keywords that explain information related to the query for the associated burst.

In another aspect, the system may provide bursts for authoritative ranking of the temporally ordered information source. Authoritative ranking of a data object or text source may depend on the ranking of the author or user, as determined according to their influence amongst other users for a given topic. Authoritative rank of a data object or text source may also depend on the context (meaning the query the burst is associated with) and the associated time interval (meaning the temporal window). An authoritative data object, like a message posting or blog, is a data object that reported the event (the event is described by the burst synopsis set and the data object contains all keywords in the synopsis set) and is most cited in the specified time interval. Message posts that contain the burst synopsis keywords are ranked by citations. Citation includes both links to this message post and also the number of quotations or references by other message posts to this message post in the specified time interval.

In another aspect, the system may be operable to efficiently identify correlated sets of keywords in association with the keywords of a query search. To provide a quick overview of a topic, an analysis tool displays a list of keywords closely related with the searched query in a selected time interval and geographic region. Such correlation between keywords can be defined based on either their co-occurrence information or based on the similarity between their popularity curves. Similarity between popularity curves can be quantified by any metric used to assess closeness of curves. Preferably, the correlated keywords are aware of temporal and spatial restrictions present in the search query. Thus, correlations are computed within a specified temporal or spatial scope. Such computation can be performed online, based on pre-computed information or achieved through other means.

The list of correlated keywords is used for navigation of the Blogosphere. Elements of such navigation include the use of correlated keywords to refine the search, drilling down or rolling-up on the search results with a specified temporal or geographical range. This list of correlated keywords can also serve as a navigational interface, allowing a user to refine the search or explore further.

In another aspect, the system may use actual text content for the purpose of analysis (e.g., for the purpose of computing correlated terms and popular keywords). The present invention provides for the identification of popular keywords (commonly known as hot keywords) from the content of the post, without requiring tags or search volume. It also can utilize text content in conjunction with tags, search volume or both elements together for the purpose of analysis.

In another aspect, the system may provide query capability for popular keywords using arbitrary time ranges. Specific algorithms are operable to conduct efficient query responses.

In yet another aspect, the system may provide a map for depicting different geographic regions and popularity of a user's query in the Blogosphere. Authors' profiles can also be used to gather location information from blogs, and this information can be applied to restrict a search to specific geographic regions.

Another aspect includes a method of analyzing the Blogosphere. The analysis method facilitated by the system is segmented into three steps: (i) identification of topics of interest to the user through the creation of a query utilizing keywords (what is interesting); (ii) identification of events of interest (when is it interesting); and (iii) identification of the reason an event is interesting (why is it interesting).

In one example embodiment, a list of “interesting” keywords is displayed on a webpage or other electronic medium. Based on this list, a user can formulate a query to seek for relevant blog posts.

In an example of the first step of analysis, the system employs a simple text query interface, to identify data objects, which may be blog posts, relevant to a query, in case a user is seeking specific information. Once one or more terms, or keywords, of interest are identified, a search query is formed and relevant blog posts are retrieved.

At the second step of the analysis, the popularity of the query terms or keywords in the data objects is plotted as a function of time. The system intelligently identifies and marks interesting temporal regions as bursts in the keyword popularity curve.

The final step of the analysis includes collecting one or more additional terms associated with the data objects of interest, known as correlated keywords (intuitively defined as keywords closely related to the keyword query at a temporal interval). Such keywords aim to provide explanations or insights as to why the keyword experiences a surge in its popularity and effectively aim to explain the reason for the popularity burst. Based on these keywords, one can refine a search and drill down in the temporal dimension to produce a more focused subset of data objects.

In one example embodiment the search results may be displayed on a webpage with snippets and links to full articles or blog posts.

In another example embodiment a user can choose between a standard and a stemmed index. The standard index conducts searches for exact keywords. For example, when searching with a standard index for the results of the query “consideration”, all articles containing the term “consideration” will be returned. However, when searching with the stemmed index, all English words are first converted to their roots, and hence a query search for the term “consideration” will return articles containing either of “consider”, “consideration”, “considerate” or “consideration”.

The method and system are best understood as a means for providing the specific functionality as particularized below. Example embodiments of the system and method may include different combinations of the example functionalities described below.

### Popularity Curve

One aspect of the system includes generating a popularity curve for a keyword or set of keywords. A popularity curve displays how often a query term is mentioned in the Blogosphere during a particular temporal window. The popularity curve and its fluctuation provide insight regarding the popularity of the keyword and augmentation or diminishment of this popularity over time.

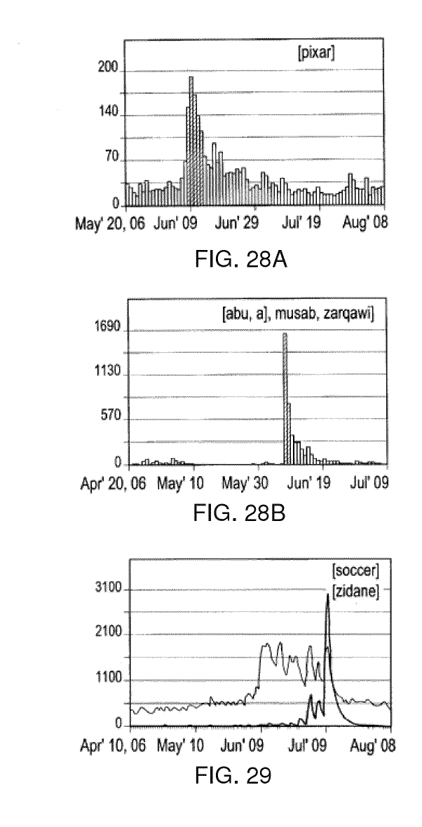

FIG. 28A and FIG. 28B provide examples of popularity curves for the queries “Pixar” and “Abu Musab al-Zarqawi”, respectively. Note that the movie “Cars” by Pixar was released on 9 Jun. 2006. Abu Musab al-Zarqawi, a member of Al-Qaeda in Iraq, was killed in a U.S. air strike on 7 Jun. 2006. Regions where an augmented popularity occurs are known as bursts.

Utilizing the popularity curve function of the present invention, one can compare the popularity of various keywords. Closely related keywords will generally have very similar popularity curves, at least for the temporal interval when the keywords are related. Hence, comparison of such curves provides an alternative approach to the analysis of the temporal relationship between keywords.

FIG. 29 displays the popularity of keywords “Zidane” and “soccer”. Notice that the keywords exhibit strong similarity in their popularity for a short temporal period. The relevant temporal window spans a few days before the world cup final match with a peak the day of the match. The peak, or burst is due to the incidents occurring during the final match related to the player Zinedine Zidane.

Popularity curves can be a useful tool for marketers and public relations executives as well as others. They can be used, for example, to measure product penetration by comparing popularity curves of a product along with those of a competitor in the Blogosphere. Popularity curves, when coupled with the semantic orientation of the associated blog posts, can provide tremendous insight for one product's popularity in relationship to another. Popularity curves can also be used to assess decisions, like marketing strategy changes, by monitoring fluctuations in popularity (e.g., as a result of a marketing campaign).

In one example embodiment, popularity curves may be further enhanced through the addition of a one-click zoomable interface for restricting the search to specific temporal intervals. Clicking on any region on the popularity curve image leads to another search with a restricted temporal range. For example, clicking on any bar in the FIG. 28A will initiate a query for any document containing “pixar” from the selected time range.

### Keyword Bursts

Another aspect of the system includes keyword bursts. Blogging activity is uncoordinated, in that it is produced through the work of unrelated individuals producing works relating to topics chosen at their individual discretion. However, whenever an event of interest to a contingent of Bloggers takes place (e.g., a natural phenomenon like an earthquake, a new product launch, etc.), multiple Bloggers write about it simultaneously. It is appreciated that a Blogger may also be referred to as a user that is the author of a message posting. Increased writing by multiple Bloggers results in an increase in the popularity of certain keywords. This fact allows the system to intelligently identify and mark an event of interest on a popularity curve based on the production of a large quantity of blog content related to a specific event. These events are referred to herein as bursts.

In an example embodiment, a burst is related to an increase in popularity of a keyword within a temporal window. Bursts play a central role in analysis and blog navigation of this invention, as they identify temporal ranges to focus upon and drill down into, for the purpose of refining a query search. FIG. 28A and FIG. 28B each show an example of a burst.

Bursts can be categorized as one of two main types: anticipated or surprising. Popularity for anticipated bursts increases steadily, reaches a maximum and then recedes in the same manner. For example, the release of a movie and the period of a soccer world cup tournament both fall under this category. Unlike anticipated bursts, popularity for surprising bursts increases unexpectedly. For example, Hurricane Katrina and the death of Abu Musab al-Zarqawi both fall under this category.

In another example embodiment, bursts can be used to produce intelligent alerts for users. Subscribing to specific keywords, the system may generate an alert (in the form of email) only when a burst occurs for specific keywords in a temporal window. This way an alert will be raised only when something potentially interesting as defined by specific keywords occurs rather than whenever a new page containing query terms is discovered.

### Keyword Correlations

Another aspect of the system includes keyword correlation. Information in the Blogosphere is dynamic in nature. As topics evolve, keywords align and links are formed between them, often this occurs to form stories. Consequently as topics recede, keyword clusters dissolve as the links between them break down. This formation and dissolution of clusters of keywords is captured by the present invention in the form of correlations.

In an example embodiment, the query search may be a list of terms or keywords found in blog posts most closely associated to the search query terms. These terms associated with the data objects of interest represent keyword correlations and are representative tokens of the chatter in the Blogosphere. Keyword correlations can be used to obtain insight regarding blog posts relevant to a query. Moreover, provided that users navigate by drilling down to posts related to a burst, such correlations can be used to reason why a burst occurred.

Keyword correlations are not static. They may change in accordance with the temporal interval specified in the query. This effect is especially relevant in an embodiment of the invention wherein a user can specify a temporal range for which a list of keywords correlated to query keywords is to be produced.

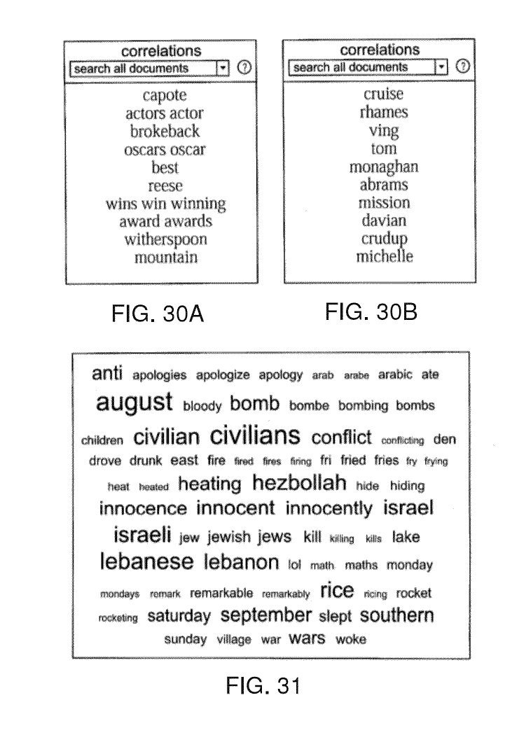

FIG. 30A and FIG. 30B show screenshots of keyword correlations for “Philip Seymour Hoffman” for two different time periods: 1 Mar. 2006 to 20 Mar. 2006 and 1 May 2006 to 20 May 2006, respectively. Hoffman won the OSCAR™ award for best actor for the movie Capote on 5 Mar. 2006. MI3 starring Hoffman was released on May 5th. As it can be seen, correlations are different for different temporal intervals, and they reflect the events that occurred during a particular interval. Choosing one of these keywords, for example “Capote”, causes a list of keywords correlated to “Philip Seymour Hoffman” and “Capote” in the temporal range specified to be produced, along with the associated popularity curve for the pair of keywords.

In another example embodiment, keyword correlations are employed to provide an exploratory navigation system. A user can easily jump from a keyword to related keywords and explore these by following correlation links. This path leads to a greater wealth of information relating to a query to be gathered.

### Hot Keywords

Yet another aspect of the system includes a list of “hot keywords” which are one or more terms generated from a prior search query, such as one that was automatically generated within a specific time interval, such as 24 hours. Keywords are measured to ascertain a level of “interestingness” as evidenced by the rate of use of keywords within a time interval, or temporal window. Those keywords that meet or exceed the set measurement are deemed hot keywords and are ranked.

In one example embodiment, the highest ranking keywords according to this measure, are displayed on a webpage having a font-size proportional to the measure of interestingness. Thus, the most interesting (meaning the most frequently used) keyword will be displayed in the largest font-size, whereas the least interesting keyword (meaning the least frequently used) will be displayed in the smallest font-size, and all other keywords will be displayed in font-sizes that correspond to the position of the particular keyword between the largest and the smallest font-size keywords, so that the font-size of the keywords reduces in size from the largest and to the smallest font-size and in a manner that is relative to the font-size used in the keywords prior to and after each keyword. Of course the order of the font-sizes may also be inverse of the order here described.

FIG. 31 shows an example screenshot of a ranking of keywords deemed “hot keywords” on 30 Jul. 2006.

The list of hot keywords is intended to offer guidance to the analysis process. The system provides a rich interface whereby a user can specify a temporal range (e.g., 1 Mar. 2006 to 31 Mar. 2006) and set a threshold of “interestingness” (meaning a minimum level of frequency of use of said keyword in blog posts) to generate a list of hot keywords for that temporal range. The result allows for analysis of past data.

In one example embodiment hot keywords are displayed in a cloud tag.

### Spatio-Temporal Search

Another aspect of the system employs a keyword search that incorporates spatio and temporal elements into the function of the analysis engine.

It should be understood that generally speaking there are important properties of the Blogosphere that cannot be easily captured by the ranking model of a traditional web search. For example, documents on the web do not have a time-stamp associated with them, while blog posts have information regarding the time of creation linked thereto. Known methods of web-based query searches do not adequately capture the time data of a blog. For example, simple relevance-based ranking using tƒ·idƒ ignores the temporal dimension, and pure temporal recency-based ranking is also flawed. As a first attempt to address the ranking of search results in the Blogosphere, the system employs a combination of both relevance based and temporal recency-based methods to rank search results.

In yet another example embodiment, demographic information consisting of age, gender, geographic location, industry, etc. relevant to the author of each post can be associated to a query. This information is utilized to stream-line the results of a search query.

In another example embodiment, the amount of influence exerted by the author on other users (e.g. followers or readers) for a given topic is computed. Identification of one or more influential authors is used to stream-line the results of a search query. An influential author is called an influencer.

In still another example embodiment, a user has the option to request that the blog post results displayed be limited to a specific temporal interval, or a selected demographic group, a geographical location, or any of these options.

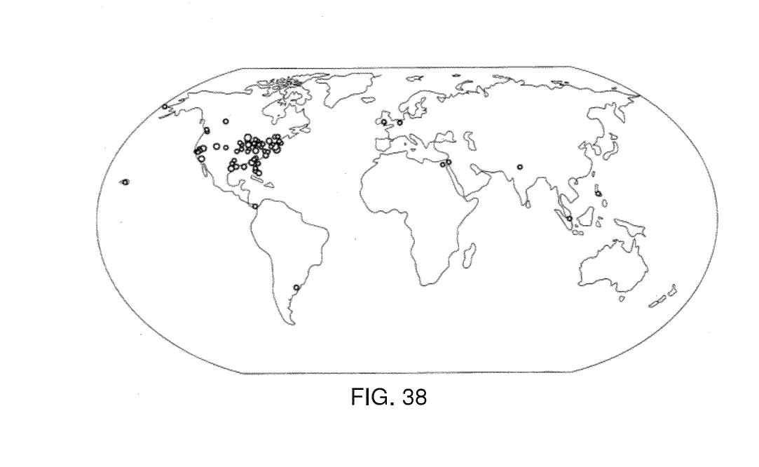

FIG. 38 displays a screenshot for a geographical search. Users can restrict viewing by selecting countries or cities on the map by a simple click on any dot on the map and drill down to the blog of a geographical region.

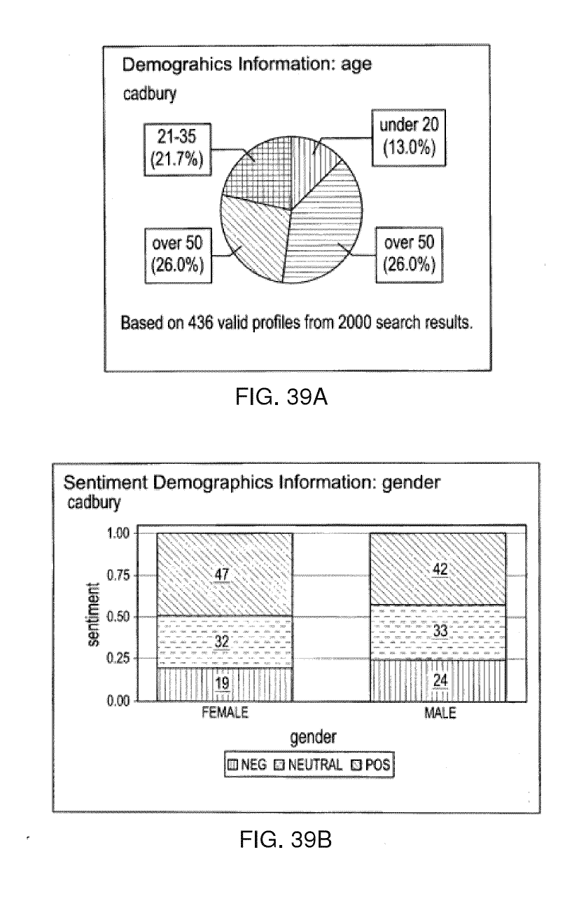

FIG. 39A displays age distribution of individuals producing content relating to Cadbury.

FIG. 39B displays another demographic curve, one generated from sentiment analysis. One region in the graph represents negative sentiment; another region represents positive sentiment; and the final region represents neutral. Sentiment classification is performed using a pre-trained classifier.

In one example embodiment, segments of the screen display may be clickable, in a one-click manner, to allow for drill down analysis. FIGS. 39A and 39B incorporate regions in a pie-chart that are clickable.

In another example embodiment, other types of data associated with blog posts may be collected to limit the query search. For example, if instead of blog posts, the system warehouses financial information or news, such textual information will be associated with a source (e.g., REUTERS™, THOMPSON FINANCIAL™, BLOOMBERG™, etc). This information is recorded by the system and results can be suitably restricted to a source, industry category, as well as other metadata associated with a site, or a collection of these types of metadata.

### Authoritative Blog Ranking

Other aspects of the system include burst synopsis sets and a ranking in accordance with the authoritative nature of the data object as indicated by the data associated with the data object.

In one example embodiment the burst synopsis set for an initial query may be indicated by (q). Thus, q represents the maximal set of keywords that exhibit burst behaviour in the associated popularity curve. Synopsis sets may have an arbitrary size (meaning inclusion of an unbounded number of keywords) provided that all included keywords contribute to the burst.

Consider the query “italy”; blog posts may mention the keyword “italy” in connection to both soccer and political events. All such data objects, or blog posts, contribute to the popularity of the keyword “italy”. The keywords “soccer” and “politics” are both correlated to keyword “italy” in the associated temporal interval. However, expanding the search and observing the popularity curves of “italy, soccer” and “italy, politics” shows that only the curve for “italy, soccer” has a burst in the temporal interval of the three summer months of 2006. The system can automatically generate synopsis keyword sets for a burst. In this case, only the set “italy, soccer” will be identified and suggested by the system as a synopsis set, associated with the initial keyword query “italy”. Notice that the set “italy, politics” will not be identified as a synopsis set, because “italy, politics” does not have a burst during June 2006 in the corresponding popularity curve.

Based on synopsis keyword sets, the system may automatically rank blog posts related to the synopsis set based on authority or influence.

In an example embodiment, the authority or influence relates to the degree of influence of the author of a given blog or message, or the author of a given blog or message account. As described above, a user or author for a given topic is ranked based on their influence amongst other users in a social data network or in the Blogosphere. The ranking of the author is used to accordingly determine the ranking of a blog posts. Therefore, the higher the influence ranking of an author, the higher the ranking of the blog post will be from the same author. In this way, query results that are considered popular based on the fluctuations of a popularity curve are also ranked.

In another example embodiment, authoritative blogs may be utilized to rank query results. Authoritative blogs are blogs that are read by a large number of readers, and are usually first to report on certain news. These blogs play an important role in the dissemination of opinions in Blogosphere. Moreover, authoritative blogs are the ones that gave rise to the burst on the synopsis keyword set. These are blogs that are relevant to the synopsis set, temporally close to the occurrence of the burst and most linked in the Blogosphere.

As an additional example, a search using query “cars” on 9 Jun. 2006 results in the synopsis set {cars, pixar, disney, movie} which disambiguate the burst resulted from the release of the movie Cars, from general discussion about automobiles in the Blogosphere. Such set is accompanied with authoritative blog posts that were the first to report the event and were most linked in the Blogosphere. Additional information can be incorporated in addition to link information from the Blogosphere. Such information includes data regarding the activity of the Blogger (such as frequency and size of the contributed content), activity in the comments section for the blog, information obtained by analyzing the language of the contributed information, such as that obtained from readability tests. This aspect is derived from the work of Jenkins and Paterson (see Farr J. N., Jenkins J. J., Paterson. D. G. (1951), Simplification of Flesch Reading Ease Formula, Journal of Applied Psychology).

### Query by Document

Another aspect of the system is a query paradigm Query by Document (“QBD”). Commonly one is interested in identifying reactions in the Blogosphere resulting from news sources or other media reports on events. The QBD system and method allows for the generation of a query upon the basis of the content of a chosen source document.

In an example embodiment, any text document may be utilized as the source document for input, such as a news article, an email message, or any text source of interest to the user. The system automatically processes the document, and constructs a search query tailored to the contents of the input document. This query is subsequently submitted to the system, or any other search engine of interest, for the purpose of identifying documents relevant to the query document.

In one example embodiment, the user may be provided with the ability to specify the degree of relatedness desired between the query document and the results. The degree can range from highly specific relatedness (meaning only documents referring specifically to the content referenced in the query document are to be included in the search results) to very general relatedness (meaning documents referring to concepts mentioned in the query document will be included in the search results).

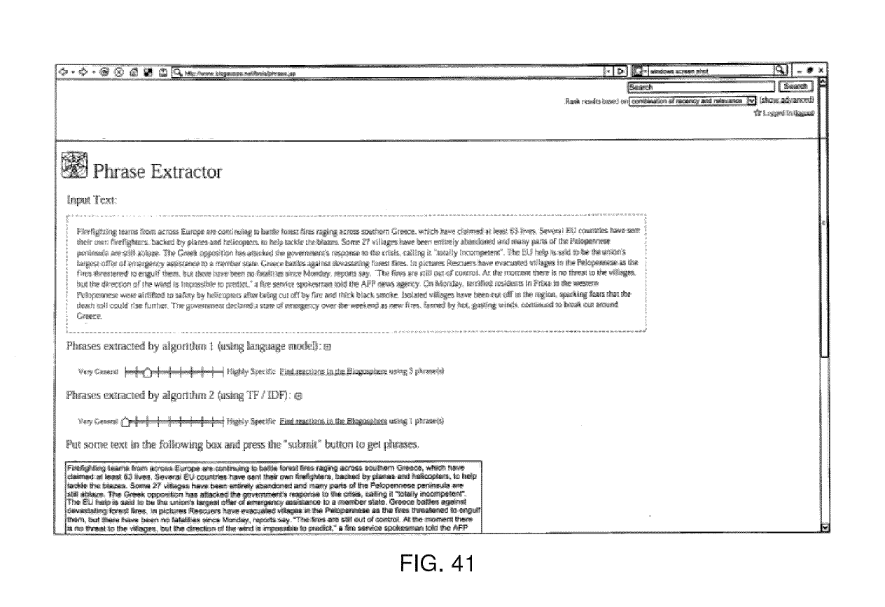

FIG. 41 shows a screenshot of the QBD interface. The figure depicts that the user can submit a text document which results in the construction of a search query. The input text is an article from New York Times relating to the fires occurring in southern Greece in 2007. A slider is presented to control the nature of the constructed query and set relatedness at a level between highly specific and very general. Clicking on “Show reactions in the Blogosphere” will retrieve articles related to the event (namely the fires in Greece) from the data.

In one example embodiment, a one click paradigm is utilized to initiate and perform a QBD.

### BuzzGraphs

Another aspect of the system includes automated tools to identify and characterize the important information and significant keywords that are the results of a query. This feature handles the large amounts of information generated in the Blogosphere and displays it in an easily understandable format.

In one example embodiment graphs, called BuzzGraphs, may be produced to visually depict the query results. BuzzGraphs aid a user in understanding the most important events of interest. Moreover, BuzzGraphs express the nature of underlying discussions occurring in the social media space related to the query. Two types of BuzzGraphs are supported, namely query-specific and general BuzzGraphs.

Query-specific BuzzGraphs may be used to characterize the nature of social media space discussions and identify information related to a particular query. When a user submits a query the system automatically identifies all relevant results and analyzes them, identifying all statistically significant associations (meaning correlations). Correlated keyword pairs can be displayed in a BuzzGraph. A connection (also known as an edge) between two keywords in the BuzzGraph signifies an important correlation between these keywords. Since the number of such correlated keywords pairs can be large, the system utilizes information about the importance of such keywords (expressed via popularity ranking measures) and ranks correlated pairs by aggregate importance. Only a user-specified number of important associations are displayed in the BuzzGraph. This graph can be furthered studied to reveal important associations between keywords in the context of the query issued by a user. The system provides its users with the ability to selectively choose keywords from this graph, to engage in further queries, and to drill down to specific events.

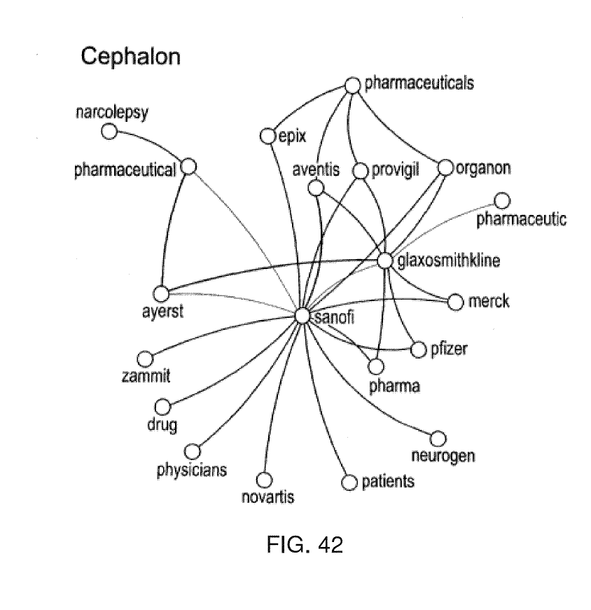

FIG. 42 presents an example of the BuzzGraph for the query “cephalon” generated by the system. This figure summarizes the buzz around the query by displaying both related keywords and the association of each keyword to the query terms.

In another example embodiment the BuzzGraph can be enhanced by the use of sentiment analysis and the inclusion of sentiment information. Initially each search result is classified as being of positive or negative sentiment and subsequently two different BuzzGraphs are constructed. This functionality is useful to gain insight regarding positive and negative keywords relating the search query. The positive and negative keyword results can then be compared and analyzed to produce additional information relating to the query.

Another type of BuzzGraph produced by the system aims to reveal important chatter and discussion during a specific temporal interval for a specific demographic group. In this embodiment, no keyword query is provided. The user in this case submits information about a target demographic group (e.g., “males aged 18-30 from New York City blogging about Politics”). All information collected from the specific temporal interval belonging to the specific demographic interest group is processed. The most significant keyword associations are identified and the results are visually displayed as a graph. This graph shows information which is deemed interesting occurring during the specific temporal interval for the specified demographic interest group in the form of keyword clusters. A user can inspect this graph, selectivity focus on keyword clusters of interest and use these keywords to construct search queries for further exploration.

### Interface

Another aspect of the system includes a simple, intuitive interface. Popularity curves provide On Line Analytical Processing (“OLAP”) style drill down and roll-up functionality in the temporal dimension. Outlinks on keyword correlations constitute a network of guided pathways to assist the user in a journey of Blogosphere exploration.

In one example embodiment OLAP analysis using the system can be summarized as a four step process:
1. Keywords are selected by a user for analysis. The system supports ad hoc keyword queries and it can also suggest keywords through the use of the hot keyword facility. Furthermore, interfaces may be applied that restrict search results according to several attributes, such as age, location, profession and gender. Profile information regarding Bloggers or authors is automatically collected and is presented to the search interface. The topic community associated with an influential Blogger or influential author may also be computed and presented, using the influencer processes described above.
2. The search results can be observed in a visual display as snippets shown on-screen in a webpage. The search results are ranked according to the influence of the associated author or Blogger. Alternative or additional ranking factors may be used, such as the associated popularity curve of the keyword searched and its correlated keywords. Demographic curves may be utilized to gain insight regarding demographic groups of interest. Moreover a spatial region may be selected to restrict the search to a specific geographic location.
3. The popularity curve data may be expanded or collapsed by selecting regions of the curve. Selection may be achieved through use of a mouse, or alternatively through a touch-screen application, or any other means of user interaction. Through this means a user may select a time interval to be analyzed based on identified bursts. A synopsis keyword set can be generated as well and blog posts may be ranked using ranking of the authors or Bloggers.
4. Correlated keywords and the BuzzGraph may be generated and utilized to derive additional information from a burst. Outlinks on keyword correlations can also be used to refine the query or explore its aspects further through drilling down.

In one example embodiment the system utilizes well-known machine learning algorithms and natural language processing techniques to undertake a sentiment analysis and automatically assign sentiment data to each data object, either positive or negative, by defining or obtaining positive or negative terms, or keywords, relating to the data objects, inferring the sentiment data from the presence or absence of such positive or negative terms, and based on such sentiment data defining additional information for a search query. As a result it automatically generates charts, such as BuzzGraphs, displaying the sentiment in the Blogosphere for all results of a query in the specified time period. Such graphs are interactive and can be selected to identify all posts with the particular sentiment for each demographic group of interest.

Graphs, as displayed in FIG. 28, FIG. 38 and FIG. 39, are clickable to allow drill-down to refine a search.

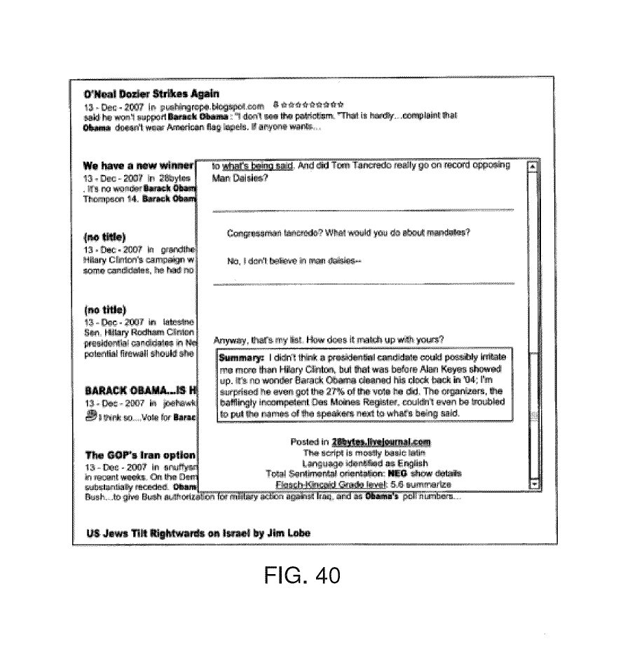

As shown in FIG. 40, in another example embodiment a complete content of search results prepared by the search engine, can be visualized conveniently in the form of asynchronously loading tooltips without having to navigate away from the search page. This functionality is implemented by creating a floating DIV element on the search page to display the contents. This functionality is known and is available as part of Javascript widget toolkits for Ajax development.

The tooltips may be multimedia enabled, allowing users to view images and videos inside the tooltip. The summary of the text document, readability index, and sentiment information are also displayed in the same tooltip for reference purposes. The use of tooltips to display the cached content of search results annotated with sentiment and readability information is advantageous.

Each of the afore-referenced functionalities are supported by the system architecture of the system. It is the combination of the method and system that enables it, for example, to track millions of blogs, comprise hundreds of millions of articles in its database, and fetch over 500 thousand posts in a twenty-four hour temporal window. Given the scope of the system architecture, the techniques employed must be computationally efficient. Accordingly, fast and effective algorithms and simplicity are the main focus of the system architecture design.

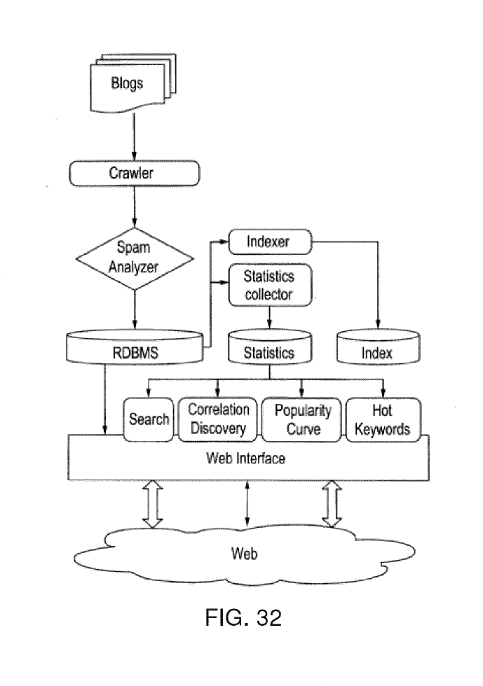

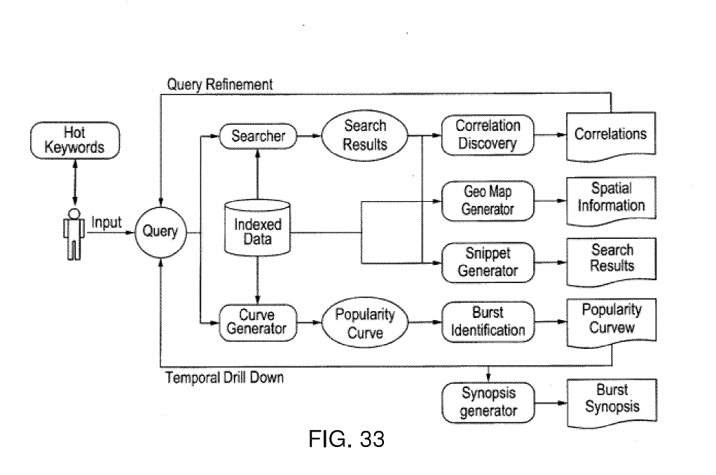

FIG. 32 represents an example embodiment of the overall system architecture which comprises: a data object source, namely a blog source; a search term definition utility, such as a crawler; a spam analyser; a database, such as a relational database having data which can be indexed and converted to statistics through the application of statistics and index software applications; a web interface that facilitates the search, correlated keyword discovery, popularity curve generation, hot keyword identification, and displays the search results to a user. The system of FIG. 32, in an example embodiment, is part of the server 100 shown in FIG. 2. In another example embodiment, the system of FIG. 32 is in communication with the server 100. FIG. 33 describes an embodiment of query execution flow and user navigation.

In one example embodiment the inverted index may consist of lists of data objects, such as blog posts, containing each search term, or keyword, Relational Database (“RDBMS”) stores complete text and associated data for all data objects, and IDF stats include idf values for all search terms.

Elements of the additional system architecture employed in example embodiments are described in detail individually.

### Crawler

One aspect of the system is that it acknowledges that the search term definition utility, may be a crawler, and that searching the Blogosphere via a crawler is different from the method employed in web crawling. A data feed, such as a RSS feed, is available for most blogs, and the crawler can fetch and parse the data feed, such as RSS XML, instead of HTML. There is no need to follow outlinks because services like blogs and weblogs maintain a list of recently updated blogs.

In one example embodiment the system applies a crawler that receives from weblogs a list of blogs updated during a specific time period, such as the previous 60 minutes. This list is compared to the list of spam blogs in the database, and additional fetches are scheduled for those blogs not included in the spam blog database.

One example embodiment of the system may fetch RSS XML blogs or message feeds from social media data networks but other hosting service resources may also be utilized.

Once a scheduled data feed, such as a RSS feed, is fetched, the data feed collected during the specified time period, such as the previous 12 hours, may be stored in the database. As a result all newly collected articles will be stored in the database. The addition of delay to the fetch process may be applied, as it is a known method applied by many machine created spam blogs. The delay works to reduce network access as the fetch only occurs once even when more than one article is posted on a blog in the specified period of time, such as 12 hours.

### Spam Removal

Another aspect of the system is a means of removing spam. Spam is a very big problem in the Blogosphere, or more generally social data networks. For example, approximately half the blogs accessible via Blogspot.com data are spam. These blogs exist to boost the page ranking of some commercial websites. Software is available that has the capability to create thousands of spam blogs within 60 minutes of time.

The sophistication of spamming techniques is increasing in intricacy and consequently the task of spam detection is simultaneously becoming more difficult. Language modeling techniques are used to generate sentences that are not just random strings but sensical. Some techniques applied by spammers are sufficiently sophisticated that they at least initially can confuse a human observer.

In one example embodiment the spam analyzer can build upon known techniques, utilizing a Bayesian classifier (see: M. Sahami, S. Dumais, D. Heckerman, and E. Horvitz. A Bayesian approach to filtering junk e-mail, in AAAI-98 Workshop on Learning for Text Categorization, pages 55-62, 1998) in conjunction with many simple, effective heuristics.

For example, spam pages contain a large number of specific characters (e.g., “-” and numerals) and contain certain keywords like “free”, “online” and “poker” both in their URLs as well as in the URLs of outgoing links. Capitalization of the first word of a sentence is often incorrect or inconsistent in spam pages. Images are almost never present on spam blogs.

The spam analyser, utilizes these known techniques of spam identification to differentiate spam from blogs. Spam is then ignored by the system architecture and is not included in the blog analysis.

### Searching and Indexing

Another aspect of the system is that the search term definition utility, which may be a crawler, stores all of the data it collects in a relational database. This data can be indexed to generate inverted lists and other statistics. Two types of indices may be maintained on all posts: namely standard and stemmed. Standard index maintains inverted lists for all tokens in the database. The stemmed index first converts all words to their roots, and maintains lists for all stemmed tokens. These indices form the core of the analysis engine.

In one example embodiment a list of posts for a period, such as 24 hours, may be maintained.

In yet another example embodiment, a separate data structure may be utilized to maintain term frequencies for a period of time, such as a twenty-four hour period, and inverse document frequency over a period of time, such as a 365 day temporal window, for all stemmed tokens.

As has been mentioned previously, all text data objects indexed by the system may be annotated with metadata information such as time of creation, location of the author, age of the author, and gender of the author. In one example embodiment, the indexing scheme may capture the metadata associated with the document, and this information may be optimized for rich queries containing both keyword and metadata based constraints.

In one example embodiment the system may apply the following method to undertake metadata analysis. Let d denote a document in the corpus C. Let ƒ in F be a metadata feature (e.g., latitude, longitude, time of creation, etc.). Denote the domain of feature ƒ by Dƒ (the terms “feature” and “metadata attribute” are used interchangeably for the purpose of describing this invention). The domain of features is bounded and quantized (e.g., age comes from the domain {1, 2, . . . , 100}). For time attribute a fixed granularity, say a day or an hour, is applicable and each document is associated with an integer to represent the time information. For domains like latitude and longitude, a granularity restriction may be imposed, such as one place after decimal, to get the quantized domain {0.0, 0.1, 0.2, . . . , 359.9, 360.0}. The domain Dƒ may or may not have a natural ordering. Features like time and age have a well defined ordering, while categorical attributes, such as language of the document or sentiment orientation, do not.

The query q contains a small set of tokens and restriction on all or some of the metadata features. The restriction of a feature ƒ can be expressed as a point query (e.g., value(rating)=7.0). If the domain off has a well defined ordering, then the restriction can contain a range (e.g., value(latitude) in [18.0, 21.0] AND value(longitude) in [143.1, 145.9]).

In traditional system architectures, a posting list for each keyword token t is maintained. For each feature ƒ, |Dƒ| posting lists are maintained (see: Mining the Web: Discovering Knowledge from Hypertext Data by Soumen Chakrabarti, Morgan Kaufmann, 2003). When a query shows up, relevant lists are retrieved and intersected to compute the answer. For example, search for all blog posts containing “global warming” posted in the first week of April 2007 from Toronto will require retrieval of 11 lists; 2 for the two tokens, and 7 lists one for each day (assuming a granularity of 1 day), and 2 lists corresponding to latitude and longitude of Toronto. Query result will be intersection of the two token lists with the latitude list, longitude list, and with union of the 7 lists corresponding to time.

It is easy to see that this approach is wasteful as it requires retrieval of long postings lists from disk. Assuming large amount of activity from Toronto, lists corresponding to latitude and longitude will be long (even though not all articles from Toronto talk about “global warming”). In a high-activity domain like the Blogosphere, the list for each of the days will also be very long (again, not all articles are from Toronto or talk about “global warming”).

In one example embodiment, even though the final query result set is small in size, long posting lists may be retrieved from disk; this provides an opportunity; as if the indices are designed intelligently, a lot of I/O can be saved resulting in considerable performance improvements.

In one example embodiment the system may apply the following method to index time. Assume that each document has a unique document identification (“ID”). The document ID is incremented every time a new document is indexed. For indexing time information along with the documents the time never decreases. If the time of crawl is associated with each document, the time increases monotonically with document IDs. This implies that for each time temporal window (e.g., a 24 hour period), a range of document IDs can be maintained. For the query “global warming for the first week of April 2007”, when intersecting the posting lists for tokens global and warming, only part of the lists is retrieved containing document IDs from the 7 days period specified in the query. Retrieval of part of postings list is possible since a range of document IDs is maintained for each time step (i.e., each day) and posting lists are sorted on document IDs. By maintaining a range of document IDs for each day, the retrieved size of postings list for tokens global and warming for the above query will be much smaller, hence resulting in significant performance gains.

In one example embodiment, due to crawling delays (and other practical issues), sometimes documents from previous dates may also be crawled. This means that the time-of-creation of a post may not be a strict monotonic function of document IDs. But the approach for indexing the time attribute as previously referenced can still be utilized because documents may be indexed in batch mode every night (and not as they arrive). During the batch indexing process, documents are first sorted based on their time data and then indexed. This way, for each time interval (e.g. a 24 hour period), a set of ranges of document IDs can be easily associated. When a query shows up, only documents belonging to one of these ranges need to be considered.

Therefore, by maintaining a list of ranges on document IDs with each time interval the time attribute present in the document may be queried in an efficient manner.

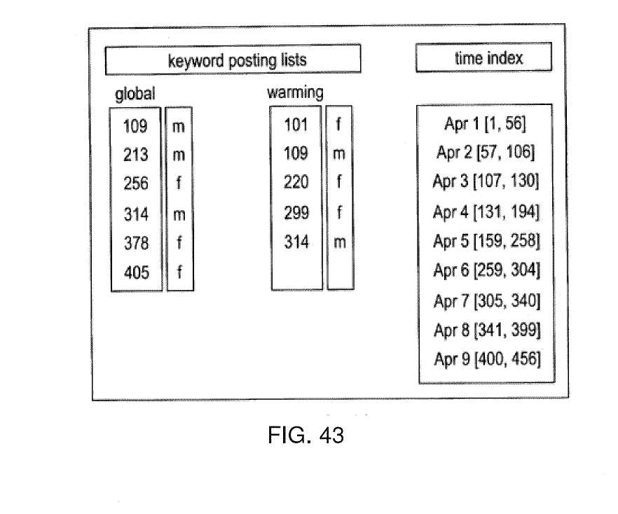

In one example embodiment the system may apply the following method to maintain aligned bitmap posting lists. Consider the query for “global warming by male authors”. If, along with each posting list for token, another aligned list is maintained containing the gender information; the query can be answered efficiently. Maintaining the gender information for a token's posting list of size n will require maintenance of another list with n entries with each entry being one of male or female. If the domain of the metadata attribute (gender in this example) is small, the additional list can be encoded as a bitmap (1 bit per entry for gender) for efficient storage. For the example query “global warming by male authors”, the posting list for tokens “global” and “warming” are first retrieved. Next the two aligned lists for gender information for each of the two token posting lists are retrieved. The postings list for “global” and its associated list for gender information in “parallel” are read and a new temporary postings list is created for “global AND male”. Next the same steps are undertaken to create a new temporary list for “warming AND male”. Finally an intersection of the two temporary posting lists is taken to achieve for the final result, shown in FIG. 43. Observe that the process described below does not require any random I/O operations and all I/O is sequential which is both fast and efficient.

Aligned posting lists are beneficial when the domain size of the metadata attribute in consideration is small as use of bitmaps is feasible in that case. With each posting list, an additional list with equal number of entries is maintained which records the value of the metadata attribute. At the query time, the posting list for token is read in parallel with the associated metadata information list and a temporary posting list is constructed. All temporary posting lists are intersected for computing the final answer.

In one example embodiment the system may apply the following method to partition token posting lists. Consider the query “zidane AND latitude=88.1”. The first problem faced is that the postings list for “zidane” will be very long and will contain posts not belonging to “latitude=88.1”. To circumvent this problem, the feature domain (latitude in this example) is divided into say 18 parts ([0-20], [20.1-40], . . . , [340.1, 360]). Instead of maintaining only one posting list for the token “zidane” instead 18 disjoint lists are maintained, one for each of the latitude partition. Observe that:
Now it is necessary to read only 1 of the 18 lists for “zidane” when the query “zidane AND latitude=88.1” arrives, reducing the disk 110 significantly.
If the query does not have a restriction on the latitude field, the query for “zidane” needs to read all 18 lists. This will not incur any significant additional cost since the union of these 18 lists is the same as the original list for “zidane”.
There are multiple partitioning options available for dividing the feature domain. One may choose to use a simple equi-sized partitioning or a more sophisticated clustering algorithm. Since the number of partitions is a variable, a hierarchical clustering on the feature domain can be used to divide posting lists. A longer posting list needs to be divided in larger number of parts and a smaller list in fewer partitions. Depending on the length of the posting list, the appropriate level of partitioning in the hierarchy can be used.

In traditional blog search system architectures, for each feature ƒ a hierarchical clustering on its domain Dƒ is performed and the result is stored as hƒ. For each token t, based on the size of the posting list for t, a level in hƒ is selected and the posting list for t is partitioned accordingly. If the posting list is small, level zero in hƒ is selected, which means that the posting list for t is not partitioned at all. When the query arrives, the appropriate posting list is fetched based on the metadata restrictions for each token in the query, and posting lists for each of the metadata restrictions is fetched, at which point all of these are intersected.

In one example embodiment the system may apply the following method to partition keyword posting lists. Consider the query “pixar AND rating=9.0” on IMDB looking for all Pixar movie reviews with rating 9.0. In this case, the posting list for feature “rating=9.0” will be long and will contain many non-Pixar movie reviews. The feature lists is partitioned by performing a keyword clustering as a pre-processing step. For example, it is possible to find 100 disjoint token clusters from the corpus. An example cluster could contain {pixar, toy, story, monsters, inc, finding, nemo, incredibles}. The intuition is that a text document will not contain tokens from more than a few cluster (the invention can perform an aggressive stop word and function word removal first). Each of the feature posting list is divided in 100 partitions based on the keyword clusters. When a query shows up, instead of fetching the complete feature posting list, the invention needs to fetch only a part of it. This may result in significant performance gains.

To summarize, this system includes several extensions to the well known inverted index methodology to support efficient querying over metadata attributes, such as time, age, gender, and location. One or more of these extensions can be used based on application requirements.

### Spatial and Demographic Component

Another aspect is a spatial and demographic component. Along with each blog post, while crawling, the system attaches a city, state and country field and when possible geographical coordinates. There are several ways to infer a definite geographical coordinate given a blog post. These include:
Utilizing metadata regarding location in the head of the blog. Several html tags and plug-ins exist to associate geographical information in blog posts. The system automatically identifies such tags by parsing them and attaches a geographical set of coordinates to the post.
Utilizing information related to the address of the Blogger or author from its profile. The profile of a Blogger or author may contain address information. In that case the system extracts this information and maps it to a geographic set of coordinates. For example, approximate match information offered by tools like The Spider Project at the University of Toronto enables effective matching of addresses.
Looking-up blog content against a set of standardized zip codes and city names also allows for extraction of geographic information from blog posts.

With the aid of such coordinates one has the option to identify the posts as a result of a query into a map and restrict the search using the map based on geography. This enables the present invention to conduct spatio-temporal navigation for blog posts and correlated keywords. The system maintains inverted lists for city, state, country for blog posts. When the search is restricted using a spatial restriction, such lists are manipulated to suitably restrict the scope of the search.

Demographic information regarding age, gender, industry, and profession of the individual may be inferred based on information disclosed on the profile page.

### Popularity and Bursts

Another aspect of the system is that it can track the Blogosphere popularity of keywords used in a query for a day by counting the number of posts relevant to the query for each day. This can be done efficiently by using the index structure as described previously in this document.

Prior art discusses burst detection in the context of text streams. The known approach is based on modeling the stream using an infinite state automaton. While interesting, this approach is computationally expensive, as it requires computing the minimum-cost state sequence requires solving a forward dynamic programming algorithm for hidden Markov models. It is therefore not possible to use this approach in our system where bursts need to be computed on the fly. Moreover, adapting the known technique for on the fly identification of bursts would be prohibitively expensive. Others have addressed the problem of burst event detection, and have proposed techniques to identify sets of burst features from a text stream (see: G. P. C. Fung, J. X. Yu, P. S. Yu, and H. Lu. Parameter free bursty events detection in text streams. In Proceedings of the 31st International Conference on Very Large Data Bases, Trondheim, Norway, pages 181-192, 2005).

In one example embodiment, the following algorithm may be employed to detect bursts. This system models the popularity x of a query as the sum of a base popularity μ and a zero mean Gaussian random variable with variance σ².

x˜μ+N(0,σ²)

The exact popularity values x₁, x₂, . . . , x_{w} for the last w days is computed by using materialized statistics. The system then estimates the value of μ and σ from this data using the maximum likelihood.

$$μ = \frac{1}{w} {\sum }_{i = 1}^{w} {x}_{i} and {σ}^{2} = \frac{1}{w} {\sum }_{i = 1}^{w} {( {x}_{i} - μ )}^{2}$$

From the standard normal curve, the probability of the popularity for some day being greater than μ+2σ is less than 5%. The system considers such cases as outliers and labels them as bursts. Therefore, the i^{th} day will be identified as a burst if the popularity value for the i^{th} day is greater than μ+2σ. In an example implementation, the system uses w=90 to compute μ and σ.

### Keyword Correlations

Yet another aspect of the system is keyword correlation. The notion of correlation of two random variables is a well studied topic in statistics. Quantifying the correlation c(a,b) between two tokens a and b can have many different semantics. One semantics, for example, can be

$$\begin{matrix}c ( a , b ) = \frac{P ( a ∈ D \vert b ∈ D )}{P ( a ∈ D )} \\ = \frac{P ( b ∈ D \vert a ∈ D )}{P ( b ∈ D )} \\ = \frac{P ( a ∈ D and b ∈ D )}{P ( a ∈ D ) P ( b ∈ D )}\end{matrix}$$

where P(t∈D) denotes the probability of token t appearing in some document D in the collection D. In words, correlation between a and b is the amplification in probability of finding the token a in a document given that the document contains the token b. Calculation of correlations using such semantics requires checking each pair of tokens, which is clearly computationally highly expensive. With tokens in the order of millions, calculating c(a,b) using the above formula for every possible pair across several temporal granularities would amount to a large computational effort. This is complicated by the fact that such correlations have to be incrementally maintained as new data arrive. Increasing the number of keywords one wishes to maintain correlations for, from two to a higher number, gives rise to a problem of prohibitive complexity.

One example embodiment may employ a fast technique to find correlations which is adopted by the present invention. Consider a query q and the collection of all documents D. Let D_{q}⊂D denote the set of documents containing all of query terms. For a token t the system defines its score s(t,q) with respect to q as

s(t,q)=|{D|D∈D_{q} and t∈D}|*idƒ(t) (1)

where idƒ(t) is the inverse document frequency of t in all documents D.

$$idf ( t ) = log ( 1 + \frac{\vert 𝒟 \vert}{\vert \{ D \vert t ∈ D and D ∈ 𝒟 \} \vert} )$$

The first term in Equation 1 is the frequency of the token t in documents relevant to the query q. The system multiplies this frequency with idƒ(t) which represents the inverse of overall popularity of the token in the text corpus. Commonly occurring tokens like “and”, “then”, “when” have high overall popularity and therefore low idƒ. Hence the proposed scoring function favours tokens which have low overall popularity but high number of occurrences in documents relevant to the query q. This represents keywords that are closely related to q as they appear frequently only in documents containing q. The list of top-k tokens having highest score with respect to q forms a representative of D_{q}. The system displays this list as correlations for query q. This technique requires a single scan over D_{q}. But even this could be prohibitively time consuming if the set D_{q} is large. To circumvent this problem the system bounds the size of set D_{q} by a number m; if there are more than m documents containing query terms, the system considers only the top-m documents most relevant to q.

This technique requires a single scan over top-m documents. The system uses m=30, thus, considering just 30 carefully ranked text articles to find correlated terms for a query. Assuming that the system has assessed that keywords q,t above are correlated in a temporal window, repeating this process, using q and t as a query (expanding the query set) would yield keywords correlated with q and t (thus obtain a larger set of correlated keywords).

### Authoritative Ranking

Another aspect of the system is an authoritative ranking. In one example embodiment the system may compute the keyword synopsis set by employing a greedy expansion technique using the original query keyword(s) as a seed set. The system enumerates keywords correlated to the searched query q, and then identifies burst intervals along the temporal dimension using the popularity curve of the correlated keyword in combination with q. The system selects the pair with maximum burstiness and iteratively repeats the same process till increase in burstiness is insignificant. For example, given the seed query “cars” the burst on 9 Jun. 2006 (release date of the movie Cars) will be searched in conjunction with all its correlations “MERCEDES™”, “truck” and “Pixar”. Since “cars, Pixar” gives a burst of higher intensity than both “cars, Mercedes” and “cars, truck”, Pixar will be selected to expand the set to {cars, Pixar}. In the second iteration, the system considers queries of the form “cars, pixar, Disney”, “cars, Pixar, nemo”, Disney and nemo are both correlated to “cars, pixar”) etc. of which the system will select “Disney” (it contributes maximum to the burst) to expand our set to {cars, pixar, disney}.

The system may continue with these iterations till the intensity of burst stops increasing. To find authoritative bursts the system searches for blogs containing all words in the synopsis keyword set and selects those at the beginning of the bursts (earliest in time) having the highest number of incoming links.

### Hot Keywords

Another aspect of the system is hot keywords. Interestingness is naturally a subjective measure, as what is interesting varies according to the group of individuals it is intended for.

In one example embodiment, given the difficulty and the subjective nature of the task, the system may adopt a statistical approach to the identification of hot keywords. The system employs a mix of scoring functions to identify top keywords for a day. In order to produce a final list the system aggregates (using weighted summation) scores from all different scoring functions to find a ranked list of hot keywords.

Let x^{t} denote the popularity of some token t today, and x₁^{t}, x₂^{t}, . . . , x_{w}^{t} be the popularity of the token in the last w days (except today). Let μ^{t} and σ^{t} be the mean and standard deviation respectively of these w numbers. The system employs the following two scoring functions:
Burstiness measures the deviation of popularity from the mean value and is defined as

$$\frac{{x}^{t} - {μ}^{t}}{{σ}^{t}}$$

tor a token t. A large aeviation (burstiness) of a token implies that its current popularity is much larger than normal. The system, in this implementation, uses a value w=90 in this case. This value is set after conducting several experiments with the system.
Surprise measures the deviation of popularity from the expected value using a regression model. The system conducts a regression of popularities for a keyword over the last w days to compute the expected popularity for today. Let r(x^{t}) be this value. Then surprise is computed as

$$\frac{\vert r ( {x}^{t} ) - {x}^{t} ) \vert}{{μ}^{t}}$$

This measure gives preference to tokens demonstrating surprising burst, ranking anticipated bursts low. An example implementation uses a value of w as 15 for this case. The choice of w in this case is set after experimentation with the system.

Using the burstiness and surprise measures the system may compute an aggregate ranked list of interesting keywords for each day. To compute the aggregate list the system adds scores from different scoring functions, but as an alternative, use of ranked list merging techniques as described in the next section is also possible. This way, the system may materialize a list of hot keywords for each day. The system allows users to query such lists using temporal conditions. For example, one may wish to identify hot keywords in the Blogosphere for a specific week. The system may employ algorithms to support such queries; they are detailed below.

### Merging Ranked Lists

Another aspect of the system is the merging of ranked lists. The system may support ad hoc temporal querying on hot keyword lists.

In one example embodiment, a list of hot keywords may produce regularly for 24 hour periods. This list can be materialized and sorted according to the aggregate burstiness and surprise scores of the keywords. Given a specified temporal interval, the system produces a hot keyword ranked list taking into account the ranked lists of hot keywords in the scope of the temporal interval.

Several approaches exist to merge ranked lists. The Kendall Tau distance measure and the Spearman footrule distance measures are commonly used metrics for comparing two lists. For merging ranked lists, the invention seeks a list that minimizes the sum of Kendall's Tau distance from all input lists. Such a measure has been shown to satisfy several fairness properties (e.g., Condorcet property). Unfortunately such computation is NP-Hard even for a small number of lists. As an approximation, the system instead seeks the list that minimizes the sum of Spearman footrule distance from all input lists. This approximation is guaranteed to perform well as the aggregate footrule distance for any list is at most twice that of aggregate Kendall's Tau distance. The list minimizing aggregate footrule distance can be computed approximately by computing median ranks for each token in input list.

Let A be a universe of keywords and σ₁ . . . σₙ be ranked lists of keywords. A ranking a, is full if the ranking is a permutation of A and partial otherwise. If the size of A is very large (e.g., number of keywords in the present invention is more than 10 million), it is impractical to assume availability of full rankings over A. The system instead materializes a top-m (m-highest ranking keywords) list for each day for suitably chosen m.

Fagin et al. (see: Fagin, Kumar, Mandian, Sivakumar, and Vee. Comparing and aggregating rankings with ties. In PODS: 23th ACM SIGACT-SIGMOD-SIGART Symposium on Principles of Database Systems, 2004; R. Fagin, R. Kumar, and D. Sivakumar. Comparing top k lists. SIJDM: SIAM Journal on Discrete Mathematics, 17, 2003) have studied the problem of comparing top-k lists and partial ranking in detail. They consider each partial ranking (a top-k list can also be considered as a partial ranking) as a set of full rankings, and use Hausdorff metric with both Kendall's Tau and Footrule distance to compare them. Footrule distance can be used to approximate in the case of partial rankings also, because of the fact that Hausdorff metric with both Kendall's Tau and Footrule distance lie in the same equivalence class. The following proposition shows that Footrule optimal aggregation can be computed approximately using median ranks.

PROPOSITION 1. Let σ₁ . . . σₙ be partial rankings. Assume ƒ∈median (σ₁, . . . , σₙ), and let σ be a top-k list off where ties are broken arbitrarily. Then for every top-k list τ,

$${\sum }_{i = 1}^{n} {L}_{1} ( σ , {σ}_{i} ) \leq 3 {\sum }_{i = 1}^{n} {L}_{1} ( τ , {σ}_{i} )$$

where L₁ is used to represent Footrule distance.

One example embodiment of the system may approximate median computation through the following method. The system can maintain a list of hot keywords for each day for a total of n lists, were n is the total number of days the system has been materializing ranked lists. For each keyword ρ∈A there are at most n ranks. Whenever a query requests an aggregate list during time t∈[t₁, t₂], the invention is required to merge t₂−t₁+1 lists. One way to do this utilizing Proposition 1 is to first find the median rank for each keyword ρ∈A and then to arrange the keywords in order of their median ranks. Thus, the system may use a simple solution for computing median ranks fast based on the algorithm discussed by Manku et al. (see: G. S. Manku, S. Rajagopalan, and B. G. Lindsay. Approximate medians and other quantiles in one pass and with limited memory. In Proceedings of the ACM SIGMOD International Conference on Management of Data, New York, 1998). For each keyword the system can maintain an independent data structure and computes its median in isolation.

For each keyword ρ∈A at any point in time, the system may materialize n ranks (for each day or a suitable lower level temporal granularity t=1 to n). The system therefore can build a binary tree on these n numbers. Each node in this tree contains a bucket of size b. Leaf nodes are constructed by collapsing consecutive b numbers to one bucket. Each non-leaf node bucket is formed by collapsing buckets of its children. The algorithm for collapsing buckets is same as the one used by Manku et al. The tree has height

$${log}_{2} ( \frac{n}{b} ) .$$

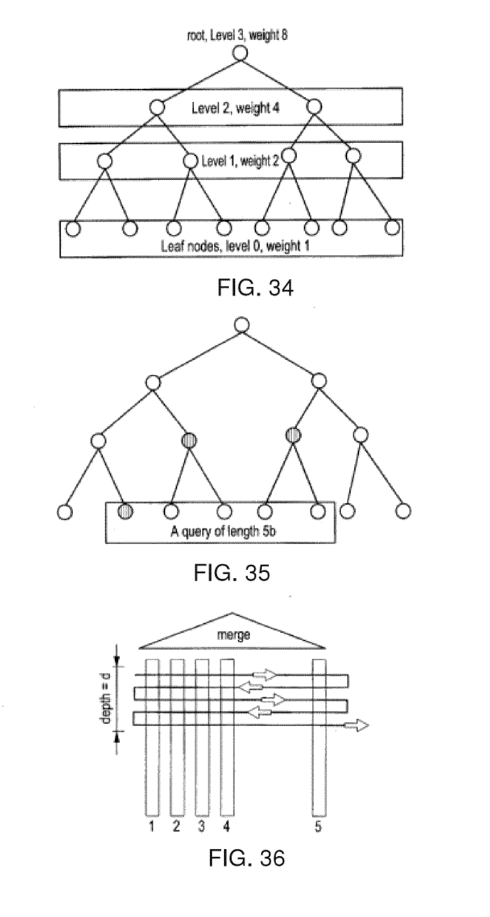

In this tree, the weight of a node at level l will be 2^{l}, with leafs being at level zero. FIG. 34 shows an example tree.

When a query with a specified temporal interval t∈[t₁, t₂] arrives (size s of the query is t₂−t₁+1), the system first identifies the topmost nodes in the tree, which when selected will cover the time interval specified by the query. The number of such nodes will be bounded by

$$2 log ( \frac{s}{b} ) .$$

The system then uses the buckets at these nodes to produce and output the median. FIG. 35 shows an example query. First darker nodes are identified that cover all the queried nodes and then they are collapsed to produce the median.

PROPOSITION 2. The difference in rank between the true φ-quantile of the original dataset and that of the output produced by the algorithm is at most

$$\frac{W - C - 1}{2} + {W}_{max} .$$

W is the total weight of all collapse operations, C is number of collapse operations, and wₘₐₓ is the weight of the heaviest bucket used to produce output.

The total weight of the collapse of all operations is not more than

$$s log ( \frac{s}{b} ) .$$

Also, wₘₐₓ is bounded by s. Using Proposition 2 and the fact that median is 0.5-quantile, the system concludes that the difference between rank of true median and the one computed will be

$$O log ( \frac{s}{b} ) .$$

THEOREM. For a number sequence of length n, by maintaining extra n numbers, the invention can identify the median of a subsequence of length s in time

$$O ( b {log}^{2} \frac{s}{b} ) .$$

with relative

$$error O ( log \frac{s}{b} )$$

One example embodiment may undertake dynamic updates through the following method. This solution is amenable to highly dynamic updates as more lists are added to the system at each suitably chosen time step (for example, each day). All that needs to be done is to adjust the tree structure by adding an extra leaf, subject to the bucket size b and dynamically adjust the higher levels of the tree, if required. Thus, the proposed solution for dynamically merging ranked lists of hot keywords, renders itself to highly dynamic maintenance, as the information recorded in the system evolves in the temporal dimension.

One example embodiment of the system can utilize the TA algorithm through the following method. Computing the median rank for each keyword and then sorting them can be very inefficient, especially when the size of the domain A is large. Hence the system uses a threshold algorithm (TA) to prune off elements with high rank. The system will deploy the above proposed solution, which acts like a black box to compute approximate median rank for any keyword ρ∈A for a time interval of length s (by maintaining an additional datastructure of size twice the original sequence), in conjunction with a TA style algorithm.

The system may have s ranked lists with the elements at top having rank 1. The invention can read elements one by one in a round-robin fashion as shown in FIG. 36. After reading a keyword ρ that is never seen before, invoke the median computation algorithm as described in the previous section to compute its median rank r_{ρ}. The system may insert the pair (ρ, r_{ρ}) to a priority queue that maintains top-k keywords with minimum median rank.

After reading d elements from each of the list, it is certain that any unseen element can not have median rank less than d. This will serve as threshold condition. The system can stop when the rank of last keyword in the priority queue containing top-k keywords is less than d.

### Query by Document

Another aspect is a methodology for enabling the QBD feature. This feature allows the user to submit a text document as query. The system automatically constructs search queries as a collection of descriptive phrases. These phrases are subsequently used for querying the text source of interest.

In one example embodiment a problem statement may be utilized through the following method. A QBD query q consists of a query document d, and optionally, temporal or other metadata restrictions (e.g., age, profession, geographical location) specified by the user. The specific challenge the system addresses is the extraction of a number k (user specified) of phrases from d in order to form a query with conjunctive semantics. Ideally the system would like them to be the phrases that an average user would extract from d to retrieve blog posts related to the document.

Problem QBD Given a query document d, extract a user specified number k of phrases to be used as input query with conjunctive semantics to the system. The documents retrieved as result of search should be rated by an average user as related to the content of the query document.

All phrases extracted by QBD are present in the document. This functionality can be extended by taking into account external information sources. In particular Wikipedia contains a vast collection of information, in pages which exhibit high link connectivity. Consider the graph G_{w} extracted from Wikipedia in which each node vᵢ corresponds to the title of the i-th Wikipedia page and is adjacent to a set of nodes corresponding to the titles of all pages that the i-th page links to. The system extracts such a graph, which is maintained up-to-date, currently consisting of 7M nodes. G, encompasses rich amount of information regarding phrases and the way they are related. For example starting with the node for ‘Bill Clinton’ the systemgets links to nodes for the ‘President of the United States’, ‘Governor of Arkansas’, and ‘Hillary Rodham Clinton’. This graph evidently provides the ability to enhance or substitute our collection of phrases extracted by QBD with phrases not present in the query document. Given the numerous outlinks from the ‘Bill Clinton’ page, it is natural to reason regarding the most suitable set of title phrases to choose from Wikipedia. Let vᵢ, v₁ be two nodes in G_{w} corresponding to two phrases in the result of QBD for a document. Intuitively the invention would like phrases in G, corresponding to nodes immediately adjacent to vᵢ and v₁ to have higher chances to be selected as candidates for enhancing or substituting the result of QBD. This intuition is captured by an algorithm called RelevanceRank.

The choice to enhance or substitute the results of QBD on a document with Wikipedia phrases depends on the semantics of the resulting query. For example consider a document describing an event associated with “Bill Clinton”, “Al Gore” and the “Kyoto Protocol” and that these three phrases are the result of QBD on a document. If the system adds the phrase “Global Warming” extracted from Wikipedia (assuming that this phrase in not present in the result of QBD) the system will be retrieving blog posts possibly associating “Global Warming” with the event described in the query document (if any). As an additional example consider a document concerning a new movie released by Pixar animation studios (say Ratatouille); assume that this document does not mention any other animated movies produced by Pixar. Nodes corresponding to other animated movies produced by “Pixar” would be good candidates from Wikipedia since they are pointed by both the node for “Pixar” and the node for “Ratatouille”. By substituting (all or some) of the phrases in QBD by phrases extracted from Wikipedia, such as “Toy Story” and “Finding Nemo”, the invention would be able to retrieve posts related to other movies produced by “Pixar”. All the above intuitions are formalized in the following problem:

Problem QBD-W Given a set of phrases C_{qbd} extracted by QBD containing k phrases from d, identify a number of phrases k′ utilizing the result of QBD and the Wikipedia graph G_{w}. The resulting k′ phrases will be used as input query with conjunctive semantics to the present invention. The documents retrieved as search results should be rated by an average user as related to the content of the query document.

In one example embodiment a phrase extraction QBD may be applied through the following methodology. The basic workflow behind our solutions to QBD is as follows:
Identify the set of all candidate key phrases Cₐₗₗ for the query document d.
Assess the significance of each candidate phrase c∈Cₐₗₗ assigning a score s(c) between 0 and 1.
Select the top-k (for a user specified value of k) phrases as C_{qbd} as a solution to QBD.

### 10.2.1 Extracting Candidate Phrases

The system may extract candidate phrases Cₐₗₗ from the query document d with the help of a part-of-speech tagger (POST). Specifically, for each term w∈d, POST determines its part-of-speech (e.g., noun, verb, or adjective) by applying a pre-trained classifier on w and its surrounding terms in d. For instance, in sentence “Wii is the most popular gaming console”, term “Wii” is classified as a noun, “popular” as an adjective, and so on. The tagged sentence is identified as “Wii/N is/V the/P most/A popular/J gaming/N console/N”, where N, V, P, A, and J signify noun, verb, article, adverb, and adjective respectively.

Based on the part-of-speech tags, all noun phrases are considered as candidate phrases, and compute Cₐₗₗ by extracting all such phrases from d. A noun phrase is a sequence of terms in d whose part-of-speech tags match a noun phrase pattern (NPP). Some example noun phrase patterns include “N”, “NN”, “JN”, “JJN”, “NNN”, “JCJN”, “JNNN”, and “NNNN”.

In one example embodiment scoring of candidate phrases may be applied through the following methodology. Once all candidate phrases are identified as Cₐₗₗ, a scoring function ƒ is applied to each phrase c∈Cₐₗₗ. The scoring function assigns a score to c based on the properties of c, taking into account both the input document, and the background statistics about terms in c from the present invention corpus. The candidate phrases are revised in a pruning step to ensure that no redundant phrases are present. The system can propose two scoring mechanisms, ƒₜ and ƒ₁ for this purpose. ƒₜ utilizes the TF/IDF information of terms in c to assign a score, while ƒ₁ computes the score based on the mutual information of the terms in phrase c. Both ranking mechanisms share the same pruning module to eliminate redundancy in the final result C_{qbd}.

In one example embodiment TD/IDF based scoring may be applied through the following methodology. The system may include ƒₜ, which is a linear combination of the total TF/IDF score of all terms in c and the degree of coherence of c. Coherence quantifies the likelihood these terms have in forming a single concept. Formally, let |c| be the number of terms in c; the invention uses, w₁, w₂, . . . , w_{|c|} to denote the actual terms. Let idƒ(wᵢ) be the inverse document frequency of wᵢ as computed over all posts in the system's corpus. ƒₜ is defined as

ƒₜ(c)=Σ^{|c|}ᵢ₌₁tƒidƒ(wᵢ)+α·coherence(c) (4.1)

where α is a tunable parameter.

The first term ƒₜ in aggregates the importance of each term in c. A rare term that occurs frequently in d is more important than a common term frequently appearing in d (with low idƒ, e.g., here, when, or hello). This importance is nicely captured by tƒidƒ for the term (See Mining the Web: Discovering Knowledge from Hypertext Data, by Soumen Chakrabarti, Morgan Kaufmann-2003 as reference for tƒ and idƒ). The system uses the total, rather than average tƒidƒ to favour phrases that are relatively long, and usually more descriptive.

The second term in ƒₜ captures how coherent the phrase c is. Let tƒ(c) e the number of times c appears in the document d, the coherence of c is defined as

$$coherence ( c ) = \frac{tf ( c ) \times ( 1 + log tf ( c ) )}{\frac{1}{\vert c \vert} \times {\sum }_{i = 1}^{\vert c \vert} tf ( {w}_{i} )} \qquad ( 4.2 )$$

Intuitively, the above Equation compares the frequency of c (the numerator) against the average TF of its terms (the denominator). The additional logarithmic term strengthens the numerator, preferring phrases appearing frequently in the input document. For example, consider the text fragment “ . . . at this moment Dow Jones . . . ”. Since the phrase “moment Dow Jones” matches the pattern “NNN”, it is included in Cₐₗₗ. However it is just a coincidence that the three nouns appear adjacent, and “moment Dow Jones” is not a commonly occurring phrase as such. The coherence of this phrase is therefore low (compared to the phrase “Dow Jones”), since the tƒ of the phrase is divided with the average tƒ of terms constituting it. This prohibits “moment Dow Jones” to appear high in the overall ƒₜ ranking.

Based on TF/IDF scoring, ƒₜ is good at distinguishing phrases that are characteristic of the input document. In the running example d=“Wii is the most popular gaming console”, ƒₜ strongly favours “Wii” over “gaming console” since the former is a much rarer term and thus has a much higher idƒ score. However, ƒₜ also has the drawback that it is often biased towards rare phrases.

In one example embodiment mutual information based scoring may be applied through the following methodology. ƒ₁ uses mutual information (MI) between the terms of c as a measure of coherence in the phrase c along with idƒ values from the background corpus. Mutual information is widely used in information theory to measure the dependence of random variables. Specifically, the point wise mutual information of a pair of outcomes x and y belonging to discrete random variables X and Y is defined as (see: Church, K. W., Hanks, P. Word Association Norms, Mutual Information and Lexicography. In ACL, 1989.)

$$PMI ( x , y ) = log ( \frac{prob ( x , y )}{prob ( x ) prob ( y )} ) \qquad ( 4.3 )$$

where prob(x), prob(y), prob(x,y) are the probability of x, y and the combination of the two respectively. The PMI of more than 2 variables is defined in a similar manner. Intuitively, for a phrase c consisting of terms w₁, w₃, . . . , w_{|c|}, the higher the mutual information among the terms, the higher are the chances of the terms appearing frequently together; and thus they are more likely to be combined to form a phrase. In simple words, a set of terms with higher mutual information tends to co-occur frequently. PMI is not defined for a single variable, i.e., when the number of terms in c is one. In this case, the invention resorts to ƒₜ to score c.

The scoring function ƒ₁ takes a linear combination of idƒ values of terms in c, frequency of c, and the point wise mutual information among them. Let tƒ(c) and tƒ(POS_{c}) be the number of times c and its part-of-speech tag sequence POS_{c} appear in d and POS_{d} respectively, then

$${f}_{i}^{′} = {\sum }_{i = 1}^{\vert c \vert} idf ( {w}_{i} ) + log \frac{tf ( c )}{tf ( {POS}_{c} )} + PMI ( c ) \qquad ( 4.4 )$$

The first part in the equation above represents how rare or descriptive each of the terms in c is. The second part denotes how frequent the phrase c is at the corresponding POS tag sequence in the document. The third part captures how likely are the terms to appear together in a phrase.

The PMI(c) for a phrase c is

$$PMI ( c ) = log ( \frac{prob ( c )}{{\prod }_{i = 1}^{\vert c \vert} prob ( {w}_{i} )} )$$

PMI can be evaluated either at the query document itself or at the background corpus. Computation of these probabilities for the background corpus requires a scan of all documents, which is prohibitively expensive. In order to compute PMI using d only, let prob(wᵢ) and prob(c) denote the probability of occurrence of wᵢ and c respectively at the appropriate part-of-speech tag sequence.

$$prob ( c ) = \frac{tf ( c )}{tf ( {POS}_{c} )}$$

$$prob ( {w}_{i} ) = \frac{tf ( {w}_{i} )}{tf ( {POS}_{{w}_{i}} )}$$

Substituting these probabilities,

$${f}_{i}^{′} = {\sum }_{i = 1}^{\vert c \vert} idf ( {w}_{i} ) + log \frac{tf ( c )}{tf ( {POS}_{c} )} + log ( \frac{\frac{tf ( c )}{tf ( {POS}_{c} )}}{{\prod }_{i = 1}^{\vert c \vert} \frac{tf ( {w}_{i} )}{tf ( {POS}_{{w}_{i}} )}} ) \qquad ( 4.5 )$$

The scoring function as defined in Equation 4.5 identifies how rare or descriptive each term is and how likely these terms are to form a phrase together. This definition however does not stress adequately the importance of how frequent the phrase is in document d; therefore the system weighs it by

$$\frac{tf ( c )}{tf ( {POS}_{c} )}$$

before computing the final score ƒ₁. The scoring function ƒ₁ therefore is,

$${f}_{i} = \frac{tf ( c )}{tf ( {POS}_{c} )} \times ( {\sum }_{i = 1}^{\vert c \vert} idf ( {w}_{i} ) + log \frac{tf ( c )}{tf ( {POS}_{c} )} + log ( \frac{\frac{tf ( c )}{tf ( {POS}_{c} )}}{{\prod }_{i = 1}^{\vert c \vert} \frac{tf ( {w}_{i} )}{tf ( {POS}_{{w}_{i}} )}} ) )$$

The tƒ values in the above equations are computed by scanning the document d once, while the idƒ values are maintained precomputed for the corpus.

The scoring function (ƒₜ or ƒ₁) evaluates each phrase c∈Cₐₗₗ individually. As a result, candidate phrases may contain redundancy. For example, a ranking function may judge that both c₁=“gaming console” and c₂=“popular gaming console” as candidate phrases. Since c₁ and c₂ refer to the same entity, intuitively only one should appear in the final list C_{qbd}. The system therefore applies a post-processing step after evaluating the ranking function on elements of Cₐₗₗ. Methodology for computing C_{qbd} is shown in Algorithm below. Lines 7-14 demonstrate the pruning routine after evaluating the ranking function. Specifically, a phrase c is pruned when there exists another phrase c′∈C_{qbd} such that (i) c′ has a higher score than c, and (ii) c′ is considered redundant in presence of c. The function Redundant evaluates whether one of the two phrases c₁, c₂ is unnecessary by comparing them literally.

Note that sometimes the shorter phrase may be more relevant, so the system should not simply identify longer phrases. For instance, the phrase “drug” may have higher score than a longer phrase “tuberculosis drugs” in a document that talks about drugs in general, and tuberculosis drugs is one of the many different phrases where the term “drug” appears. Also, the candidate set Cₐₗₗ may contain phrases with common suffix or prefix, e.g., “drug resistance”, “drug facility” and “drug needs”, in which case the system keeps only the top few highest scoring phrases to eliminate redundancy. Redundant returns true if and only if either one phrase subsumes the other, or multiple elements in C_{qbd} share common prefix/suffix.

Algorithm 1 Algorithm for QBD

```
  INPUT document d, and required number of phrases k
  Compute QBD
1.  Run a POS tagger to obtain the tag sequence POS_{d} for d
2.  Initialize Cₐₗₗ and C_{qbd} to empty
3.  Match POS_{d} against the PS Trie forest
4.  For each subsequent POS_{c} ⊂ POS_{d} that matches a NPP, append
  the corresponding term sequence to Cₐₗₗ
5.  for each c ∈ Cₐₗₗ do
6.  Compute the score s_{c} using either of fₜ or fₗ
7.  if NOT exists c′ ∈ C_{qbd} such that (Redundant(c,c′) =
8.  true and s_{c′} > s_{c}) then
9.  Add c to C_{qbd}
10.  end if
11.  for each c′ ∈ C_{qbd} do
12.  if Redundant(c,c′) and s_{c′} < s_{c} then
13.  Remove c′ from C_{qbd}
14.  end if
15.  end for
16.  If |C_{qbd}| > k′, remove the entry with minimum score
17. end for
18. OUTPUT C_{qbd}
```

In one example embodiment Wikipedia can be used in the QBD through the following methodology. The system has constructed a directed graph G_{w}<V,E> by preprocessing a snapshot of Wikipedia, modeling all pages with the vertex set V and the hyperlinks between them with the edge set E. Specifically, a phrase c is extracted for each page Pc in Wikipedia as the title of the page. Each such phrase is associated with a vertex in V. Hyperlinks between pages in Wikipedia translate to edges in the graph G_{w}. For example, the description page for “Wii” starts with the following sentence: “The Wii is the fifth home video game console released by Nintendo”, which contains hyperlinks (underlined) to the description pages of “video game console” and “Nintendo” respectively. Intuitively, when the Wikipedia page Pc links to another page Pc′, the underlying phrases c and c′ are related. Consider two pages Pc₁ and Pc₂ both linking to Pc′. If the number of links from Pc₁ to Pc′ is larger than the number of links from Pc₂ to Pc′, the system expects c₁ to have a stronger relationship with c′. This can be easily validated by observing the Wikipedia data.

Formally, the Wikipedia graph G_{w} is constructed as follows: a vertex v_{c} is created for each phrase c which is the title of the page Pc. A directed edge e=<v_{c}, v_{c′}> is generated if there exists a hyperlink in Pc pointing to Pc′. A numerical weight wtₑ is assigned to the edge e=<v_{c},v_{c′}> with value equal to the number of hyperlinks from Pc pointing to Pc′. The system refers to the weight of the edge between two vertices in graph G_{w} as their affinity.

### Example 5.1

FIG. 10A depicts the interconnection between phrases c₁=“Wii”, c₂ =“Nintendo”, c₃=“Sony”, c₄=“Play Station”, and c₅=“Tomb Raider”, in the Wikipedia graph. The number beside each edge signifies its weight, e.g., wt<c₁,c₂>=7 implying that there are 7 links from the description page of “Wii” to that of “Nintendo”. Node c₂ is connected to both c₁ and c₃, signifying that “Nintendo” has affinity with both “Wii” and “Sony”. Edge <c₂,c₁> has a much higher weight than <c₂,c₃>, signifying that the affinity between “Nintendo” and “Wii” is stronger than that between “Nintendo” and “Sony” (the manufacturer of Play Station 3, a competitor of Wii). Therefore, if “Nintendo” is an important phrase mentioned in the input document d, i.e., c₂∈C_{qbd}, it is much more likely that c₁ (rather than c₃) is closely relevant to d, and thus should be included in the enhanced phrase set after QBD-W.

Once G_{w} is ready and the set C_{qbd} is identified, it can be enhanced using the Wikipedia graph according to the following procedure:
Use C_{qbd} to identify a seed set of phrases in the Wikipedia graph G_{w}.
Assign an initial score to all nodes in G_{w}.
Run the algorithm RelevanceRank as described in Algorithm displayed below to iteratively assign a relevance score to each node in G_{w}. The RelevanceRank algorithm is an iterative procedure in the same spirit as biased PageRank and TrustRank (see Gyongyi, Z., Garcia-Molina, H., Petersen, J. Combating Web Spam with TrustRank. In VLDB, 2004 Haveliwala, T. Topic-Sensitive PageRank. In WWW 2002.).
Select the top-k′ highest scoring nodes from G_{w} (for user specified value of k′) as top phrases C_{wiki}.

The RelevanceRank algorithm starts (Lines 1-5) by computing the seed set S containing the best matches of phrases in C_{qbd}. To find best matches, for each phrase c∈C_{qbd}, an exact string match over all nodes in G_{w} is conducted to identify the node matching c exactly. If no such node exists an approximate match is conducted. The system deploys edit distance based similarity for our experiments, but other approximate match techniques can also be used (see: Chandel, A., Hassanzadeh, O., Koudas, N., Sadoghi, M. Srivastava., D. Benchmarking Declarative Approximate Selection Predicates. In SIGMOD, 2007). It is possible that a phrase c∈C_{qbd} is not described by any Wikipedia page. A threshold θ on maximum edit distance is therefore used. The matching phrase c′∈G_{w} is added to the seed S only if the edit distance between c′ and c is below θ.

Algorithm 2 Algorithm to compute RelevanceRank

```
INPUT Graph G_{w} =< V,E >, QBD phrases C_{qbd}, k′
RelevanceRank
    1.  Initialize the seed set to empty set
    2.  for each c ∈ C_{qbd} do
    3.  Compute node υ ∈ V with smallest edit distance to c
    4.  If edit_distance(c,υ) < θ, add υ to S
    5.  end for
    6.  for each υ ∈ V do
    7.  Assign initial score to υ based on Equation 5.1
    8.  end for
    9.  for i = 1 to MaxIterations do
    10.  Update scores for each υ ∈ V using Equation 5.3
    11.  If convergence, i.e., RR^{j} = RRⁱ⁻¹, break the for loop
    12. end for
    13. Construct C_{wiki} as the set of top-k′ vertices with highest RR scores
```

After generating S, RelevanceRank initializes the ranking score RRᵥ⁰ of each vertex v∈V (Lines 6-8). Let cᵥ be the phrase in the seed set corresponding to the vertex v. Let s(cᵥ) be the score assigned to it by one of the two scoring functions (ƒₜ or ƒ₁) described in the previous section. RRᵥ⁰ is defined by

$${RR}^{0} = \{ \begin{matrix}\frac{s ( {c}_{v} )}{{Σ}_{{v}^{′} ∈ s} s ( {c}_{{v}^{′}} )} , & if v ∈ s \\ 0 , & otherwise\end{matrix} \qquad ( 5.1 )$$

This initializes the scores of all vertices not in the seed set to zero. Scores of vertices in the seed set the normalized to lie in [0, 1] such that the sum is 1.

Next RelevanceRank iterates (Lines 9-12) until convergence or reaching a maximum number of iterations MaxIterations. The i^{th} iteration computes RRⁱ based on the results of RRⁱ⁻¹ following the spreading activation framework (see Crestani, F. Application of Spreading Activation Techniques in Information Retrieval. In Artificial Intelligence Review, 1997). Specifically, the transition matrix T is defined as

$$T \vert v . {v}^{′} \vert = \{ \begin{matrix}\frac{{wt}_{e}}{{\sum }_{{s}^{′} = ( v , w )} {wt}_{{s}^{′}}} , & if ∃ e = < v , {v}^{′} > ∈ E \\ 0 , & otherwise\end{matrix}$$

The entry T[v,v′] represents the fraction of out-links from the page corresponding to v in Wikipedia that point to the page associated with v′. Observe that each entry in T is in range [0,1] and the sum of all entries in a row is 1. Conceptually T captures the way a vertex v passes its affinity to its neighbours, so that when v is relevant, it is likely that a neighbouring phrase v′ with high affinity to v is also relevant, though to a lesser degree.

### Example

The transition matrix for vertices in FIG. 10A is displayed in FIG. 10B.

To model the fact that a phrase connected to nodes from C_{qbd} through many intermediate nodes is only remotely related, the propagation of RR is dampened as follows: with probability αᵥ, v passes its RR score to its successors, and with probability (1−αᵥ) to one of the seed vertices S. Formally \vec{RRᵥⁱ} in the i th iteration is computed by

RRᵥⁱ=Σ_{e=<v′,v>}α_{v′}·RR_{v′}ⁱ⁻¹·T[v′,v]+RRᵥ⁰Σ_{v′∈V}(1−α_{v′})RR_{v′}ⁱ⁻¹ (5.3)

The first term in the equation represents propagation of RR scores via incoming links to v. The second term accounts for transfer of RR scores to seed nodes with probability 1−α_{v′}. Recall that RRᵥ⁰ is zero for phrases not in the seed set, and thus the second term in the equation above is zero for v∉S.

The RelevanceRank algorithm can be alternatively explained in terms of the random surfer model. In the Wikipedia graph G_{w}, first the seed nodes are identified by using the result C_{qbd} of QBD. Each of these seed nodes is assigned an initial score using a scoring function (ƒₜ or fi). All other nodes are assigned score zero. The surfer starts from one of the seed nodes. When at node v, the surfer decides to continue forward, selecting a neighbouring node v′ with probability αᵥ·T[v,v′]. With probability 1−αᵥ, the surfer picks a node at random from the initial seed set. The probability of selection of the node from the seed set is proportional to the initial RR⁰ scores of the nodes in S. At convergence, RR score of a node is the same as the probability of finding the random surfer there.

In RelevanceRank, with probability 1−αᵥ, the random surfer jumps back to nodes in the seed set only and not to any node in G_{w}. This is in similar spirit as the topic-sensitive PageRank and TrustRank algorithms, which use a global constant value αᵥ=α for all v∈G_{w} for returning back to one of the seed nodes. Selection of a constant α is however not suitable for RelevanceRank for the following two reasons:
The RelevanceRank scoring function must prefer nodes that are close to the initial seed set. In TrustRank, existence of a path between two nodes suffices for propagation of trust (as stationary state probabilities are probability values after the surfer makes infinitely many jumps). The same holds true for PageRank as well, where existence of a path is sufficient for propagation of authority. For the case of RelevanceRank however, the length of the path is an important consideration. Propagation of RR scores over long paths needs to be penalized. Only nodes in the vicinity of seed nodes are relevant to the query document. The value of αᵥ therefore must depend on the distance of a node from the seed set.
G_{w} consists of over 7 million nodes. Execution of the iterative algorithm to compute RR scores over the entire graph for every query is not feasible. Unlike TrustRank or PageRank, where one-time offline computation is sufficient, RelevanceRank needs to be evaluated on a per-query basis. Since only nodes close to the seed set are relevant, the invention sets αᵥ to zero for vertices v∈V far from the seed set S. Let lₘₐₓ be the maximum permissible length of path from a node to S. Define the graph distance GD(v) of a node v as its distance from the closest node in the seed set. Formally,

GD(v)=min_{v′∈s}distance(v′,v)
where distance represents the length of the shortest path between nodes. Thus, if GD(v)≧lₘₐₓ for some v∈V, αᵥ is assigned value 0 Application of this restriction on αᵥ allows us to chop off all nodes from G_{w} that are at distance greater than lₘₐₓ from S, which significantly reduces the size of the graph the invention needs to run the RelevanceRank algorithm on. As the value of lₘₐₓ increases, the size of sub-graph over which RelevanceRank is to be computed increases, leading to higher running times.

For the above mentioned reasons, αᵥ for a node v is defined as a function of its graph distance GD(v). The system would like αᵥ to decrease as GD(v) increases such that αᵥ=0 if GD(v)≧lₘₐₓ. The syste, defines αᵥ as

$${α}_{v} = max ( 0 , {α}_{max} - \frac{GD ( v )}{{l}_{max}} ) \qquad ( 5.4 )$$

for some constant αₘₐₓ∈[0, 1].

When the iterative algorithm for computation of RelevanceRank finishes, each node is assigned an RR score. The process is guaranteed to converge to a unique solution, as the algorithm is essentially the same as that of computing stationary state probabilities for an irreducible Markov chain with positive-recurrent states only (see: Feller, W. An Introduction to Probability Theory and Its Applications, Wiley, 1968). These nodes, and thus corresponding phrases, are sorted according to the RR scores, and top-k′ (for a user-defined value of k′) are selected as the enhanced phrase set C_{wiki}. The new set C_{wiki} may contain additional phrases that are not present in C_{qbd}. Also, phrases from C_{qbd} included in C_{wiki} may have been re-ranked, that is the order of phrases in C_{qbd} appearing in C_{wiki} may be different than the corresponding order these phrases have in C_{qbd}. This means, even for k′≦k, the set C_{wiki} can be very different from C_{qbd} depending on the information present in Wikipedia.

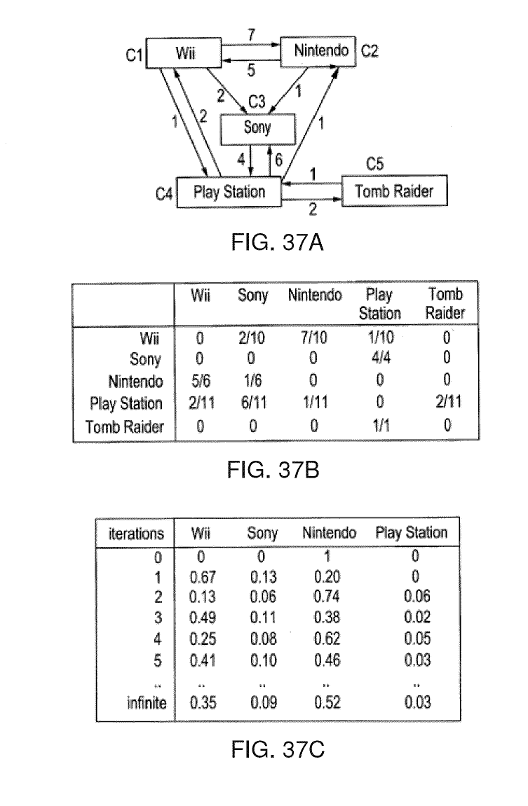

Example Consider the graph in FIG. 37A. Assume that the seed set consists of only one node “Nintendo”. Let αₘₐₓ=0.8 and lₘₐₓ=2. Then, initial score for Nintendo will be 1, RR_{Nintendo}⁰=1; and for Sony, Wii and Play Station, the initial score will be zero. Also, α_{Nintendo}=0.8, α_{Sony}=0.3, α_{Wii}=0.3, α_{PlayStation}=0, and α_{TombRaider}=0. Note that, the random surfer can never reach the node “Tomb Raider” in this setting since the surfer must jump back to “Nintendo” when he reaches the node “Play Station”. Hence the system can simply remove all nodes, including “Tomb Raider”, with graph distance greater than 2 for calculating RR scores. The transition matrix is presented in FIG. 37B. Only the first four rows and columns of the transition matrix are relevant. RelevanceRank scores after few iterations will be as displayed in FIG. 37C. At convergence, “Nintendo” has the highest RR score 0.52, with “Wii” at the second position. Scores for “Sony” and “Play Station” are low as expected.

Example Consider the news article titled “U.S. Health Insurers Aim to Shape Reform Process” taken from Reuters (http://www.reuters.com/article/domesticNews/idUSN2024291720070720). Top 5 phrases in QBD for this article consists of “America's health care system”, “ahip's ignani”, “special interests”, “tax credits,” and “poorer Americans”. While these phrases do relate to the meaning of the document, they do not necessarily constitute the best fit for describing it. The result of running QBD-W with the same value of k′=k=5 results in “american health care”, “ahip”, “universal health care”, “united states” and “poore brothers”. Arguably, the latter articulates the theme of the document in a much better way. Enhancement using wikipedia graph has replaced and re-ranked most items from the seed set consisting of 5 initial terms. For example, the phrase “AHIP's Ignani” that appears thrice in the document, and which refers to the CEO Karan Ignani of America's Health Insurance Plans, has been replaced with just AHIP. Also, “America's health care system” is re-written as “american health care” (due to use approximate string matching) which is the title of a page in Wikipedia.

### BuzzGraph Computation

Another aspect of the present system is the generation of graphs that are referenced as BuzzGraphs.

In one example embodiment a query-specific BuzzGraph may be generated through the following methodology. For a given keyword query q with suitable demographic and temporal restrictions, all query results, results(q), are collected. For each result r in results(q), let ki and kj be two keywords. For each keyword ki, the system maintains count(ki) across all results r in results(q) and count(ki,kj) across of r in results(q) representing the number of results keyword ki appears and number of results in which ki and kj both appear. The counts are existential namely if a keyword or keyword pair appear many times in a result r the system only accounts for one occurrence. Given such counts, the system assesses a correlation utilizing a log likelihood test (see Foundations of Statistical Natural Language Processing by Christopher D. Manning, Hinrich Schütze, MIT Press 2000). Let

pi=count(ki)/|results(q)|,

pj=count)kj)/|results(q),

and p=(count(ki)+count(kj))/(2*|results(q)|).

### Denote as

L(pi.count(ki),|results(q))=count(ki)*log(pi)±(|results(q)|−count(ki))*log(1−pi).

Then the log likelihood test is denoted as 2*(L(pi,count(ki),|results(q)|)+L(pj,count(kj),|results(q)|−L(p,|results(q)|−count(ki),|results(q)|)−L(p,|results(q)|−count(kj),|results(q)|)). This measure has asymptotically the same properties as the statistical chi-squared test but is more appropriate for the small counts that are expected for keywords given that the system inspects a small number of answers at the result of a query q. This test is thresholded with suitable values to assess correlation as a specified statistical significance level utilizing statistical tables. All pairs that survive this thresholding are correlated. The system limits their number by selecting only a number specified by a user that consists of the most important correlated pairs. Importance is computed by aggregating the tfidf score of the keywords in the pair.

In another example embodiment, the second type of BuzzGraph may be constructed on the information of the entire collection of documents collected by the system on an arbitrarily specified temporal period (suitably restricted by demographic information if required). In this case in analogy with the query specific BuzzGraph, let results refer to the entire collection of document for the specified time interval belonging to the specified demographic group. The system may accumulate counts for each keyword and each keyword pair as before. The system may then construct a graph with vertices corresponding to each keyword encountered in results. An edge between two keywords is annotated with the count of the number of times the keywords co-occur in results. Counts have existential semantics as before. For each pair of keywords the system conducts a chi-squared test utilizing count(ki,kj), count(ki) and count(kj) as well as |results|, the number of results which is the total number of documents collected in the suitable time period. This test is thresholded to gain statistical significance at the suitable level. In addition for each pair surviving the threshold test, the system computes the linear correlation coefficient between the two keywords, utilizing the counts. This coefficient is computed as r(ki,kj)=(|results|count(ki,kj)−count(ki)count(kj)/(sqrt((|results|−count(ki))count(kj)*sqrt(|results|−count(kj))count(ki)). A pair of keywords is maintained only of the linear correlation coefficient between the pair is above a user specified threshold. All keyword pairs that survive the tests form the BuzzGraph for the general case.

In yet another example embodiment both forms of BuzzGraph may be generated.

It will be appreciated that different features of the example embodiments of the system and methods, as described herein, may be combined with each other in different ways. In other words, different modules, operations and components may be used together according to other example embodiments, although not specifically stated.

The steps or operations in the flow diagrams described herein are just for example. There may be many variations to these steps or operations without departing from the spirit of the invention or inventions. For instance, the steps may be performed in a differing order, or steps may be added, deleted, or modified.

The GUIs and screen shots described herein are just for example. There may be variations to the graphical and interactive elements without departing from the spirit of the invention or inventions. For example, such elements can be positioned in different places, or added, deleted, or modified.

Although the above has been described with reference to certain specific embodiments, various modifications thereof will be apparent to those skilled in the art without departing from the scope of the claims appended hereto.

1. A method performed by a computing system for searching for text sources including temporally-ordered data objects based on at least influence of an author, comprising:
identifying users associated with a topic, the users including authors of the data objects;
modeling each of the users as a node and determining relationships between each of the users;
computing a topic network graph using the users as nodes and the relationships as edges;
ranking the users within the topic network graph;
identifying and filtering outlier nodes within the topic network graph;
outputting users remaining within the topic network graph according to their associated ranking of influence;
obtaining or generating a search query based on one or more terms and one or more time intervals, the one or more terms including the topic;
obtaining or generating time data associated with the data objects;
identifying one or more data objects based on the search query;
generating one or more popularity curves based on the frequency of data objects corresponding to one or more of the search terms in the one or more time intervals;
identifying data objects as popular based on the one or more popularity curves;
identifying an author of each of the popular data objects, each author identified as part of the outputted users within the topic network graph; and
ranking each of the popular data objects according to a respective influence ranking of a respective author of each of the popular data objects.

2. The method of claim 1 further comprising:
identifying at least two distinct communities amongst the users within the filtered topic network graph, each community associated with a subset of the users;
identifying attributes associated with each community; and
outputting each community associated with the corresponding attributes.

3. The method according to claim 1, further comprising: ranking the users within each community and providing, for each community, a ranked listing of the users mapped to the corresponding community.

4. The method according to claim 1, wherein ranking the users further comprises: mapping each ranked user to the respective community and outputting a ranked listing of the users for the at least two communities.

5. The method according to claim 1, wherein the attributes are associated with each user's interaction with the social data network.

6. The method according to claim 5, wherein the attributes are displayed in association with a combined frequency of the attribute for the users.

7. The method according to claim 1, wherein the attributes are frequency of topics of conversation for the users within a particular community.

8. The method according to claim 1, further comprising displaying in a graphical user interface the at least two distinct communities comprising color coded nodes and edges, wherein at least a first portion of the color coded nodes and edges is a first color associated with a first community and a least a second portion of the color coded nodes and edges is a second color associated with a second community.

9. The method according to claim 8 wherein a size of a given color coded node is associated with a degree of influence of a given user represented by the given color coded node.

10. The method according to claim 8, further comprising displaying words associated with a given community, the words corresponding to the attributes of the given community.

11. The method according to claim 8, further comprising detecting a user-controlled pointer interacting with a given community in the graphical user interface, and at least one of: displaying one or more top ranked users in the given community; visually highlighting the given community; and displaying words associated with a given community, the words corresponding to the attributes of the given community.

12. The method according to claim 1, wherein the steps of modeling each of the users and computing the topic network graph comprise:
determining posts related to the topic within one or more social data networks;
characterizing each post as one or more of: a reply post to another posting, a mention post of another user, and a re-posting of an original posting;
generating a group of users comprising any user that authored the posting, being mentioned in the mention post, that posted the original posting, that authored one or more posts that are related to the topic, or any combination thereof;
representing each of the user in the group as a node in a connected graph and establishing an edge between one or more pairs of nodes;
for each edge between a given pair of nodes, determining a weighting that is a function of one or more of: whether a follower-followee relationship exists, a number of mention posts, a number of reply posts, and a number of re-posts involving the given pair of nodes; and
computing the topic network graph using each of the nodes and the edges, each edge associated with a weighting.

13. The method of claim 12 wherein, when there the follower-followee relationship exists between the given pair of nodes, initializing the weighting of the edge to a default value and further adjusting the weighting based on any one or more of the number of mention posts, the number of reply posts, and the number of re-posts involving the given pair of nodes.

14. The method of claim 12 further comprising:
ranking the users within the topic network graph to filter outlier nodes within the topic network graph;
identifying at least two distinct communities amongst the users within the filtered topic network graph, each community associated with a subset of the users;
identifying attributes associated with each community; and
outputting each community associated with the corresponding attributes.

15. The method according to claim 14, further comprising: ranking the users within each community and providing, for each community, a ranked listing of the users mapped to the corresponding community.

16. A computing system for searching for text sources including temporally-ordered data objects based on at least influence of an author, the computing system comprising:
memory;
a communication device; and
a processor configured to at least:
identify users associated with a topic, the users including authors of the data objects;
model each of the users as a node and determining relationships between each of the users;
compute a topic network graph using the users as nodes and the relationships as edges;
rank the users within the topic network graph;
identify and filter outlier nodes within the topic network graph;
output users remaining within the topic network graph according to their associated ranking of influence;
obtain or generate a search query based on one or more terms and one or more time intervals, the one or more terms including the topic;
obtain or generate time data associated with the data objects;
identify one or more data objects based on the search query;
generate one or more popularity curves based on the frequency of data objects corresponding to one or more of the search terms in the one or more time intervals;
identify data objects as popular based on the one or more popularity curves;
identify an author of each of the popular data objects, each author identified as part of the outputted users within the topic network graph; and
rank each of the popular data objects according to a respective influence ranking of a respective author of each of the popular data objects.

17. A non-transitory computer readable medium for searching for text sources including temporally-ordered data objects based on at least influence of an author, the non-transitory computer readable medium comprising processor executable instructions, the instructions comprising:
identifying users associated with a topic, the users including authors of the data objects;
modeling each of the users as a node and determining relationships between each of the users;
computing a topic network graph using the users as nodes and the relationships as edges;
ranking the users within the topic network graph;
identifying and filtering outlier nodes within the topic network graph;
outputting users remaining within the topic network graph according to their associated ranking of influence;
obtaining or generating a search query based on one or more terms and one or more time intervals, the one or more terms including the topic;
obtaining or generating time data associated with the data objects;
identifying one or more data objects based on the search query;
generating one or more popularity curves based on the frequency of data objects corresponding to one or more of the search terms in the one or more time intervals;
identifying data objects as popular based on the one or more popularity curves;
identifying an author of each of the popular data objects, each author identified as part of the outputted users within the topic network graph; and
ranking each of the popular data objects according to a respective influence ranking of a respective author of each of the popular data objects.
